(19) United States
(12) Patent Application Publication
(10) Pub. No.: US 2007/0168262 A1
(43) Pub. Date: Jul. 19, 2007

(54) Information processing system, information processing apparatus, information processing method, information processing program and recording medium for storing the program

(76) Inventors: Shiro Morotomi, Kanagawa (JP); Kissei Matsumoto, Kanagawa (JP); Takashi Fukushima, Tokyo (JP); Hiroyuki Kawahara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/640,361

(22) Filed: Dec. 18, 2006

(30) Foreign Application Priority Data
Dec. 28, 2005 (JP) P2005-378838

(51) Int. Cl. G06Q 30/00; G06F 17/30; G06F 15/16

(52) U.S. Cl. 705/26; 707/3; 709/217

(57) ABSTRACT

Disclosed herein is an information processing system including an information processing apparatus and another information processing apparatus different from the information processing apparatus. The information processing apparatus includes: a first communication unit, a first storage unit, a data generation unit, and a transmission control unit. The other information processing apparatus includes a second communication unit, a second storage unit, a content reproduction unit, and a control unit.

### CROSS REFERENCES TO RELATED APPLICATIONS

The present invention contains subject matter related to Japanese Patent Application JP 2005-378838, filed in the Japanese Patent Office on Dec. 28, 2005, the entire contents of which being incorporated herein by reference.

### BACKGROUND OF THE INVENTION

1. Field of the Invention

The present invention relates to an information processing system, an information processing apparatus, an information processing method adopted by the apparatus, an information processing program implementing the method and a recording medium for storing the program. More particularly, the present invention relates to an information processing system and apparatus suitable for cases in which information can be communicated among a plurality of apparatus and relates to an information processing method adopted by the apparatus, an information processing program implementing the method as well as a recording medium for storing the program.

2. Description of the Related Art

Document such as Japanese Patent Laid-open No. 2004-335098 have disclosed a traditional technology wherein a recording medium can be searched with ease for a predetermined track or a predetermined album and a highlight portion of the predetermined track or a highlight portion of every track included in the predetermined album obtained as a result of the search process are sequentially reproduced.

Now, a technology for communicating information among a plurality of apparatus is utilized in a number of applications. In addition, contents such as musical data are downloaded from a predetermined server to an apparatus by way of a network as contents purchased by the user owning the apparatus.

### SUMMARY OF THE INVENTION

With the utilization of a technology for communicating information among a plurality of apparatus in a number of applications, contents such as musical data can be exchanged between apparatus. Due to a copyright problem, however, a pay content such as pay musical data cannot be exchanged among the apparatus without limitations. A pay content is defined as a content downloaded from a predetermined server by way of a network to an apparatus as a content purchased by the user owning the apparatus.

On the other hand, a seller of contents desires distribution of contents to large number of users and promotion of content sales. In this case, a seller of contents means a group including a content creator and a content provider.

However, the conventional technology described above is a technology for searching a recording medium for a predetermined track or a predetermined album on the basis of a keyword entered by the user and for extracting a highlight portion of the predetermined track or a highlight portion of every track each included in the predetermined album. In addition, the description of the conventional technology for extracting only a portion of content data does not include consideration of a case of exchanging contents such as musical data among a plurality of apparatus and consideration of information required for promotion of sales of contents.

Addressing the problems described above, inventors of the present invention have devised an information processing system allowing sales of content data to be promoted.

In accordance with a first embodiment of the present invention, there is provided an information processing system including an information processing apparatus and another information processing apparatus different from the information processing apparatus wherein:

the information processing apparatus has
a first communication section configured to exchange information,
a first storage section configured to store a content,
a data generation section configured to cut out a portion of the content stored in the first storage section and generate content introduction data based on the portion, and
a transmission control section configured to control transmission of the content introduction data to another apparatus by making use of the first communication section; and

the other information processing apparatus has
a second communication section configured to exchange information,
a second storage section configured to store a content,
a content reproduction section configured to reproduce the content, and
a control section configured to store the content introduction data received by the second communication section from the information processing apparatus as a portion cut out from the content in the information processing apparatus in the second storage section and control the content reproduction section to reproduce the content introduction data stored in the second storage section.

It is possible to provide the information processing system according to the first embodiment of the present invention with a configuration in which:

the data generation section employed in the information processing apparatus generates purchasing information to purchase the content and includes the purchasing information and the cut-out portion of the content in the content introduction data; and

the control section employed in the other information processing apparatus controls the second communication section to receive the content introduction data and transmit a signal making a request for purchasing of the content in accordance with the purchasing information.

In addition, it is also possible to provide the information processing system according to the first embodiment of the present invention with a configuration in which:

the data generation section employed in the information processing apparatus generates apparatus information of the information processing apparatus and includes the apparatus information and the cut-out portion of the content in the content introduction data; and

the control section employed in the other information processing apparatus controls the second communication section to receive the content introduction data and transmit a signal making a request for purchasing of the content along with the apparatus information.

In accordance with a second embodiment of the present invention, there is provided an information processing method including the steps of:

cutting out a portion of a content stored in a first storage section and generating content introduction data based on the portion;

controlling transmission of the content introduction data to another apparatus by making use of a first communication section;

letting a second communication section receive the content introduction data and store the content introduction data in a second storage section; and

controlling a content reproduction section to reproduce the content introduction data stored in the second storage section as a portion cut out from the content.

In accordance with the information processing method according to the second embodiment of the present invention:

a portion of a content stored in a first storage section is cut out and used for generating content introduction data based on the portion;

transmission of the content introduction data to another apparatus is controlled by making use of a first communication section;

a second communication section receives the content introduction data and store the content introduction data in a second storage section; and

a content reproduction section is controlled to reproduce the content introduction data stored in the second storage section as a portion cut out from the content.

In accordance with a third embodiment of the present invention, there is provided an information processing apparatus including:

a communication section configured to exchange information with another apparatus;

a storage section configured to store a content;

a data generation section configured to cut out a portion of the content stored in the storage section and generate content introduction data based on the portion; and

a transmission control section configured to control transmission of the content introduction data to the other apparatus by making use of the communication section.

It is possible to provide the information processing apparatus according to the third embodiment of the present invention with a configuration in which the data generation section generates apparatus information of the information processing apparatus and includes the apparatus information and the cut-out portion of the content in the content introduction data.

In addition, it is also possible to provide the information processing apparatus according to the third embodiment of the present invention with a configuration in which the data generation section generates purchasing information to purchase the content including the cut-out portion and includes the purchasing information and the cut-out portion of the content in the content introduction data.

On top of that, it is also possible to provide the information processing apparatus according to the third embodiment of the present invention with a configuration further including:

a user-information acquisition section configured to acquire user information on a user owning the other apparatus in a predetermined communication mode and information on a favorite with the user on the basis of information, which is included in the user information; and

a content search section configured to search the storage section for a content serving as a favorite with the user on the basis of information, which is included in the user information acquired by the user-information acquisition section, as information on content-related favorites of the user,

wherein the data generation section generates the content introduction data based on the content found by the content search section.

Furthermore, it is also possible to provide the information processing apparatus according to the third embodiment of the present invention with a configuration in which the predetermined communication mode is a communication mode for carrying out direct radio communications between apparatus as communications passing through no access point.

Moreover, it is also possible to provide the information processing apparatus according to the third embodiment of the present invention with a configuration in which the data generation section cuts out a predetermined portion of the content on the basis of information included in the content or on the basis of an operation input entered by a user owning the information processing apparatus to an operation input section employed in the information processing apparatus.

In addition, it is also possible to provide the information processing apparatus according to the third embodiment of the present invention with a configuration in which the data generation section includes a data conversion section configured to convert at least a portion of the content.

In accordance with a fourth embodiment of the present invention, there is provided an information processing method or an information processing program. The information processing method or the information processing program has the steps of:

cutting out a portion of a content stored in a storage section and generating content introduction data based on the portion; and

controlling transmission of the content introduction data generated at the cutting out/generating step to another apparatus by making use of a communication section.

According to either of the information processing method and the information processing program, which are provided in accordance with the fourth embodiment of the present invention as described above:

a portion of a content stored in a storage section is cut out and used for generating content introduction data based on the portion; and

transmission of the content introduction data generated at the cutting out/generating step to another apparatus is controlled by making use of a communication section.

In accordance with a fifth embodiment of the present invention, there is provided an information processing apparatus including:

a communication section configured to exchange information with another apparatus;

a storage section configured to store content data;

a content reproduction section configured to reproduce the content data; and

a control section configured to control
the communication section to receive content introduction data, which includes at least a portion cut out by the other apparatus from a content, information on the other apparatus and information on a method to purchase the content, from the other apparatus,
the content reproduction section to reproduce the cut-out portion included in the content introduction data, and
the communication section to transmit the information on the other apparatus and a signal making a request for purchasing of the content in accordance with the information on the other apparatus and the information on a method to purchase the content.

It is possible to provide the information processing apparatus according to the fifth embodiment of the present invention with a configuration in which the content introduction data further includes information on a method to purchase the content introduced by the content introduction data.

In addition, it is possible to provide the information processing apparatus according to the fifth embodiment of the present invention with a configuration in which:

the information processing apparatus further has a display section for displaying information;

the communication section receives content introduction data generated by a specific one of the other apparatus;

the display section shows information on a process to purchase a content introduced by the content introduction data as a content purchasing process based on information included in the content introduction data as information on a method to purchase the content; and

the communication section transmits a signal representing a request to purchase the content introduced by the content introduction data and information on the specific one of the other apparatus generating the content introduction data to a server when the operation input section receives a command to purchase the content introduced by the content introduction data.

In addition, it is possible to provide the information processing apparatus according to the fifth embodiment of the present invention with a configuration further having:

a user-information acquisition section configured to acquire registered-user information on a registered user in a predetermined communication mode; and

a content search section configured to search the storage section for a content serving as a favorite with a registered user owning one of the other apparatus to serve as an apparatus to receive the content introduction data on the basis of information included in the registered-user information acquired by the user-information acquisition section as information on content-related favorites of the user,

wherein the data generation section generates the content introduction data based on the content found by the content search section.

In addition, it is possible to provide the information processing apparatus according to the fifth embodiment of the present invention with a configuration further having:

an information acquisition section configured to acquire user information transmitted by the second a particular one of the other apparatus existing in a communication range in a communication mode for carrying out direct radio communications between apparatus as communications passing through no access point; and

a content search section configured to search the storage section for a content serving as a favorite with a user owning the particular one of the other apparatus to serve as an apparatus to receive the content introduction data on the basis of information included in the registered-user information acquired by the user-information acquisition section as information on content-related favorites of the user,

wherein the data generation section generates the content introduction data based on the content found by the content search section.

In addition, it is possible to provide the information processing apparatus according to the fifth embodiment of the present invention with a configuration in which the data generation section has a cutout section configured to cut out a predetermined portion of the content on the basis of information included in the content or on the basis of an operation input entered by a user owning the information processing apparatus to the operation input section employed in the information processing apparatus.

On top of that, it is possible to provide the information processing apparatus according to the fifth embodiment of the present invention with a configuration in which the data generation section has a data conversion section configured to convert at least a portion of the information included in the content.

In accordance with a sixth embodiment of the present invention, there is provided an information processing method or an information processing program. The information processing method or the information processing program including the step of controlling:

a communication section to receive content introduction data, which includes at least a portion cut out by another apparatus from a content, information on the other apparatus and information on a method to purchase the content, from the other apparatus;

a content reproduction section to reproduce the cut-out portion included in the content introduction data; and

the communication section to transmit the information on the other apparatus and a signal making a request for purchasing of the content in accordance with the information on the other apparatus and the information on a method to purchase the content.

According to either of the information processing method and the information processing program, which are provided in accordance with the sixth embodiment of the present invention as described above:

a communication section is controlled to receive content introduction data, which includes at least a portion cut out by another apparatus from a content, information on the other apparatus and information on a method to purchase the content, from the other apparatus;

a content reproduction section is controlled to reproduce the cut-out portion included in the content introduction data; and

the communication section is controlled to transmit the information on the other apparatus and a signal making a request for purchasing of the content in accordance with the information on the other apparatus and the information on a method to purchase the content.

At least, two apparatus are connected to a network to form a mechanism allowing any one of the apparatus to transmit information to any others of the apparatus. A communication through the network can be a communication carried out between apparatus independent of each other or between blocks composing the same apparatus.

A communication is of course a radio or wire communication. As an alternative, a communication is a mixed communication, which is a combination of radio and wire communications. To be more specific, the mixed communication is carried out as a radio communication in a region but as a wire communication in another region. In addition, a communication from a specific apparatus to another apparatus can be carried out as a wire communication while a communication from the other apparatus to the specific apparatus can be carried out as a wire communication.

As described above, in accordance with the present invention, a portion of a content can be exchanged among a plurality of apparatus. In particular, information on a sender of information including the exchanged portion of a content is transmitted along with the information including the exchanged portion of a content. Thus, when a content is introduced by an introducer and purchased as a result of the introduction, the introducer of the content can be recognized.

### BRIEF DESCRIPTION OF THE DRAWINGS

FIG. 1 is an explanatory diagram showing an information communication system including information communication terminals each provided by the present invention;

FIG. 2 is a diagram showing the front view of the external appearance of the information communication terminal;

FIG. 3 is a diagram showing the rear view (opposite side to the face on which the display unit is visible) of the external appearance of the information communication terminal;

FIG. 4 is a diagram showing the top view of the external appearance of the information communication terminal where the top is defined as the side having a WLAN on/off switch;

FIG. 5 is a diagram showing the right-side view of the external appearance of the information communication terminal where the right side is defined as the side located in the right when seen from a position at which a display unit of the information communication terminal is visible or, in other words, the right side is defined as the side having a communication-state notification light emitting unit;

FIG. 6 is a diagram showing the left-side view of the external appearance of the information communication terminal where the left side is defined as the side located in the left when seen from a position at which the display unit of the information communication terminal is visible or, in other words, the right side is defined as the side having the WLAN on/off switch and a power-supply switch;

FIG. 7 is a diagram showing the bottom view of the external appearance of the information communication terminal where the bottom is defined as the side having the power-supply switch and a music key;

FIG. 8 is a diagram showing the front view of the external appearance of the information communication terminal with its cover slid upward;

FIG. 9 is an explanatory diagram showing a continuous display panel;

FIG. 10 explains pieces of information shown on the continuous display panel;

FIG. 11 is a block diagram showing the internal configuration of the information communication terminal;

FIG. 12 is a software-stack diagram showing the configuration of software executed by an application processor;

FIG. 13 is a software-stack diagram showing the configuration of software executed by an audio processor;

FIG. 14 is a diagram showing a typical display of a home screen;

FIG. 15 is a diagram showing a typical display of the screen in a recording wait state;

FIG. 16 is a diagram showing a typical display of the screen in a recording state;

FIG. 17 is a diagram showing a typical display of the screen in a stopped-recording state, that is, a state of waiting for reproduction of recorded audio data (or, a temporarily stopped reproduction state);

FIG. 18 is a diagram showing a typical display of the screen in a state of reproducing recorded audio data;

FIG. 19 is a diagram showing a typical display screen in execution of a photo viewer;

FIG. 20 is a diagram showing a typical screen for creation of a new text;

FIG. 21 is an explanatory diagram showing a context menu;

FIG. 22 is an explanatory diagram referred to in description of a character predictive conversion function;

FIG. 23 is an explanatory diagram referred to in description of communications in an ad-hoc mode;

FIG. 24 is an explanatory diagram referred to in description of pieces of typical information transmitted by an information communication terminal in an ad-hoc mode by adoption of a broadcasting transmission technique;

FIG. 25 is an explanatory diagram showing ad-hoc user list display screens;

FIG. 26 is an explanatory diagram referred to in description of typical user information exchanged in a mutual registration process;

FIG. 27 is an explanatory diagram showing a menu screen;

FIG. 28 is an explanatory diagram showing a search screen;

FIG. 29 is an explanatory diagram showing a musical-data reproduction display screen;

FIG. 30 is an explanatory diagram showing an ad-hoc user list display screen;

FIG. 31 is an explanatory diagram showing a released-playlist list display screen;

FIG. 32 is an explanatory diagram showing a track display screen;

FIG. 33 is an explanatory diagram showing the top screen of a communication application;

FIG. 34 is an explanatory diagram showing a login screen;

FIG. 35 is an explanatory diagram showing a contact list display screen;

FIG. 36 is an explanatory diagram showing a web browser menu screen;

FIG. 37 is an explanatory diagram showing a connection screen;

FIG. 38 is an explanatory diagram showing a message display screen;

FIG. 39 is an explanatory diagram showing a web-page display screen;

FIG. 40 is an explanatory diagram showing a standby screen;

FIG. 41 is an explanatory diagram showing a method of distributing a content in more detail;

FIG. 42 is an explanatory diagram showing typical content data generated by a content distribution server;

FIG. 43 is a functional block diagram showing functions, which are executed by an application processor when an application program for controlling a process to generate push data and transmit the generated push data is activated;

FIG. 44 is an explanatory diagram showing typical user information;

FIG. 45 is an explanatory diagram showing typical broadcasted information;

FIG. 46 is an explanatory diagram showing the structure of push data;

FIG. 47 is a block diagram showing the configuration of a content introduction service server;

FIG. 48 is an explanatory functional block diagram showing processing carried out by a CPU employed in the content introduction service server shown in FIG. 47;

FIG. 49 shows an explanatory flowchart representing processing to exchange contents in a content providing system;

FIG. 50 shows an explanatory flowchart representing processing to generate data for introducing a content and transmit the data;

FIG. 51 shows an explanatory flowchart representing processing to select a content to be introduced in an ad-hoc mode;

FIG. 52 shows an explanatory flowchart representing processing to select a content to be introduced in an infrastructure mode;

FIG. 53 shows an explanatory flowchart representing processing to generate data for introducing a content;

FIG. 54 shows an explanatory flowchart representing processing carried out by an apparatus receiving data for introducing a content;

FIG. 55 shows a continuation of the explanatory flowchart representing processing carried out by an apparatus receiving data for introducing a content;

FIG. 56 shows an explanatory flowchart representing processing carried out by a content introduction service server in a process to sell a content; and

FIG. 57 shows an explanatory flowchart representing processing to generate information for promoting distribution of a content and transmit the information to apparatus.

### DETAILED DESCRIPTION OF THE PREFERRED EMBODIMENTS

Before preferred embodiments of the present invention are explained, relations between disclosed inventions and the embodiments are explained in the following comparative description. This description is intended to ensure that the embodiments according to the present invention conform to the specification and drawings therein. It is to be noted that, even if there is an embodiment described in this specification but not included in the following comparative description as an embodiment corresponding to an invention, such an embodiment is not to be interpreted as an embodiment not corresponding to an invention. Conversely speaking, an embodiment included in the following comparative description as an embodiment corresponding to a specific invention is not to be interpreted as an embodiment not corresponding to an invention other than the specific invention.

In addition, the following comparative description is not to be interpreted as a comprehensive description covering all inventions disclosed in this specification. In other words, the following comparative description by no means denies existence of inventions disclosed in this specification but not included in claims as inventions for which a patent application is filed. That is to say, the following comparative description by no means denies existence of inventions to be included in a separate application for a patent, included in an amendment to this specification or added in the future.

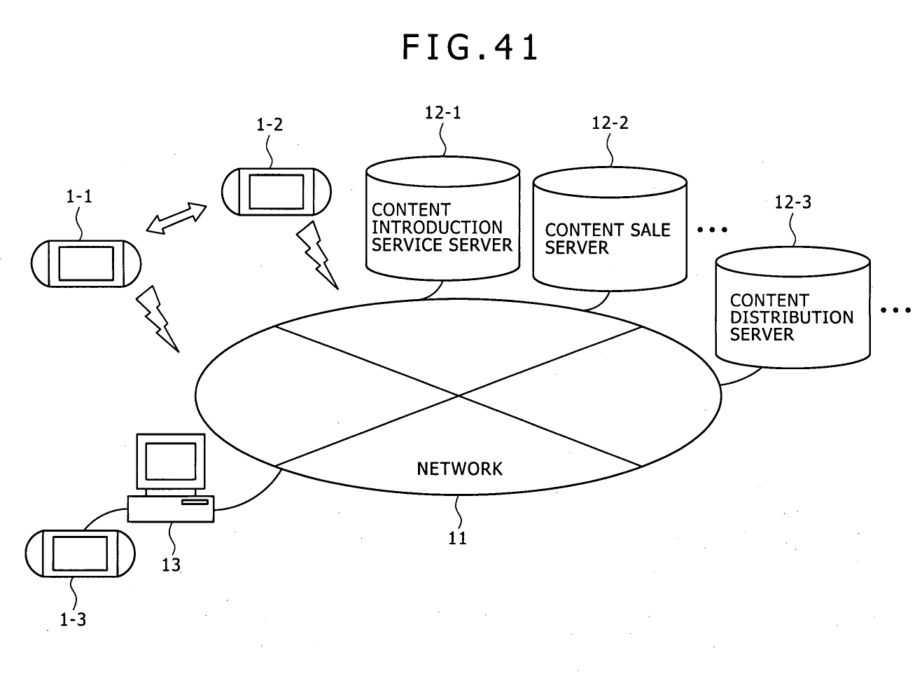

In accordance with a first embodiment of the present invention, there is provided an information processing system (such as a system shown in FIG. 41) including an information processing apparatus (such as an information communication terminal 1 and a personal computer 13, which are shown in FIG. 41) and another information processing apparatus (such as another information communication terminal 1 and another personal computer 13, which are shown in FIG. 41) different from the information processing apparatus wherein:

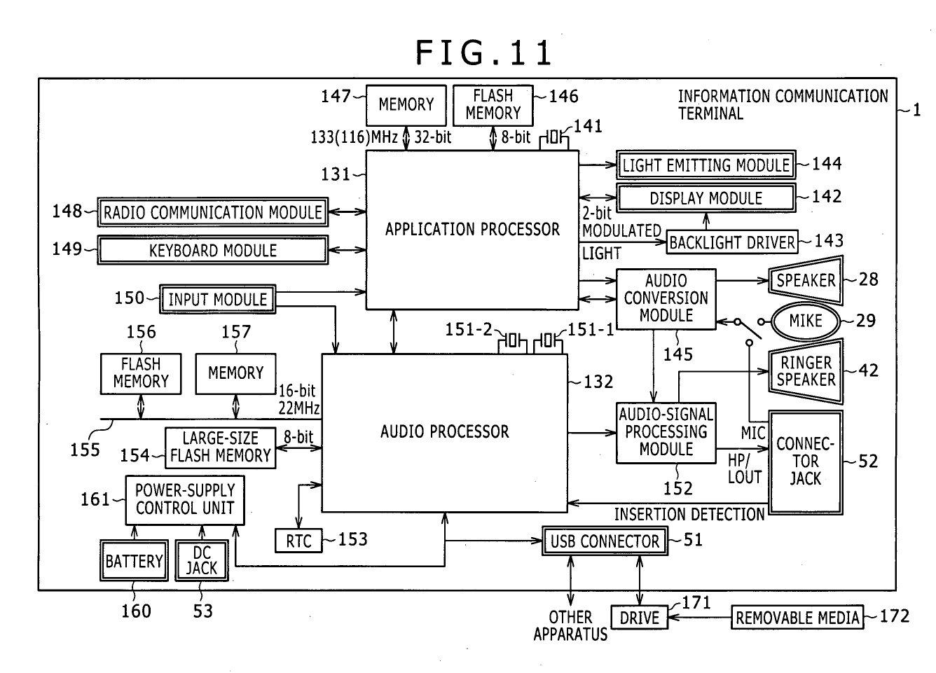

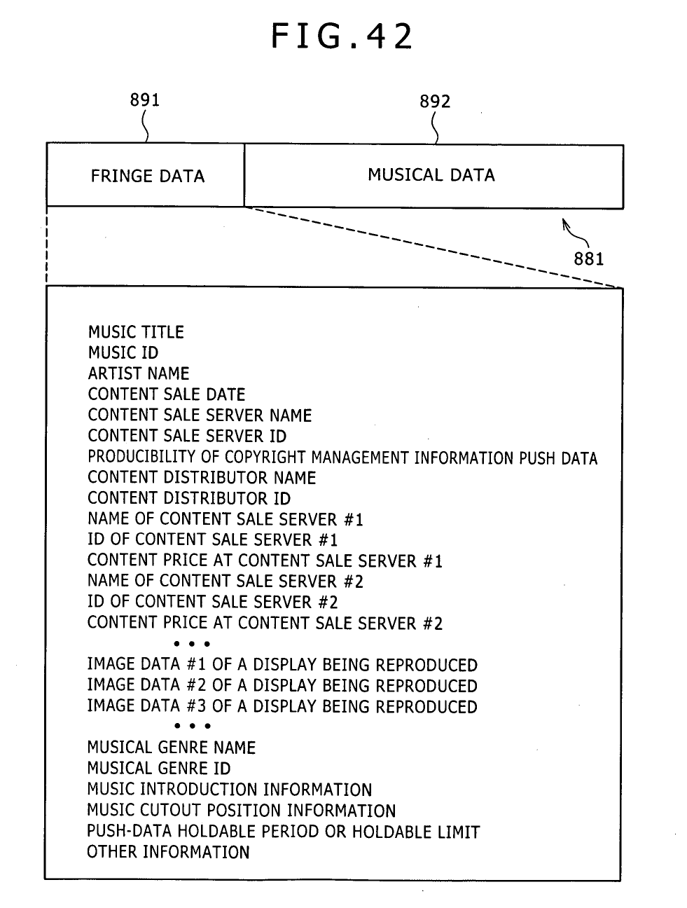

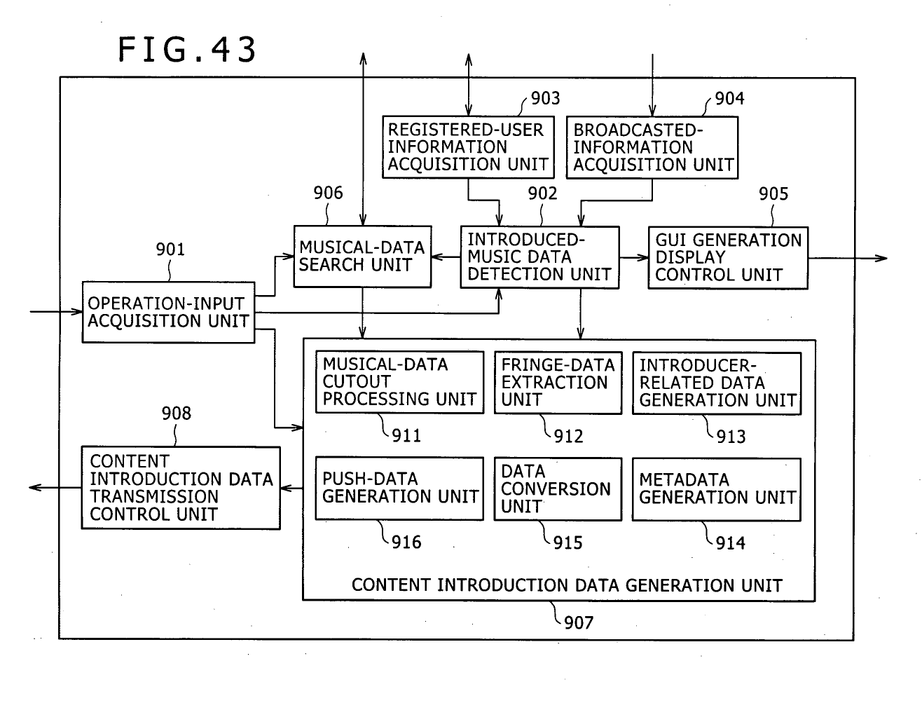

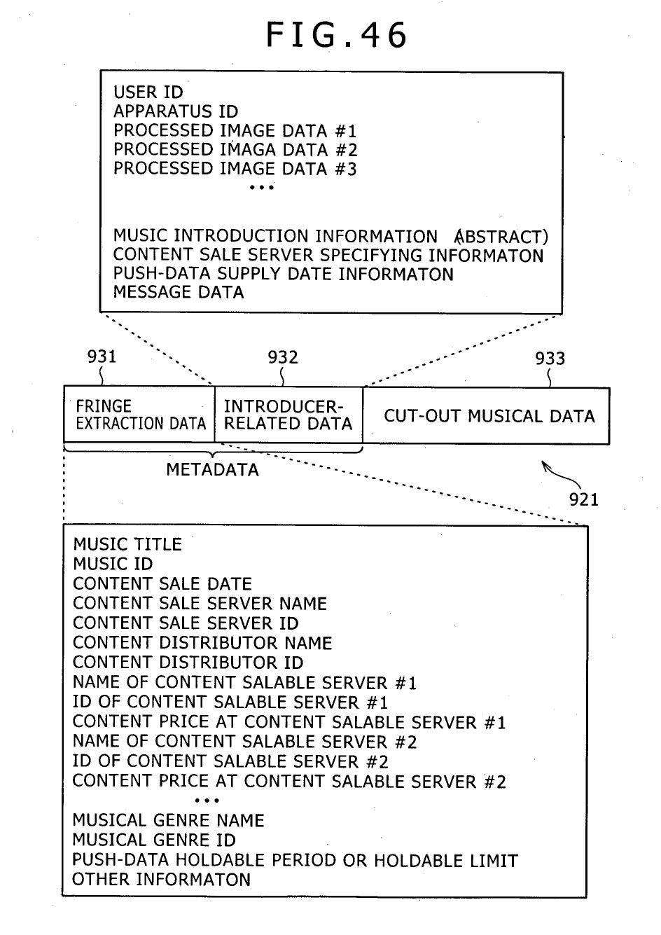

the information processing apparatus has
a first communication section (such as a radio communication module 148 shown in FIG. 11) configured to exchange information,
a first storage section (such as a large-size flash memory 154 shown in FIG. 11) configured to store a content (such as a content 811 shown in FIG. 42),
a data generation section (such as a content introduction data generation unit 907 shown in FIG. 43 as a functional unit of an application processor 131 shown in FIG. 11) configured to cut out a portion (such as cut-out musical data 933 shown in FIG. 46) of the content stored in the first storage section and generate content introduction data based on the portion, and
a transmission control section (such as a content introduction data transmission control unit 908 shown in FIG. 43 as a functional unit of the application processor 131 shown in FIG. 11) configured to control transmission of the content introduction data to another apparatus by making use of the first communication section; whereas

the other information processing apparatus has
a second communication section (such as the radio communication module 148 shown in FIG. 11) configured to exchange information,
a second storage section (such as the large-size flash memory 154 shown in FIG. 11) configured to store a content,
a content reproduction section (such as the content introduction data generation unit 907 shown in FIG. 43 as a functional unit of the application processor 131 shown in FIG. 11) configured to reproduce the content, and
a control section (such as the application processor 131 and an audio processor 132, which are shown in FIG. 11) configured to store the content introduction data received by the second communication section from the information processing apparatus as a portion cut out from the content in the information processing apparatus in the second storage section and control the content reproduction section to reproduce the content introduction data stored in the second storage section.

It is possible to provide the information processing system according to the first embodiment of the present invention with a configuration in which:

the data generation section employed in the information processing apparatus generates purchasing information (such as some of fringe extraction data 931 shown in FIG. 46) to purchase the content and includes the purchasing information and the cut-out portion of the content in the content introduction data; and

the control section employed in the other information processing apparatus controls the second communication section to receive the content introduction data and transmit a signal making a request for purchasing of the content in accordance with the purchasing information.

In addition, it is also possible to provide the information processing system according to the first embodiment of the present invention with a configuration in which:

the data generation section employed in the information processing apparatus generates apparatus information (such as some of introducer-related data 932 shown in FIG. 46) of the information processing apparatus and includes the apparatus information and the cut-out portion of the content in the content introduction data; and
the control section employed in the other information processing apparatus controls the second communication section to receive the content introduction data and transmit a signal making a request for purchasing of the content along with the apparatus information.

In accordance with a second embodiment of the present invention, there is provided an information processing method including the steps of:

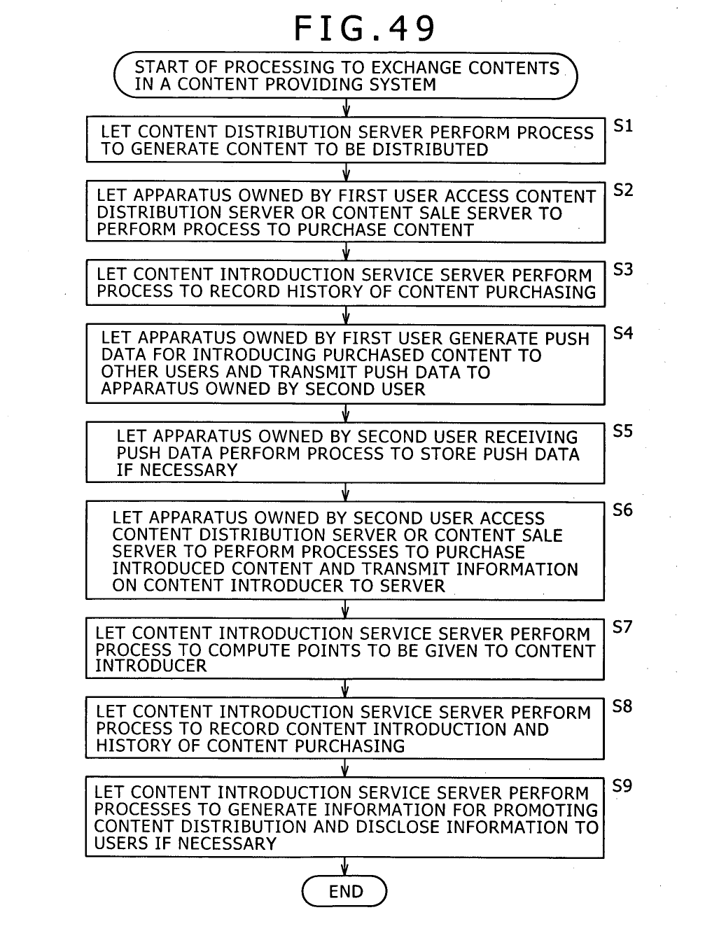

cutting out a portion (such as the cut-out musical data 933 shown in FIG. 46) of a content stored in a first storage section (such as the large-size flash memory 154 shown in FIG. 11) and generating content introduction data (such as push data) based on the portion (for example in a process carried out at a step S4 of a flowchart shown in FIG. 49);

controlling transmission of the content introduction data to another apparatus (such as either of the information communication terminal 1 and the personal computer 13, which are shown in FIG. 41) by making use of a first communication section (such as the radio communication module 148 shown in FIG. 11) (for example in a process carried out at the step S4 of the flowchart shown in FIG. 49);

letting a second communication section (such as the radio communication module 148 shown in FIG. 11) receive the content introduction data and store the content introduction data in a second storage section (such as the large-size flash memory 154 shown in FIG. 11) (for example in a process carried out at a step S5 of the flowchart shown in FIG. 49); and

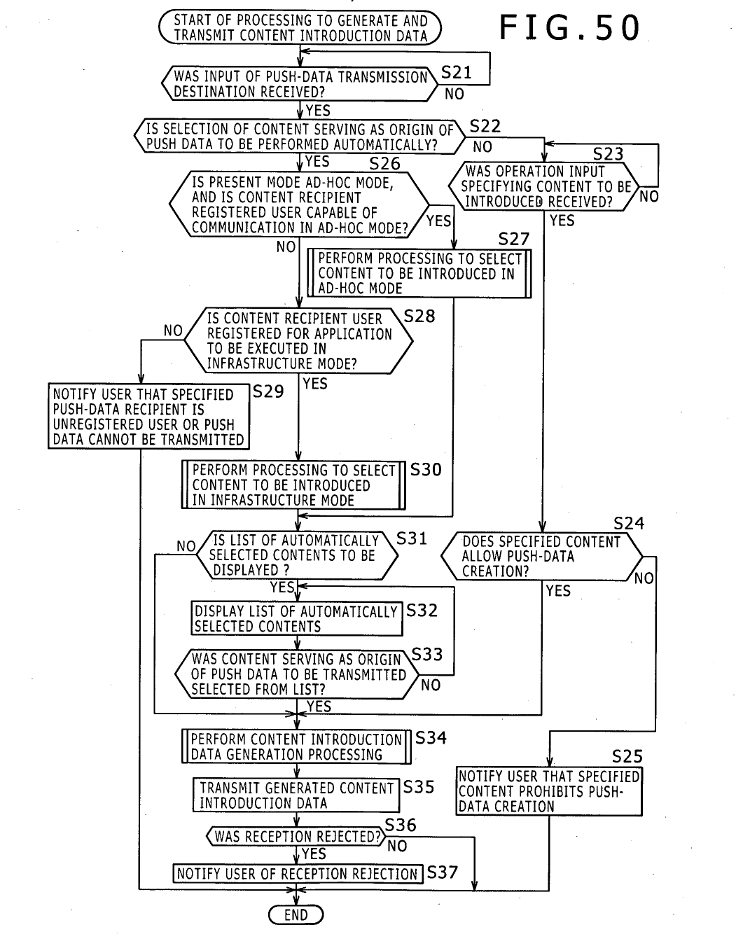

controlling a content reproduction section (such as the content introduction data generation unit 907 shown in FIG. 43 as a functional unit of the application processor 131 shown in FIG. 11) to reproduce the content introduction data stored in the second storage section as the portion cut out from the content (for example in a process carried out at a step S34 of a flowchart shown in FIG. 50).

In accordance with a third embodiment of the present invention, there is provided an information processing apparatus (such as either of the information communication terminal 1 and the personal computer 13, which are shown in FIG. 41) including:

a communication section (such as the radio communication module 148 shown in FIG. 11) configured to exchange information with another apparatus (such as either of another information communication terminal 1 and another personal computer 13, which are shown in FIG. 41);

a storage section (such as the large-size flash memory 154 shown in FIG. 11) configured to store a content;

a data generation section (such as the content introduction data generation unit 907 shown in FIG. 43 as a functional unit of the application processor 131 shown in FIG. 11) configured to cut out a portion (such as the cut-out musical data 933 shown in FIG. 46) of the content stored in the storage section and generate content introduction data (such as push data) based on the portion; and

a transmission control section (such as the content introduction data transmission control unit 908 shown in FIG. 43 as a functional unit of the application processor 131 shown in FIG. 11) configured to control transmission of the content introduction data to the other apparatus by making use of the communication section.

It is possible to provide the information processing apparatus according to the third embodiment of the present invention with a configuration in which the data generation section generates apparatus information (such as some of the introducer-related data 932 shown in FIG. 46) of the information processing apparatus and includes the apparatus information and the cut-out portion of the content in the content introduction data.

In addition, it is also possible to provide the information processing apparatus according to the third embodiment of the present invention with a configuration in which the data generation section generates purchasing information (such as some of the fringe extraction data 931 shown in FIG. 46) to purchase the content including the cut-out portion and includes the purchasing information and the cut-out portion of the content in the content introduction data.

On top of that, it is also possible to provide the information processing apparatus according to the third embodiment of the present invention with a configuration further including:

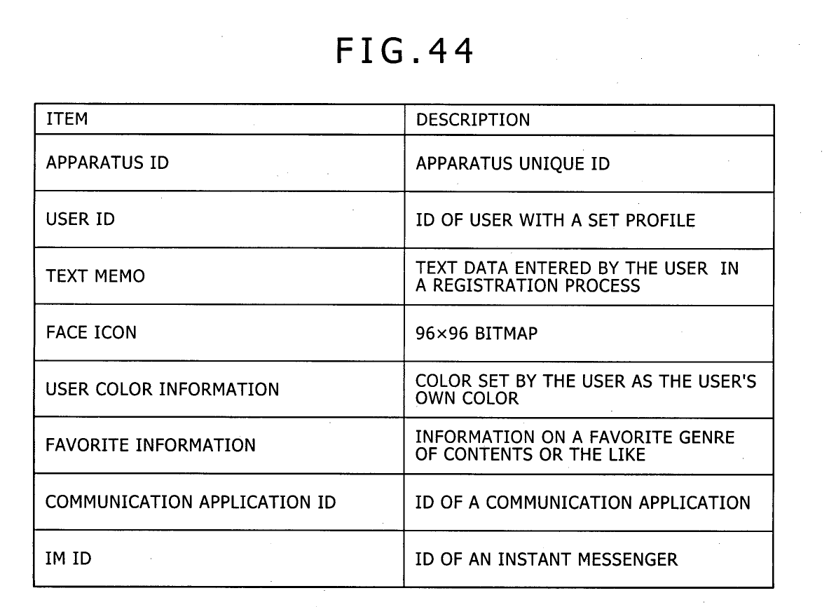

a user-information acquisition section (such as a registered-user information acquisition unit 903 shown in FIG. 43) configured to acquire user information (such as user information shown in FIG. 44) on a user owning the other apparatus in a predetermined communication mode and information on a favorite with the user on the basis of information, which is included in the user information; and
a content search section (such as a introduced-music data detection unit 902 and a musical-data search unit 906, which are shown in FIG. 43) configured to search the storage section for a content serving as a favorite with the user on the basis of information, which is included in the user information acquired by the user-information acquisition section, as information on content-related favorites of the user,

wherein the data generation section generates the content introduction data based on the content found by the content search section.

Furthermore, it is also possible to provide the information processing apparatus according to the third embodiment of the present invention with a configuration in which the predetermined communication mode is a communication mode (such as the ad-hoc mode) for carrying out direct radio communications between apparatus as communications passing through no access point.

Moreover, it is also possible to provide the information processing apparatus according to the third embodiment of the present invention with a configuration in which the data generation section cuts out a predetermined portion (such as the cut-out musical data 933 shown in FIG. 46) of the content on the basis of information (such as fringe data 891 shown in FIG. 42) included in the content or on the basis of an operation input entered by a user owning the information processing apparatus to an operation input section (such as an input module 150 shown in FIG. 11) employed in the information processing apparatus.

In addition, it is also possible to provide the information processing apparatus according to the third embodiment of the present invention with a configuration in which the data generation section includes a data conversion section (such as a data conversion unit 915 shown in FIG. 43) configured to convert at least a portion of the content.

In accordance with a fourth embodiment of the present invention, there is provided an information processing method or an information processing program. The information processing method or the information processing program has the steps of:

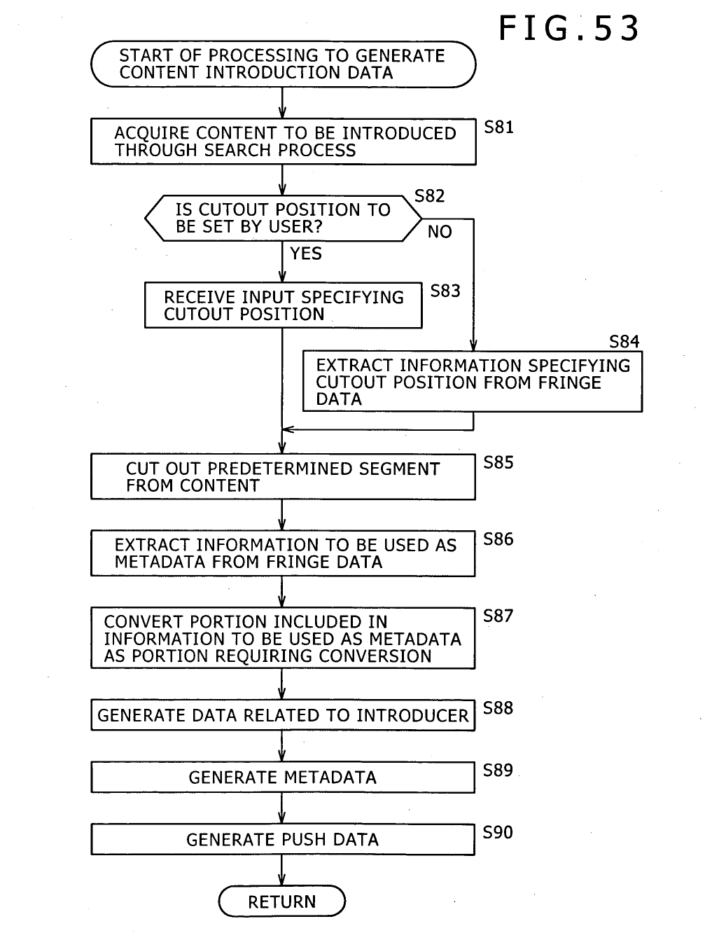

cutting out a portion (such as the cut-out musical data 933 shown in FIG. 46) of a content stored in a storage section (such as the large-size flash memory 154 shown in FIG. 11) and generating content introduction data (such as push data) based on the portion (for example in processes carried out at steps S82 to S90 of the flowchart shown in FIG. 53); and

controlling transmission of the content introduction data generated at the cutting out/generating step to another apparatus by making use of a communication section (such as the radio communication module 148 shown in FIG. 11) (for example in a process carried out at a step S35 of a flowchart shown in FIG. 50).

In accordance with a fifth embodiment of the present invention, there is provided an information processing apparatus (such as either of the information communication terminal 1 and the personal computer 13, which are shown in FIG. 41) including:

a communication section (such as the radio communication module 148 shown in FIG. 11) configured to exchange information with another apparatus (such as either of another information communication terminal 1 and another personal computer 13, which are shown in FIG. 41);

a storage section (such as the large-size flash memory 154 shown in FIG. 11) configured to store content data;

a content reproduction section (such as the content introduction data generation unit 907 shown in FIG. 43 as a functional unit of the application processor 131 shown in FIG. 11) configured to reproduce the content data; and

a control section (such as the application processor 131 and the audio processor 132, which are shown in FIG. 11) configured to control
the communication section to receive content introduction data (such as push data), which includes at least a portion (such as fringe extraction data 931 and cut-out musical data 933) cut out by the other apparatus from a content, information (such as introducer-related data 932) on the other apparatus and information (such as fringe extraction data 931 shown in FIG. 46) on a method to purchase the content, from the other apparatus,
the content reproduction section to reproduce the cut-out portion included in the content introduction data, and
the communication section to transmit the information on the other apparatus and a signal making a request for purchasing of the content in accordance with the information on the other apparatus and the information on a method to purchase the content.

It is possible to provide the information processing apparatus according to the fifth embodiment of the present invention with a configuration in which the content introduction data further includes information (such as fringe extraction data 931 shown in FIG. 46) on a method to purchase the content introduced by the content introduction data.

In addition, it is possible to provide the information processing apparatus according to the fifth embodiment of the present invention with a configuration in which:

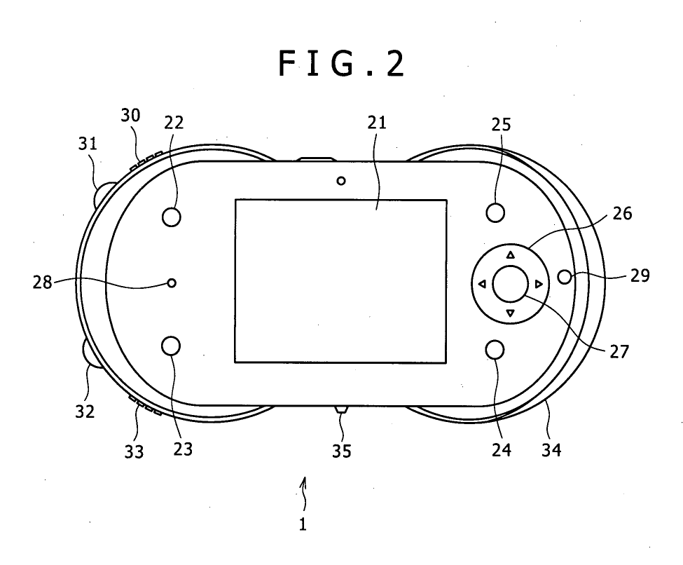

the information processing apparatus further has a display section (such as a display unit 21 shown in FIG. 2) for displaying information;

the communication section receives content introduction data (such as push data) generated by a specific one of the other apparatus;

the display section shows information on a process to purchase a content introduced by the content introduction data as a content purchasing process based on information included in the content introduction data as the information (such as some of the fringe extraction data 931 shown in FIG. 46) on a method to purchase the content; and

the communication section transmits a signal representing a request to purchase the content introduced by the content introduction data and information on the specific one of the other apparatus generating the content introduction data to a server (such as either of a content introduction service server 12-1, a content sale server 12-2 and a content distribution server 12-3, which are shown in FIG. 41) when the operation input section receives a command to purchase the content introduced by the content introduction data.

In addition, it is possible to provide the information processing apparatus according to the fifth embodiment of the present invention with a configuration further having:

a user-information acquisition section (such as the registered-user information acquisition unit 903 shown in FIG. 43) configured to acquire registered-user information on a registered user in a predetermined communication mode (such as an infrastructure mode or an ad-hoc mode); and

a content search section (such as a introduced-music data detection unit 902 and a musical-data search unit 906, which are shown in FIG. 43) configured to search the storage section for a content serving as a favorite with a registered user owning one of the other apparatus to serve as an apparatus to receive the content introduction data on the basis of information included in the registered-user information acquired by the user-information acquisition section as information on content-related favorites of the user,

wherein the data generation section generates the content introduction data based on the content found by the content search section.

In addition, it is possible to provide the information processing apparatus according to the fifth embodiment of the present invention with a configuration further having:

an information acquisition section (such as a broadcasted-information acquisition unit 904 shown in FIG. 43) configured to acquire user information transmitted by a particular one of the other apparatus existing in a communication range in a communication mode (such as ad-hoc mode) for carrying out direct radio communications between apparatus as communications passing through no access point; and

a content search section such as a introduced-music data detection unit 902 and a musical-data search unit 906, which are shown in FIG. 43) configured to search the storage section for a content serving as a favorite with a user owning the particular one of the other apparatus to serve as an apparatus to receive the content introduction data on the basis of information included in the registered-user information acquired by the user-information acquisition section as information on content-related favorites of the user,

wherein the data generation section generates the content introduction data based on the content found by the content search section.

In addition, it is possible to provide the information processing apparatus according to the fifth embodiment of the present invention with a configuration in which the data generation section has a cutout section (such as a musical-data cutout processing unit 911 shown in FIG. 43) configured to cut out a predetermined portion (such as the cut-out musical data 933 shown in FIG. 46) of the content on the basis of information (such as fringe data 891) included in the content or on the basis of an operation input entered by a user owning the information processing apparatus to an operation input section employed in the information processing apparatus.

On top of that, it is possible to provide the information processing apparatus according to the fifth embodiment of the present invention with a configuration in which the data generation section has a data conversion section (such as a data conversion unit 915 shown in FIG. 43) configured to convert at least a portion (such as an image or a text representing the lyrics) of the information included in the content.

In accordance with a sixth embodiment of the present invention, there is provided an information processing method or an information processing program. The information processing method or the information processing program including the step of controlling:

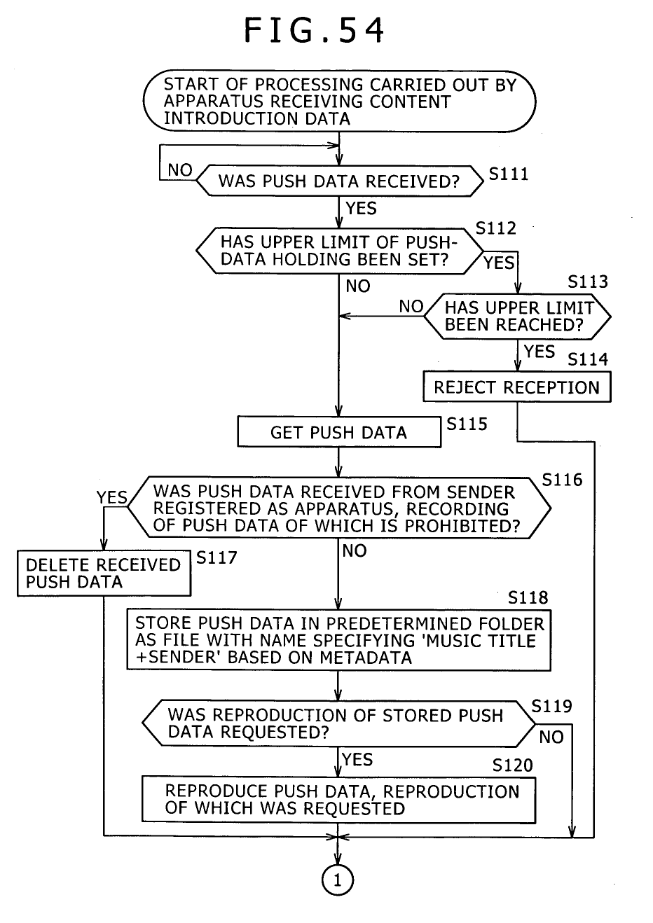

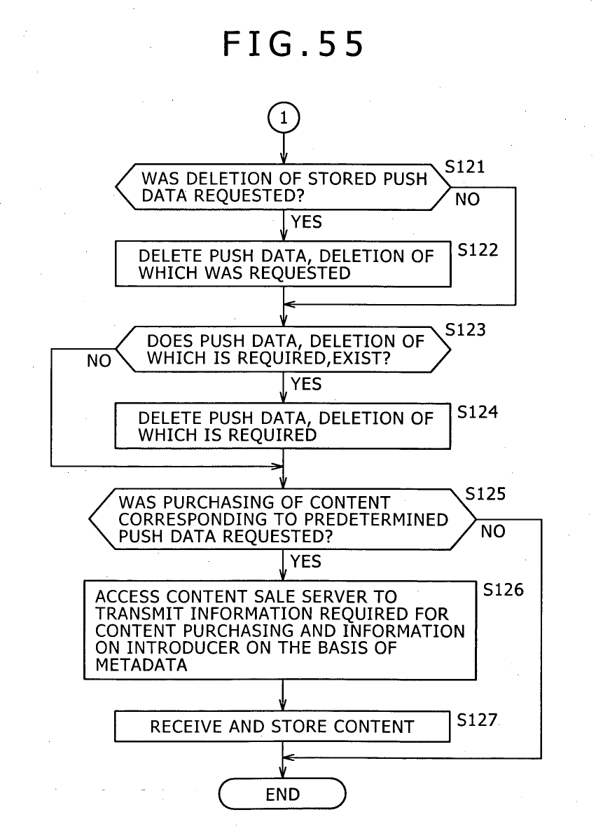

a communication section (such as the radio communication module 148 shown in FIG. 11) to receive content introduction data, which includes at least a portion (such as the cut-out musical data 933 shown in FIG. 46) cut out by another apparatus from a content, information (such as the introducer-related data 932 shown in FIG. 46) on the other apparatus and information (such as some of the fringe extraction data 931 shown in FIG. 46) on a method to purchase the content, from the other apparatus (for example in processing represented by flowcharts shown in FIGS. 54 and 55);

a content reproduction section (such as the content introduction data generation unit 907 shown in FIG. 43 as a functional unit of the application processor 131 shown in FIG. 11) to reproduce the cut-out portion included in the content introduction data (for example in the processes carried out at the steps S82 to S90 of the flowchart shown in FIG. 53); and

the communication section to transmit the information on the other apparatus and a signal making a request for purchasing of the content in accordance with the information on the other apparatus and the information on a method to purchase the content (for example in the process carried out at the step S35 of the flowchart shown in FIG. 50).

The embodiments of the present invention are explained by referring to diagrams as follows.

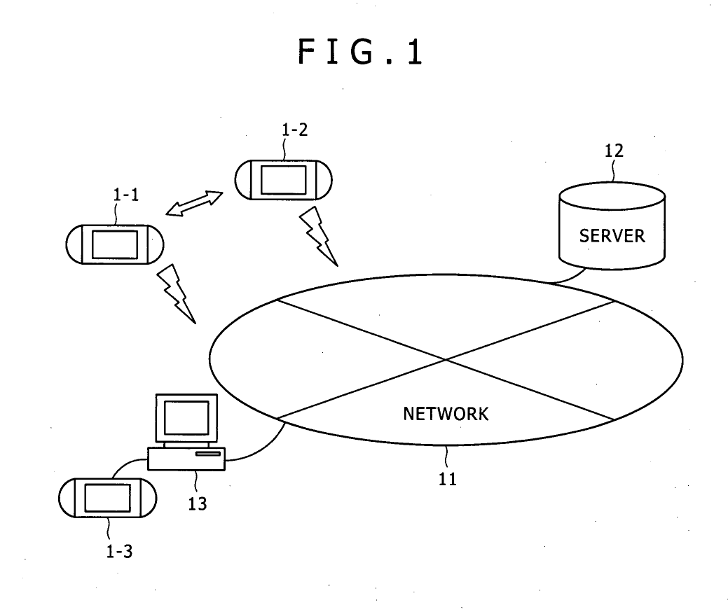

By referring to FIG. 1, the following description explains an information communication system including information communication terminals 1-1 to 1-3 each provided by the present invention. It is to be noted that the information communication terminals 1-1 to 1-3 shown in FIG. 1 have the same functions.

Typically, the information communication terminals 1-1 to 1-3 each execute a variety of programs in order to carry out a variety of functions such as a function to communicate information through radio or wired communication, a function to record various kinds of information, a function to reproduce audio and video data, a function to display various kinds of information such as recorded information, reproduced video information an GUI (Graphic User Interface) information serving as an aid helping the user enter an operation input via a variety of input devices and a function to receive an operation input entered by the user. In the following description, the information communication terminals 1-1 to 1-3 are each referred to simply as an information communication terminal 1, which is a generic name representing the information communication terminals 1-1 to 1-3, in case there is no need to distinguish the information communication terminals 1-1 to 1-3 from each other.

To put it concretely, the information communication terminal 1 has a WLAN (Wireless Local Area Network meaning a radio LAN) function conforming to typically a 802.11b standard as a function allowing the information communication terminal 1 to be connected to other apparatus and making the information communication terminal 1 capable of exchanging information with the other apparatus. The information communication terminal 1 is capable of selecting either an infrastructure mode or an ad-hoc mode. The WLAN infrastructure mode is a mode in which the information communication terminal 1 carries out a communication with another information communication terminal through an access point in the WLAN. On the other hand, the WLAN ad-hoc mode is a mode in which the information communication terminal 1 carries out a communication with another information communication terminal without using an access point in the WLAN. The information communication terminal 1 can also be connected to another apparatus by using a cable conforming to typically a USB (Universal Serial Bus) 2.0 standard so that the information communication terminal 1 is capable of exchanging information with the other apparatus. It is to be noted that the USB connection of the information communication terminal 1 may be implemented in accordance with either of an MSC (Mass Storage Class) mode and an MTP (Media Transfer Protocol) mode, either of which can be selected as a USB mode.

That is to say, if the information communication terminal 1 is an apparatus subscribing a predetermined service or an apparatus having a predetermined application program installed therein in order to implement predetermined setting, the information communication terminal 1 is capable of exchanging information with or without a predetermined access point with not only another information communication terminal, but also any other apparatus through a radio or wire communication.

Typically, the information communication terminal 1 includes a flash memory having a typical storage capacity of about 1 GB besides an ordinary volatile memory. In addition, if necessary, the information communication terminal 1 may be typically further provided with a large-capacity storage unit such as a hard disk. On top of that, the information communication terminal 1 has an LCD (Liquid Crystal Display) unit serving as a display device and also has a keyboard used as an input device. If necessary, the information communication terminal 1 may also be provided with other connected input devices such as a mouse and/or a joystick. The information communication terminal 1 may also be provided with a touch panel in addition to the LCD unit if required.

In addition, the information communication terminal 1 is capable of recording audio data supplied thereto and reproducing recorded audio data in accordance with an audio coding method such as an ATRAC3 (Advanced Transform Acoustic Coding 3) method, an MP3 (MPEG Audio Layer-3) method or a WMA (Windows® Media Audio) method. Furthermore, the information communication terminal 1 also has the so-called photo viewer function for storing video data and reproducing as well as displaying the recorded video data. Moreover, the information communication terminal 1 is capable of avoiding operations such as distribution and exchanging of illegal data without a consent given by its copyright holder in accordance with various kinds of DRM (Digital Rights Management) such as OpenMG management or WMT10 (Janus) management.

On top of that, the information communication terminal 1 may have a variety of application programs installed therein as programs to be executed to carry out various kinds of processing. The application programs include an IP telephone program, an instant messenger, an email program, a web browser and a text editor.

Furthermore, the information communication terminal 1 has such a size that the information communication terminal 1 can be grasped by a hand of the user, providing desirable convenience such as portability to the user.

In addition, the information communication terminal 1 can be connected to a network 11 such as the Internet directly by a radio communication so that the information communication terminal 1 is capable of exchanging information with a variety of servers 12, a variety of personal computers 13 and other information communication terminals 1 through the network 11. The other information communication terminals 1 are any of the information communication terminals 1-1 to 1-3 shown in the figure.

Moreover, the information communication terminal 1 is also capable of exchanging information directly with other information communication terminals 1 by a radio communication. The other information communication terminals 1 are any of the information communication terminals 1-1 to 1-3 shown in the figure.

On top of that, the information communication terminal 1 can be connected to the personal computer so that the information communication terminal 1 is capable of exchanging information with the personal computer 13 as well as a variety of servers and other information communication terminals through the network 11 (such as the Internet) connected to the personal computer 13. In the example shown in the figure, the information communication terminal 1-3 is connected to the personal computer 13.

In addition, it is needless to say that the network 11 employed in the information communication system can be connected to more information communication terminals 1, more servers 12 and more personal computers 13.

Next, the external appearance of the information communication terminal 1 is explained by referring to FIGS. 2 to 8. FIG. 2 is a diagram showing the front view of the external appearance of the information communication terminal 1.

As shown in the figure, the front face of the information communication terminal 1 has a display unit 21, a WLAN-mode switching button 22, a home button 23, a back button 24, an option button 25, 4-direction keys 26, an enter button 27, a speaker 28 and a mike 29. The left-side face of the information communication terminal 1 includes a WLAN on/off switch 30, a WLAN-state notification light emitting unit 31, a power-supply-state notification light emitting unit 32 and a power-supply switch 33. The left-side face is a face located on the left side when seen from a position facing the display unit 21. The right-side face of the information communication terminal 1 has a communication-state notification light emitting unit 34. The right-side face is a face located on the right side when seen from the position facing the display unit 21. The bottom of the information communication terminal 1 has a music key 35. The bottom is a face located on the lower side when seen from the position facing the display unit 21.

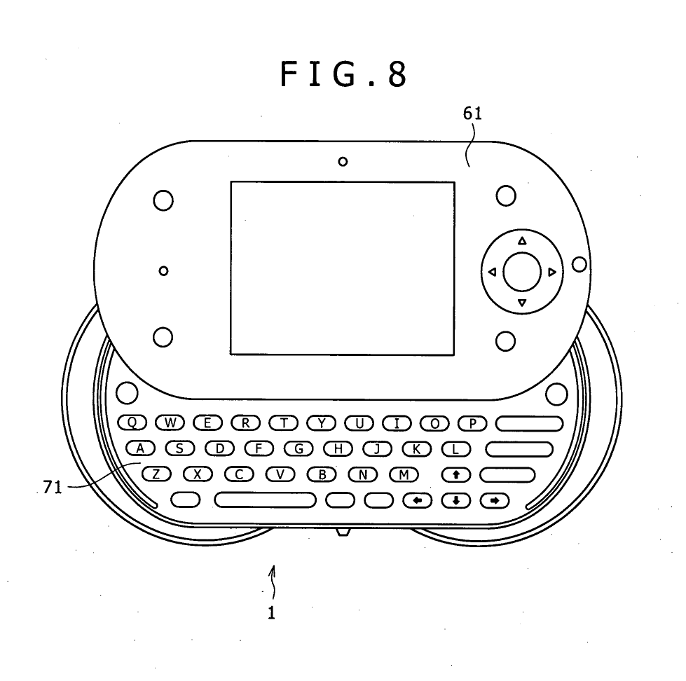

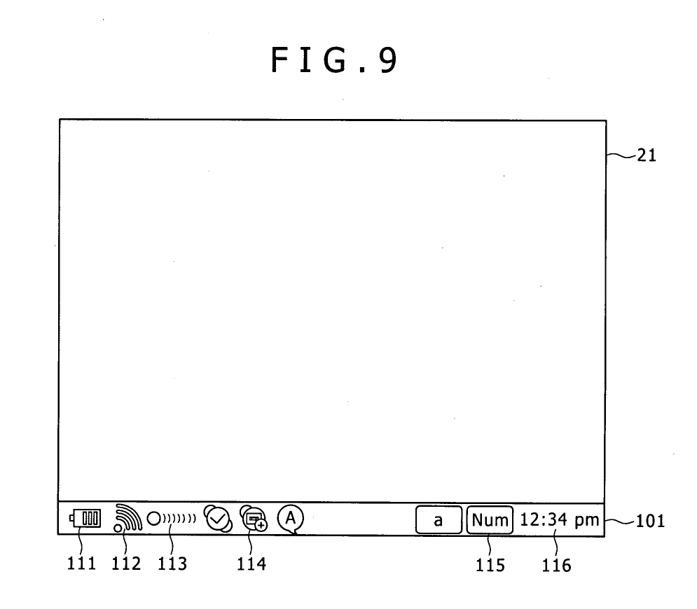

The display unit 21 is typically a flat display unit such as an LCD unit capable of displaying various kinds of information. The information displayed on the display unit 21 includes information on the state of the information communication terminal 1. Displays of the information on the state of the information communication terminal 1 are explained by referring to FIGS. 8 and 9. Other information displayed on the display unit 21 in various kinds of processing carried out by the information communication terminal 1 will also be properly described later.

The WLAN-mode switching button 22 is a button to be operated by the user to enter an operation input for switching the radio LAN on and off.

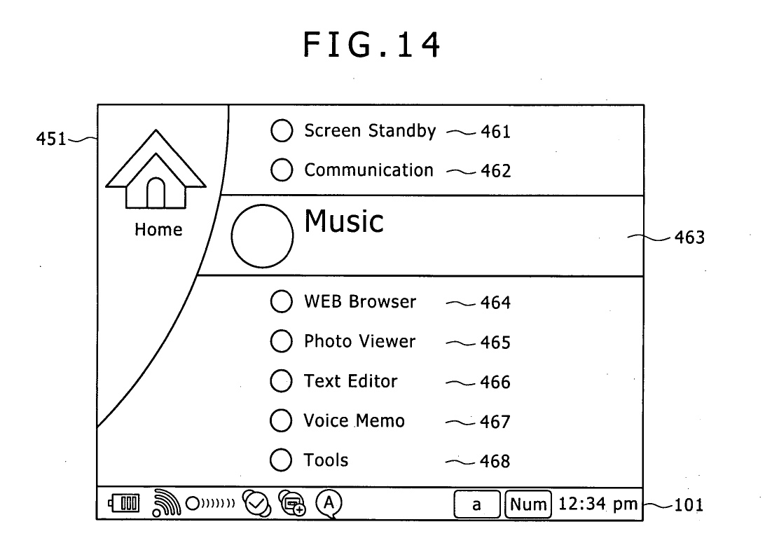

The home button 23 is a button to be operated by the user to enter an operation input for displaying a home menu on the display unit 21 without regard to the type of information currently displayed on the display unit 21. The home menu will be described later by referring to FIG. 14.

The back button 24 is a button to be operated by the user to enter an operation input for restoring the display screen displayed immediately before the current display screen.

The option button 25 is a button to be operated by the user to enter an operation input for showing a display screen used for displaying a variety of optional tools.

The 4-direction keys 26 are each a key to be operated by the user to enter an operation input for moving typically a cursor over a screen of information displayed on the display unit 21 in one of four directions, changing typically a selected button or a selected icon or carrying out another operation.

The enter button 27 is a button to be operated by the user to enter an operation input for making a final decision to determine a selected menu, a selected button, a selected icon or another selected item.

The speaker 28 is a speaker for outputting voices of a phone conversation such as in an IP telephone call and sounds reproduced by a predetermined application. The sounds reproduced by a predetermined application are audio data recorded in advance in the information communication terminal 1.

The mike 29 is an input component for inputting voices of a phone conversation in an IP telephone call and sounds acquired by a predetermined application.

The WLAN on/off switch 30 is a switch to be operated by the user to switch a radio communication function of the information communication terminal 1 from an enabled state to a disabled state and vice versa.

The WLAN-state notification light emitting unit 31 is typically a light emitting device and a light guide tube or a plurality of light emitting devices and a plurality of light guide tubes. An example of the light emitting device is an LED (light emitting diode). The WLAN-state notification light emitting unit 31 is a component for notifying the user of an enabled state or a disabled state of the radio communication function included in the information communication terminal 1. For example, if the radio communication function included in the information communication terminal 1 is in the enabled state, the WLAN-state notification light emitting unit 31 is turned on to emit light. If the radio communication function included in the information communication terminal 1 is in the disabled state, on the other hand, the WLAN-state notification light emitting unit 31 is turned off to cease transmission of light. In order to turn on the WLAN-state notification light emitting unit 31 or put the WLAN-state notification light emitting unit 31 in a blinking state, the communication-state notification light emitting unit 34 drives the LEDs to emit light through the light guide tubes.

The power-supply-state notification light emitting unit 32 is typically a light emitting device having an LED (light emitting diode) or a plurality of LEDs. The power-supply-state notification light emitting unit 32 is a component for notifying the user of information such as information on whether or not the power supply of the information communication terminal 1 has been turned on and whether the power supply is being electrically charged or the process to electrically charge the power supply has been completed. For example, the power-supply-state notification light emitting unit 32 is put in an on state when the power supply is turned on. When the power supply is turned off, on the other hand, the power-supply-state notification light emitting unit 32 is also put in an off state as well. In addition, when the power supply is being electrically charged, the power-supply-state notification light emitting unit 32 is put in an on state showing a color different from a color, which is shown when the power supply is turned on.

The power-supply switch 33 is a switch for turning the power supply of the information communication terminal 1 on or off.

The communication-state notification light emitting unit 34 is typically a light emitting device having an LED (light emitting diode) or a plurality of LEDs. The communication-state notification light emitting unit 34 is a component for notifying the user of the communication state of the information communication terminal 1. For example, in a WLAN infrastructure mode, the communication-state notification light emitting unit 34 is put in an on state showing a color different from a color, which is shown in a WLAN ad-hoc mode. When an IP telephone call arrives, the communication-state notification light emitting unit 34 is put in either of an on state and a blinking state, which show another color. That is to say, the communication-state notification light emitting unit 34 is put in an off state or either of the on and blinking states showing different colors depending on the radio communication state of the information communication terminal 1.

The WLAN infrastructure mode is a mode adopting a method of communication through a radio LAN access point. On the other hand, the WLAN ad-hoc mode adopting a method to directly exchange data among apparatus without making use of a radio LAN access point.

The music key 35 is a key used for entering an input making a request for an operation such as an operation to start a reproduction process, an operation to end a reproduction operation, a fast-forward operation, a rewind operation, a temporary stop, a reversed-direction AMS (Auto Music Scan) for the beginning of a piece of music or another operation.

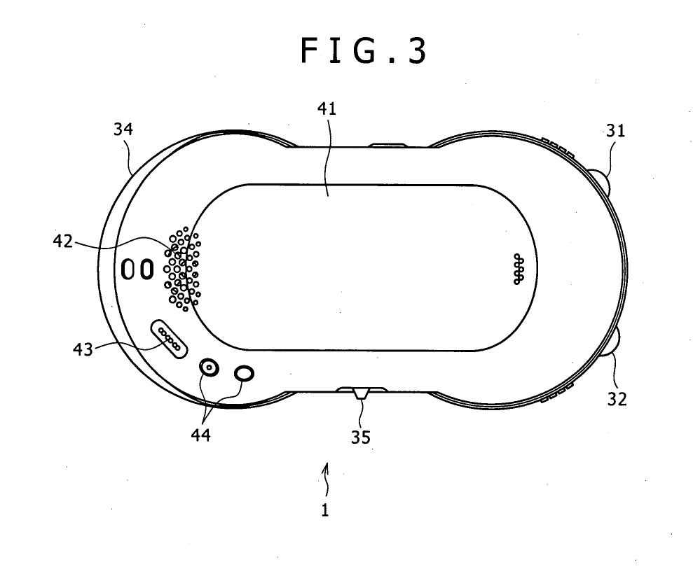

FIG. 3 is a diagram showing the rear view of the external appearance of the information communication terminal 1. The rear face is the face on the opposite side of the display unit 21.

As shown in the figure, the rear face of the information communication terminal 1 includes a battery cover 41 in addition to a ringer speaker 42, a hold switch 43 and a volume button 44, which are provided on a side in close proximity to the communication-state notification light emitting unit 34.

The battery cover 41 covers a battery mounting portion and a battery for supplying power to a variety of components employed in the information communication terminal 1.

The ringer speaker 42 is a speaker used mainly for outputting musical data stored on and reproduced from the information communication terminal 1 or outputting musical data streamed from another information communication terminal 1. The ringer speaker 42 is also a speaker for outputting, for example, a calling sound in the event of an arriving IP phone call.

The hold switch 43 is a switch to be operated by the user to invalidate inputs entered via all buttons and all switches in order to prevent an operation unintended by the user from being carried out due to an inadvertent operation performed on any of the buttons and switches typically when the information communication terminal 1 is kept in a pocket or a bag.

The volume button 44 is a button to be operated by the user to adjust the volume of a sound output by the ringer speaker 42.

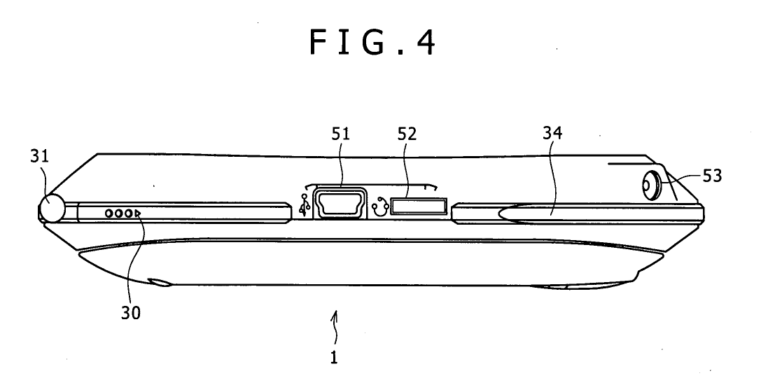

FIG. 4 is a diagram showing the top view of the external appearance of the information communication terminal. In this case, the top is defined as the side having the WLAN on/off switch 30.

As shown in the figure, the top of the information communication terminal 1 includes a USB connector 51, a connector jack 52 and a DC jack 53.

A USB cable is connected to the USB connector 51, allowing the information communication terminal 1 to exchange information with another apparatus. As the USB connector 51, it is demanded to provide at least a downstream-side connector, and an upstream-side connector may be provided. The downstream-side connector is the so-called series-B or series-mini-B connector for connecting the information communication terminal 1 to the personal computer 13. On the other hand, the upstream-side connector is the so-called series-A connector for connecting the information communication terminal 1 to a peripheral apparatus. In addition, the information communication terminal 1 can receive a power supply via a USB connection.

The connector jack 52 is typically a 10-pin flat connector for connecting the information communication terminal 1 to an audio input/output device such as a headphone or a mike.

The DC jack 53 is used for receiving power of a DC power supply. In general, the DC jack 53 is connected to an AC/DC converter for converting the 100V AC power generated by the home power supply into a DC power supplied to the information communication terminal 1.

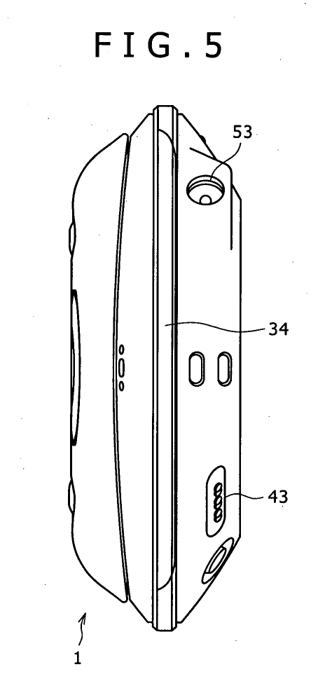

FIG. 5 is a diagram showing the right-side view of the external appearance of the information communication terminal 1. In this case, the right side is defined as the side located in the right when seen from a position at which the display unit 21 of the information communication terminal 1 is visible or, in other words, the right side is defined as the side having a communication-state notification light emitting unit 34.

As shown in FIG. 5, the right-side face of the information communication terminal 1 also includes the hold switch 43 and the DC jack 53 in addition to the communication-state notification light emitting unit 34.

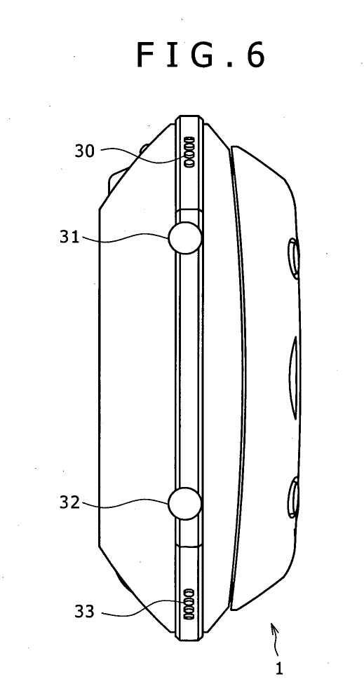

FIG. 6 is a diagram showing the left-side view of the external appearance of the information communication terminal 1. In this case, the left side is defined as the side located in the left when seen from a position at which a display unit 21 of the information communication terminal 1 is visible or, in other words, the right side is defined as the side having the WLAN on/off switch 30 and the power-supply switch 33.

As shown in FIG. 6, the left-side face of the information communication terminal 1 also includes the WLAN-state notification light emitting unit 31 and the power-supply-state notification light emitting unit 32 in addition to the WLAN on/off switch 30 and the power-supply switch 33.

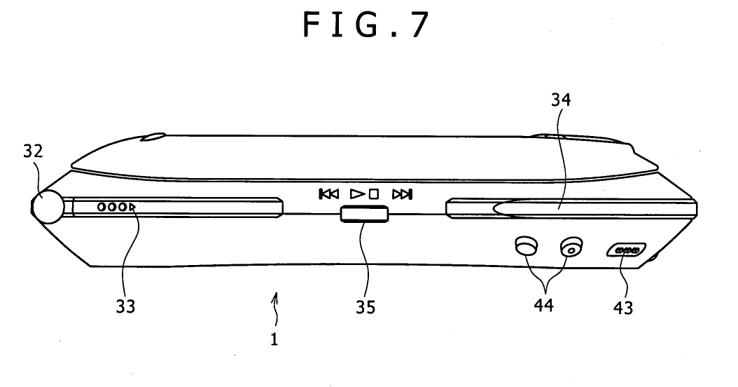

FIG. 7 is a diagram showing the bottom view of the external appearance of the information communication terminal 1. In this case, the bottom is defined as the side having the power-supply switch 33 and the music key 35.

As shown in FIG. 7, the bottom of the information communication terminal 1 also includes the power-supply-state notification light emitting unit 32, the communication-state notification light emitting unit 34, the hold switch 43 and the volume button 44 in addition to the power-supply switch 33 and the music key 35.

The information communication terminal 1 is configured to allow the cover 61 of the front face to be slid in the upward direction. As described earlier, the cover 61 has the display unit 21, the WLAN-mode switching button 22, the home button 23, the back button 24, the option button 25, the 4-direction keys 26, the enter button 27, the speaker 28 and the mike 29. The upward direction is an upward direction seen at a position in front of the display unit 21. With the cover 61 sled upward, a keyboard 71 is exposed to the user. FIG. 8 is a diagram showing the front view of the external appearance of the information communication terminal 1 with its front cover 61 slid upward.

The following description explains operation inputs related to the power supply and the WLAN as well as the states of the light emitting units explained above by referring to FIGS. 2 to 7.

First of all, with the power supply of the information communication terminal 1 put in an off state, the light emitting units including the power-supply-state notification light emitting unit 32 do not emit light either. Then, let us assume that the power-supply switch 33 is turned on in order to change the state of the power supply from the off state to an on state. In this case, the power-supply-state notification light emitting unit 32 emits light having a predetermined color indicating that the power supply has been put in the on state. In this state, the information communication terminal 1 is capable of accepting a normal operation input entered by the user.

With the power supply of the information communication terminal 1 put in an on state, that is, with the power-supply-state notification light emitting unit 32 put in a state of emitting light having a predetermined color indicating that the power supply has been put in the on state, the WLAN is still in an off state indicated by the WLAN-state notification light emitting unit 31 also being in an off state as well. In order to change the state of the WLAN from the off state to an on state, the user needs to operate the WLAN on/off switch 30. Typically, the WLAN on/off switch 30 is a slide-type switch to be slid in order to put the WLAN in an on or off state. In this case, the user can slide the WLAN on/off switch 30 in a predetermined direction in order to change the state of the WLAN from the off state to an on state. When the user slides the WLAN on/off switch 30 in the predetermined direction in order to change the state of the WLAN from the off state to the on state, the information communication terminal 1 is put in a state of being capable of carrying out a radio communication through the WLAN. In this state, the WLAN-state notification light emitting unit 31 is emitting light.

When the WLAN on/off switch 30 is operated in order to start a radio communication as described above, the information communication terminal 1 gets into a communication mode, which can be a WLAN infrastructure mode or a WLAN ad-hoc mode. Either the WLAN infrastructure mode or the WLAN ad-hoc mode is selected as the communication mode in accordance with setting. As an alternative, the information communication terminal 1 gets into the WLAN infrastructure mode or the WLAN ad-hoc mode, which was selected last as the communication mode.

The communication-state notification light emitting unit 34 is emitting light having a color determined on the basis of whether the present communication mode of the information communication terminal 1 is the WLAN infrastructure mode or the WLAN ad-hoc mode. In addition, the communication-state notification light emitting unit 34 emits light after the WLAN-state notification light emitting unit 31 emits light without regard to the state of the connection of the information communication terminal 1 to the WLAN. As an alternative, the communication-state notification light emitting unit 34 emits light only after such a connection has been established. On top of that, the communication-state notification light emitting unit 34 may emit light with an intensity determined by the strength of an electric wave received by the information communication terminal 1.

With the power supply of the information communication terminal 1 put in an on state, that is, with the power-supply-state notification light emitting unit 32 put in a state of emitting light having a predetermined color indicating that the power supply has been put in the on state and with the WLAN infrastructure mode selected as the communication mode, whereas the communication-state notification light emitting unit 34 put in a state of emitting light having a predetermined color indicating that the WLAN infrastructure mode has been selected as the communication mode, the user may want to change the communication mode from the WLAN infrastructure mode to the WLAN ad-hoc mode. In this case, the user needs to operate the WLAN-mode switching button 22. For example, the user presses the WLAN-mode switching button 22 downward in order to change the communication mode from the WLAN infrastructure mode to the WLAN ad-hoc mode. As a result, the communication mode is changed from the WLAN infrastructure mode to the WLAN ad-hoc mode indicated by the communication-state notification light emitting unit 34 emitting light with its color changed from the color indicating that the WLAN infrastructure mode has been selected as the communication mode to a predetermined color indicating that the WLAN ad-hoc mode has been selected as the communication mode.

With the WLAN ad-hoc mode selected as the communication mode of the information communication terminal 1, that is, with the WLAN-state notification light emitting unit 31 emitting light and the communication-state notification light emitting unit 34 emitting light having a predetermined color indicating the WLAN ad-hoc mode has been selected as the communication mode of the information communication terminal 1, let us assume that the user wants to switch the communication mode from the WLAN ad-hoc mode to the WLAN infrastructure mode. In this case the user needs to operate the WLAN-mode switching button 22. When the user operates the WLAN-mode switching button 22, the communication mode of the information communication terminal 1 is switched from the WLAN ad-hoc mode to the WLAN infrastructure mode as evidenced by the communication-state notification light emitting unit 34 emitting light with its color changed from the color indicating that the WLAN ad-hoc mode has been selected as the communication mode to a predetermined color indicating that the WLAN infrastructure mode has been selected as the communication mode.

With the power supply of the information communication terminal 1 put in an on state, that is, with the power-supply-state notification light emitting unit 32 put in a state of emitting light having a predetermined color indicating that the power supply has been put in the on state, let us assume that the user wants to turn of the WLAN off. In this case, the user needs to operate the WLAN on/off switch 30. Typically, the WLAN on/off switch 30 is a slide-type switch to be slid in order to put the WLAN in an on or off state. In this case, the user can slide the WLAN on/off switch 30 in a predetermined direction in order to change the state of the WLAN from the on state to an off state. When the user slides the WLAN on/off switch 30 in the predetermined direction in order to change the state of the WLAN from the on state to the off state, the information communication terminal 1 is put in a state of being no longer capable of carrying out a radio communication through the WLAN. In this state, the WLAN-state notification light emitting unit 31 is not emitting light anymore.

If the communication-state notification light emitting unit 34 emits light after the WLAN-state notification light emitting unit 31 emits light without regard to the state of the connection of the information communication terminal 1 to the WLAN, the communication-state notification light emitting unit 34 stops emitting light after the WLAN-state notification light emitting unit 31 ceases to emit light. If the communication-state notification light emitting unit 34 emits light after the connection of the information communication terminal 1 to the WLAN has been established, on the other hand, the communication-state notification light emitting unit 34 stops emitting light after the connection is cut off even if the WLAN is still an on state. The communication-state notification light emitting unit 34 also stops emitting light as the WLAN-state notification light emitting unit 31 ceases to emit light when the WLAN is turned off with the connection of the information communication terminal 1 to the WLAN established.

The power supply can be in one of two different off states. One of the two off state is referred to as a first power-supply off state or a user off state. The power supply is put in the first power-supply off state when the user turns off the power supply and no operation input is entered by the user within three days after the user turns off the power supply. In the first power-supply off state, however, power is supplied to a processor to be described later so that, when the user turns on the power supply with the power supply put in the first power-supply off state, the information communication terminal 1 can be activated immediately.

The other off state is referred to as a second power-supply off state or a deep off state. The power supply is put in the second power-supply off state when the user turns off the power supply and no operation input is entered by the user even after the lapse of three consecutive days since the user turns off the power supply. In the second power-supply off state, no power is supplied to the processor to be described later so that, when the user turns on the power supply with the power supply put in the second power-supply off state, it takes time of a predetermined length such as 30 seconds to put the information communication terminal 1 in a state of being ready for activation.

The information communication terminal 1 can be electrically charged by putting the information communication terminal 1 in a USB-connected state by making use of the USB connector 51 or by supplying DC power to the information communication terminal 1 by way of the DC jack 53. In general, the DC jack 53 is connected to an AC/DC converter for converting the 100V AC power generated by the home power supply into a DC power supplied to the information communication terminal 1. While the information communication terminal 1 is being electrically charged, the power-supply-state notification light emitting unit 32 is emitting light having a predetermined color indicating that the information communication terminal 1 is being electrically charged.

The following description explains the continuous display panel 101, which is basically displayed on the display unit 21 all the time.

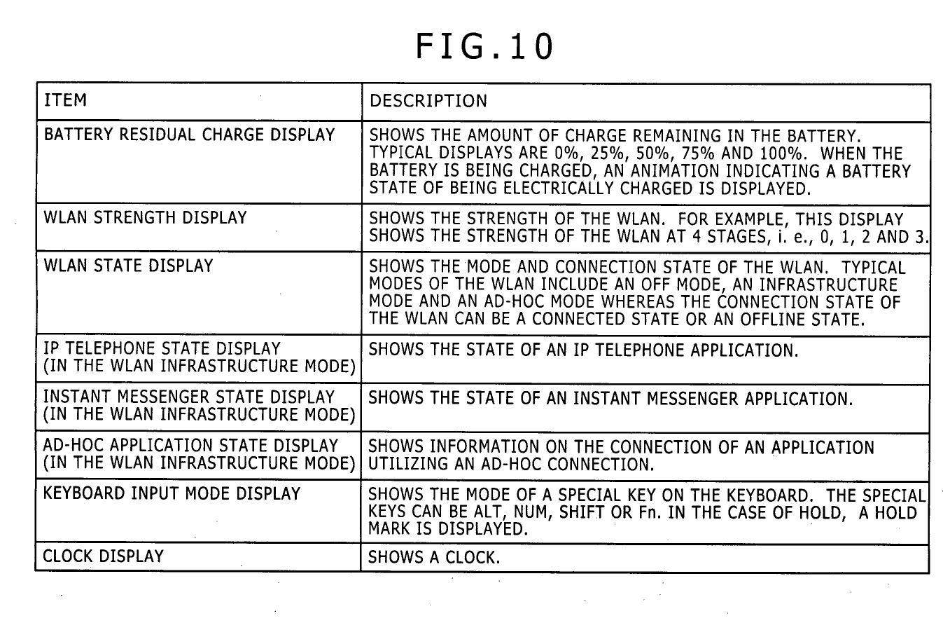

As shown in FIG. 9, the continuous display panel 101 appears typically in a predetermined area stretched along the bottom line of the display unit 21. Basically, the continuous display panel 101 appears all the time. The continuous display panel 101 shows various kinds of information such as ones described in FIG. 10 as information on the state of the information communication terminal 1.

For example, the continuous display panel 101 includes a battery residual charge amount display area 111, a WLAN wave-strength display area 112, a WLAN state display area 113, a communication utilization application state display area 114, a keyboard input mode display area 115 and a clock display area 116.

The battery residual charge amount display area 111 is an area for showing information on the amount of electrical charge left in a battery. Typical displays in the battery residual charge amount display area 111 are 0%, 25%, 50%, 75% and 100%. When the battery is being charged, an animation indicating a battery state of being electrically charged is displayed.

The WLAN wave-strength display area 112 is an area for showing information on the strength of the WLAN. To put it concretely, this display typically shows the strength of the WLAN at four stages, i.e., 0, 1, 2 and 3.

The WLAN state display area 113 is an area for showing information on the mode and connection state of the WLAN. To put it concretely, the WLAN state display area 113 typically displays a WLAN mode such as an off mode, the WLAN infrastructure mode and the WLAN ad-hoc mode as well as a WLAN connection state such as a connected state (or a state of being connected) or an offline state.

The communication utilization application state display area 114 is an area for showing information on the state of execution of an Application carrying out a communication in either the WLAN infrastructure mode or the WLAN ad-hoc mode. Specifically, for example, in the WLAN infrastructure mode, if an IP telephone application is executed in order to carrying out a communication, the state of execution of the IP telephone application is shown in the communication utilization application state display area 114. If an instant messenger application is executed in order to carry out a communication in the WLAN infrastructure mode, the communication utilization application state display area 114 shows the state of execution of the instant messenger application. If an application making use of ad-hoc connection is executed in the WLAN ad-hoc mode, on the other hand, the communication utilization application state display area 114 shows connection information of the WLAN ad-hoc mode. An example of the connection information of the WLAN ad-hoc mode is information on whether or not a one-to-one communication is going on.

The keyboard input mode display area 115 is an area for showing information on the input mode of a special key on the keyboard. The special keys include Alt, Num, Shift and Fn. In the case of Hold, a Hold mark is displayed in the keyboard input mode display area 115.

The clock display area 116 is an area for showing information generated by a clock.

Let us keep in mind that it is needless to say that the continuous display panel 101 may also display various kinds of information on the states of the information communication terminal 1 other than the pieces of information described above.

FIG. 11 is a block diagram showing the internal configuration of the information communication terminal 1.

The information communication terminal 1 includes an application processor 131 and an audio processor 132. The application processor 131 is a processor used mainly for executing an application program. On the other hand, the audio processor 132 is a processor for executing functions such as management of audio data, coding and decoding of audio data and management of copyrights. The application processor 131 and the audio processor 132 are connected to each other typically by making use of one serial interface or one parallel interface or a plurality of serial or parallel interfaces so that the application processor 131 and the audio processor 132 are capable of exchanging control signals and data with each other.

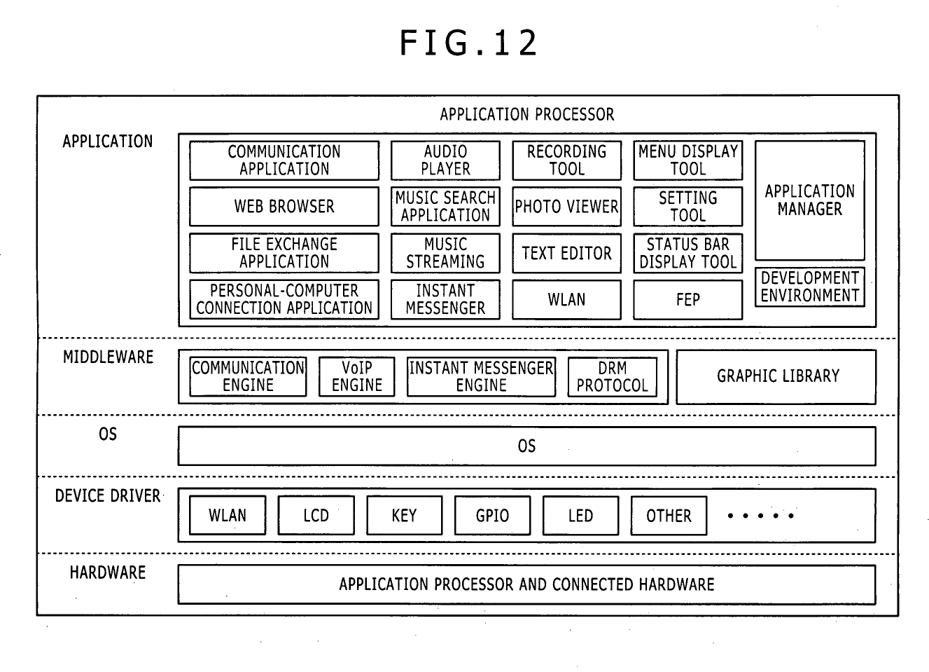

The application processor 131 carries out various kinds of processing on the basis of a clock signal generated by a clock generation unit 141. Details of functions carried out by the application processor 131 will be described later by referring to FIG. 12.

The application processor 131 is connected to a display module 142, a backlight driver 143, a light emitting module 144, an audio conversion module 145, a flash memory 146, a memory 147, a radio communication module 148, a keyboard module 149 and an input module 150. The input module 150 is also connected to the audio processor 132.

The display module 142 is configured to include the display unit 21. If an LCD unit is employed as the display unit 21, the display module 142 is configured to also include an LCD driver, an LCD backlight and, if necessary, components such as a light guide tube required in an operation to display information on the display unit 21. The display module 142 displays various kinds of information on the display unit 21 in accordance with control executed by the application processor 131.

The backlight driver 143 is a driver for the backlight of the display unit 21.

The light emitting module 144 includes the WLAN-state notification light emitting unit 31, the power-supply-state notification light emitting unit 32, the communication-state notification light emitting unit 34 and drivers for driving light emitting devices employed in the WLAN-state notification light emitting unit 31, the power-supply-state notification light emitting unit 32 and the communication-state notification light emitting unit 34. The light emitting module 144 puts the WLAN-state notification light emitting unit 31, the power-supply-state notification light emitting unit 32 and the communication-state notification light emitting unit 34 in an on, blinking or off state in accordance with control executed by the application processor 131. In the on and blinking states, the WLAN-state notification light emitting unit 31, the power-supply-state notification light emitting unit 32 and the communication-state notification light emitting unit 34 each emit light having a predetermined color.

The audio conversion module 145 includes embedded components such as a PLL circuit, an A/D converter, a D/A converter and a DSP core. The DSP core is capable of carrying out filter processing and equalizer processing. The filter processing includes processing of a high-pass filter and a notch filter. To be more specific, in accordance with control executed by the application processor 131, the audio conversion module 145 carries out an A/D conversion process on a sound input by the mike 29 or a mike connected to the connector jack 52, and carries out predetermined processing such as filtering on the result of the process. Then, the audio conversion module 145 supplies the result of the predetermined processing to the application processor 131. On the other hand, the audio conversion module 145 carries out a D/A conversion process on audio data received from the application processor 131 and outputs the result of the D/A conversion process to the speaker 28 as a reproduced sound, or outputs audio data obtained as a result of the D/A conversion process to typically a headphone connected to the connector jack 52 as a reproduced sound by way of the connector jack 52.

The flash memory 146 is a memory having a typical storage capacity of about 64 MB. The flash memory 146 is used for storing programs to be executed by the application processor 131 and information that remains stored in the flash memory 146 even after the power supply is put in an off state. The information stored in the flash memory 146 includes data and a variety of register variables. The data and the register variables are information required in the execution of the programs.

The memory 147 is typically an SDRAM (Synchronous Dynamic Random Access Memory) having a typical storage capacity of about 64 MB. The memory 147 is used for storing information required in processing carried out by the application processor 131.

The radio communication module 148 is a unit for implementing a WLAN function conforming to the 802.11b standard. In accordance with control executed by the application processor 131, the radio communication module 148 carries out a radio communication in order to exchange information with another apparatus directly or through an access point and a network.

The keyboard module 149 is configured to include the keyboard 71 for receiving an operation input entered by the user and supplying a signal representing the operation to the application processor 131.

The input module 150 is configured to include the WLAN-mode switching button 22, the home button 23, the back button 24, the option button 25, the 4-direction keys 26, the enter button 27, the WLAN on/off switch 30, the power-supply switch 33, the music key 35, the hold switch 43 and the volume button 44. The input module 150 is a module for receiving an operation input entered by the user and supplying a signal representing the operation to the application processor 131 or the audio processor 132.

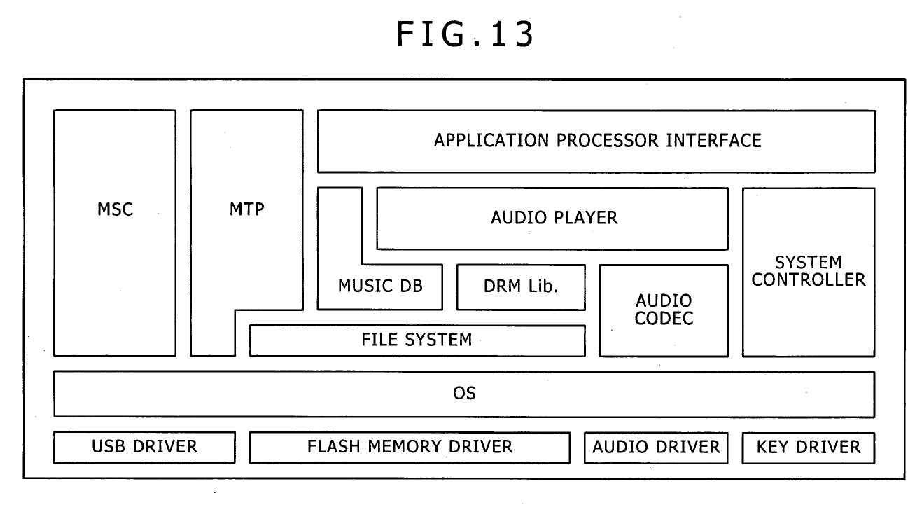

The audio processor 132 carries out various kinds of processing on the basis of a clock signal generated by a clock generation unit 151-1 or a clock generation unit 151-2. Since the audio processor 132 is a processor for handing mainly audio data, it is proper for the audio processor 132 to use two different clock signals. One of the clock signals is a basic clock signal used for processes such as processing to code and decode audio data. The other clock signal is a basic clock signal used for other signal processing. Functions carried out by the audio processor 132 will be described in detail by referring to FIG. 13.

The audio processor 132 is connected to the input module 150 described above, an audio-signal processing module 152, the USB connector 51, a real-time clock (RTC) 153, a large-capacity flash memory 154 and a memory bus 155. The memory bus 155 is connected to a flash memory 156 and a memory 157. The audio processor 132 also receives a signal indicating whether a device such as a headphone has been inserted into the connector jack 52 or pull out from the connector jack 52.

The audio-signal processing module 152 includes embedded components such as a D/A converter, a digital filter and an audio output amplifier for the headphone or the speaker. The audio-signal processing module 152 carries out a D/A conversion process on audio data received from the audio processor 132 or the audio conversion module 145, carries out a filtering process on the result of the D/A conversion process if necessary, amplifies the result of the filtering process and supplies the output of the amplifier to the ringer speaker 42 or the connector jack 52 as a reproduced signal. In addition, the audio-signal processing module 152 also receives a command from the audio processor 132 as a command to output not only an audio signal, but also the so-called beep sound or a calling sound of typically an arriving IP telephone call. The audio-signal processing module 152 outputs the beep sound or the calling sound of an arriving IP telephone call to the ringer speaker 42 or the connector jack 52.

The real-time clock (RTC) 153 is a clock for finding the present time by counting the number of pulses output by a pulse generator and supplying the present time to the audio-signal processing module 152.

The large-capacity flash memory 154 is a flash memory having a typical large storage capacity in the range 1 to several GB. The large-capacity flash memory 154 is used for storing information received from the audio processor 132. It is to be noted that the large-capacity flash memory 154 is also used for storing information generated by or acquired from a process carried out by the application processor 131 and supplied by the application processor 131 to the large-capacity flash memory 154 by way of the audio processor 132.

In addition, the large-capacity flash memory 154 is also used for storing information on other registered users. The information on another registered user is used in a process to exchange information with the other user by making use of an exchange tool such as an instant messenger, an IP phone, chatting or an email. The information exchanged with the other user typically includes a content such as musical data reproducible in a process carried out by the audio processor 132 and data generated as a result of executing a variety of application programs. On top of that, the large-capacity flash memory 154 is also used for storing information on registration of the user itself, who owns the information communication terminal 1, or information on registration of the information communication terminal 1. This registration information is transmitted to the apparatus owned by the other user serving as a partner of the information exchange process. The information on registration of the user itself, who owns the information communication terminal 1, or the information on registration of the information communication terminal 1 is stored in the large-capacity flash memory 154 in such a way that the user is capable of properly modifying the stored information.

The flash memory 156 is typically a memory having a typical storage capacity of about 64 MB. The flash memory 156 is used for storing a program to be executed by the audio processor 132 and information that remains stored in the flash memory 156 even after the power supply is put in an off state. The information stored in the flash memory 156 includes data and a variety of register variables. The data and the register variables are information required in the execution of the program.

The memory 157 is typically an SDRAM (Synchronous Dynamic Random Access Memory) having a typical storage capacity of about 64 MB. The memory 157 is used for storing information required in processing carried out by the audio processor 132.

The USB connector 51 is connected to an external apparatus by making use of a USB cable. An example of the external apparatus is the personal computer 13 explained before by referring to FIG. 1. If necessary, the USB connector 51 is also connected to a drive 171 on which a removable medium 172 is mounted. Examples of the removable medium 172 are a magnetic disk, an optical disk, a magneto-optical disk and a semiconductor memory. If necessary, a computer program read out from the removable medium 172 is installed in the flash memory 146 or the flash memory 156 in an executable state.

A signal received from an external apparatus such as the personal computer 13 through the USB connector 51 is supplied to the audio processor 132 and, if necessary, supplied to the application processor 131. On the other hand, the audio processor 132 outputs a predetermined signal to the external apparatus such as the personal computer 13 by way of the USB connector 51.

DC power supplied through the USB connection, DC power supplied through the DC jack 53 or DC power supplied from a battery 160 mounted on the information communication terminal 1 is distributed to components composing the information communication terminal 1 by a power-supply control unit 161.

FIG. 12 is a software-stack diagram showing the configuration of software executed by the application processor 131.

As shown in FIG. 12, the configuration of the software to be executed by the application processor 131 includes the following layers: a hardware layer at the bottom of the configuration, a device-driver layer above the hardware layer, an OS layer above the device-driver layer, a middleware layer above the OS layer and an application layer on the top of the configuration.

The device-driver layer is dedicated software for driving the application processor 131 and hardware connected to the application processor 131. To put it concretely, the device-driver layer includes a WLAN device driver WLAN for driving the radio communication module 148, an LCD driver for driving LCDs employed in the display module 142 for displaying an image on the display unit 21, a KEY keyboard driver for driving the keyboard module 149, a GPIO device driver for driving general-purpose ports of the application processor 131 and an LED driver for driving light emitting diodes employed in the WLAN-state notification light emitting unit 31, the power-supply-state notification light emitting unit 32 and the communication-state notification light emitting unit 34, which are included in the light emitting module 144.

In addition, the device-driver layer also properly includes other required device drivers such as a device driver for driving the backlight driver 143, a variety of memory drivers, a device driver for driving the audio conversion module 145, a mouse driver for driving a mouse if a mouse is employed in the information communication terminal 1 as an input device, a hard-disk driver for driving an embedded hard disk used for storing information if the hard disk is embedded in the information communication terminal 1 and a printer driver for driving an external printer connected to the information communication terminal 1 as an output device to which the information communication terminal 1 outputs information to be printed.

The OS layer is an OS (operating system) for controlling basic operations of the application processor 131. The OS is a basic program for managing a variety of resources driven by the device drivers. The OS manages the entire system by providing basic functions common to a number of application programs on the middleware and application layers to be described later as functions available to middleware and the application programs. For example, when any of the application programs executes an instruction, a device driver associated with the instruction is activated to carry out an operation requested by the instruction. Examples of the operation carried out by the device driver are an operation to input or output data from or to the flash memory 146, the memory 147 or the audio processor 132 and an operation to execute management of input/output functions such as a function to input data from the keyboard and a function to output an image to a screen. The OS can be Windows® 95™, Windows® 98™, Windows® NT™, LINUX or OS/2™. In addition, the OS also manages some software resources included typically in a context of execution of an application program on the application layer to be described later. The context of execution of an application program includes a set of registers, a main-memory image and a file handler.

Executed on the OS, the middleware on the middleware layer provides application programs with functions more sophisticated and more practical than the functions offered by the OS.

The middleware thus has an intermediate characteristic between the OS and application programs. If a function common to a number of application programs is developed individually for each of the application programs, the software development will become inefficient. In order to solve this problem, such a common function to be used by the application programs is developed as a function of the middleware. Thus, the middleware is a collection of such common functions, which are each generally a basic function in many cases.

To put it concretely, the middleware includes software elements such as a communication engine, a VoIP (Voice over IP) engine, an instant-messenger engine, a DRM (Digital Rights Management) protocol and a graphic library. The communication engine is software for providing basic functions of communication applications such as the IP phone. The VoIP engine is software for providing basic functions of a technology for exchanging audio data by making use of a TCP/IP network such as the Internet or an intranet. The instant-messenger engine is software for providing basic functions of an instant messenger. The DRM protocol is software for realizing a function for implementing processes such as a process to encrypt digital data in order to protect the copyright of the digital data. The graphic library is a collection of GUI components to be displayed on the display unit 21 to accompany execution of a variety of application programs.

To be more specific, the graphic library is a collection of general-purpose functions and general-purpose data, which are to be used in image processing carried out by a variety of application programs executed on the application layer. To put it more concretely, the graphic library is used for collecting some general-purpose functions to be used in the image processing in the same way as a book room is used for collecting books. That is to say, functions necessary for execution of application programs are made sharable by the programs as an independent file referred to as a graphic library. In general, the graphic library is loaded at an execution time separately from an application program and distinguished from subroutines of an application program.

On the application layer at the top of the software configuration, a variety of application programs are executed. In case of the information communication terminal 1, the application programs include application software, utilities, an application manager and a development environment. The application software includes individual applications such as a communication application, a web browser, a file exchange application, a personal-computer connection application, an audio player, a music search application, a music streaming application, an instant messenger, a recording tool, a photo viewer and a text editor. The utilities include a WLAN interface, a menu display tool, a setting tool, a status-bar display tool and an FEP (Front End Processor). The application manager is a program for managing the application software.

The communication application is an application program making use of the communication engine and the VoIP engine to allow the user to communicate with (a user utilizing) another apparatus through the so-called IP telephone function or a voice chatting function.

The web browser is an application used for viewing a web page through a network. To put it concretely, the web browser implements functions to download a file such as an HTML file, an image file or a musical file from a web server through the network and analyze the layout of the page in order to display/reproduce the file. The web browser also implements a function of allowing the user to transmit data to the web server by making use of a displayed form. In addition, the web browser also implements a function to execute application software written in a language such as Java™ Script, Flash or Java™.

The file exchange application is an application program having a file transfer function to exchange a data file with another apparatus connected to the information communication terminal 1 through a network or directly. The personal-computer connection application is an application program having a function to connect the information communication terminal 1 to the personal computer 13 in order to allow the information communication terminal 1 to exchange information with the personal computer 13.

The audio player is an application program having a function to reproduce musical data. The music search application is an application program having a function to store audio data in an internal database and allow the user to search the database for desired musical data. The music streaming application is an application program having a function to transmit multimedia data such as video and audio data to another apparatus through a network and reproduce multimedia data in a streaming reproduction process while receiving the data from another apparatus through the network.

The instant-messenger application is an application program having a function to produce a result of determination as to whether or not a peer connected to the network such as the Internet or a LAN as a peer making use of the same software is in an online state. The instant-messenger application also has a function to allow chatting with the peer or a transfer of a file to/from the peer if the result of the determination indicates that the peer is in an online state.

The recording tool is an application program having a function to record audio data input by the mike 29 in a way similar to the so-called voice memo and reproduce the recorded audio data. The photo viewer is an application program having a function to manage image data (or photo data) recorded internally in the information communication terminal 1 and control a process to reproduce and display the recorded image data by making use of a variety of display methods such as a method to display image data as a list of thumbnail images and a slideshow display method. The text editor is an application program having a function to create text data on the basis of operation inputs entered by the user via an input device such as the keyboard 71.

Individual application programs other than those mentioned and described above include table-calculation software, database creation software, an email application and a variety of game applications. These other application programs can also be properly installed in the information communication terminal 1 as well.

The WLAN interface is a utility for implementing a WLAN function conforming typically to the 802.11b standard. The menu display tool is a utility for controlling a display appearing on the display unit 21 as a display showing information such as a menu or a standby image. The setting tool is a utility for setting a variety of functions of the information communication terminal 1 on the basis of operation inputs entered by the user. The status-bar display tool is a utility for displaying various kinds of information on the continuous display panel 101 explained earlier by referring to FIGS. 9 and 10. The FEP is a utility serving as kanji conversion software used for handing inputs entered in the Japanese language.

FIG. 13 is a software-stack diagram showing the configuration of software executed by the audio processor 132.

The device-driver layer at the bottom of the configuration is dedicated software for driving the audio processor 132 and hardware connected to the audio processor 132. To put it concretely, the device-driver layer includes a USB driver, a flash-memory driver, an audio driver and a key driver. The USB driver is a device driver for implementing USB-connection and USB-streaming functions. The flash-memory driver is a device driver for driving the large-capacity flash memory 154 connected to the audio processor 132. The audio driver is a device driver for driving the audio-signal processing module 152. The key driver is a device driver for driving an input device employed in the input module 150. An example of the input device is a music key 35 for inputting an operation input concerning a process to be carried out by the audio processor 132.

The device-driver layer may also properly include other required device drivers such as a memory driver for driving a memory other than the large-capacity flash memory 154 and a GPIO device driver for driving a general-purpose port of the application processor 131.

The OS is a basic program for controlling basic operations carried out by the audio processor 132. As the OS of the audio processor 132, it is desirable to employ a real-time OS designed for an embedded system. An example of the real-time OS designed for an embedded system is uITRON.

A variety of application programs are executed on the OS.

In implementing USB connection, the information communication terminal 1 is capable of switching a USB mode from an MSC (Mass Storage Class) mode, which is one of two USB modes, to an MTP (Media Transfer Protocol) mode serving as the other USB mode and vice versa.

The MSC (Mass Storage Class) mode is a USB mode providing the host apparatus with a function to recognize and control a connected USB apparatus as a storage apparatus. In this case, the USB apparatus is the information communication terminal 1 connected to the personal computer 13. That is to say, having a MSC (Mass Storage Class) interface, the information communication terminal 1 is recognized as a driver by an OS running on the personal computer 13. Thus, an application executed in the personal computer 13 is capable of reading out data stored internally in the information communication terminal 1. The data stored internally in the information communication terminal 1 includes image data and musical data. The application executed in the personal computer 13 to read out data stored internally in the information communication terminal 1 is not limited to a special application, but may also be an explorer or the like.

The MTP (Media Transfer Protocol) mode is a USB mode providing a protocol for connecting the information communication terminal 1 and the personal computer 13 to each other and exchanging musical data, moving-picture data and still-picture data between the information communication terminal 1 and the personal computer 13. MTP software for the MTP mode is executed on a layer of communication with any storage device including the USB MSC (Mass Storage Class) storage apparatus, allowing a content having a copyright protection flag to be transferred with a high degree of safety.

A file system is software for managing files stored in a memory (such as the large-capacity flash memory 154) connected to the audio processor 132. Some of the files managed by the file system are stored in a database. To be more specific, musical-data files managed by the file system are stored in a musical DB (database). The copyrights of the musical-data files are protected in a DRM (Data Rights Management) library.

The DRM library is a collection of general-purpose functions and general-purpose data, which are used by a variety of application programs to encrypt digital data such as musical data, moving-picture data and still-picture data in order to implement a function of avoiding illegal data copies and illegal transfers of data to other apparatus.

Musical data stored in a memory (such as the large-capacity flash memory 154) connected to the audio processor 132 is data compressed by an audio coding/decoding unit in a compression format such as an MP3 (MPEG Audio layer-3) format, an ATRAC3 (Adaptive TRansform Acoustic Coding-3) format, a WMA (Windows® Media Audio) format or an ASF (Advanced Streaming Format). Thus, the audio coding/decoding unit is also capable of decompressing the compressed musical data by adoption of a decompression method for the compression format.

An audio player is software for controlling a process to decompress compressed audio data in the audio coding/decoding unit by adoption of a predetermined decompression method and output the audio data as reproduced data. The compressed audio data to be decompressed is supplied to the audio processor 132 by way of an application processor interface. The compressed audio data is audio data subjected to copyright protection based on the DRM library and managed by making use of the musical DB in accordance with control signals output by various kinds of software executed by the application processor 131.

A system controller is software for controlling a variety of functions implemented by the audio processor 132.

An application processor interface is software for providing a function to control exchanges of various kinds of information and control signals between the application processor 131 and the audio processor 132.

By referring to display screens appearing on the display unit 21, the following description explains typical and concrete executions of a variety of application programs in the information communication terminal 1.

A variety of application programs executed by the information communication terminal 1 can be classified into a category not making use of processing of communications with another apparatus and a category making use of processing of communications with another apparatus through a network. The category not making use of processing of communications with another apparatus includes the audio player, the recording tool (or the so-called voice memo tool), the photo viewer and the text editor. As described earlier, the audio player is an application program for reproducing audio data. On the other hand, the category making use of processing of communications with another apparatus includes the file exchange application, the music streaming application, the communication application, the instant messenger and the web browser. As described before, the file exchange application is an application program having a file transfer function to exchange a data file with another apparatus connected to the information communication terminal 1 through a network or directly. Also as explained earlier, the music streaming application is an application program having a function to transmit multimedia data such as video and audio data to another apparatus through a network and reproduce multimedia data while receiving the data from another apparatus through the network in a streaming reproduction process. Also as described earlier, the communication application is an application program making use of the communication engine and the VoIP engine in order to allow the user to communicate with (a user utilizing) another apparatus through the so-called IP telephone function or a voice chatting function through a network. Also as explained before, the instant-messenger application is an application program having a function to allow chatting or a transfer of a file through a network. Also as explained earlier, the web browser is an application program used for viewing a web page through a network.

There are also application programs each having a plurality of functions. There are also application programs each having a plurality of functions making use of and not making use of processing of communications with another apparatus through a network. The functions not making use of processing of communications with another apparatus include a function to record audio data (such as mainly musical data), a still picture and a moving picture and a function to organize stored data into a database. On the other hand, the functions making use of processing of communications with another apparatus through a network include a function to exchange data with another apparatus and a function to reproduce data while receiving the data from another apparatus in a streaming reproduction process.

FIG. 14 is a diagram showing a typical display of a home screen 451, which immediately appears on the display unit 21 employed in the information communication terminal 1 typically when the power supply is turned on or when the home button 23 is pressed. The home screen 451 shows a menu as a list of application programs that can be executed in the information communication terminal 1. As an alternative, the displayed menu can also be a list of items each including a plurality of such application programs. In the case of the home screen 451 shown in FIG. 14, the displayed menu shows a standby screen 461, a communication application 462, a music tool 463, a web browser 464, a photo viewer 465, a text editor 466, a voice memo tool 467 and a variety of tools 468 in a state of being selectable. If application programs executable in the information communication terminal 1 cannot all be displayed on one page of the home screen 451, the user may operate an up or down key of the 4-direction keys 26 in order to scroll the displayed list of the menu in the upward or downward direction respectively. In this way, the user is capable of viewing all the application programs included on the list. The user is allowed to select an application program from the displayed menu of the home screen 451 appearing on the display unit 21 and activate the selected program.

It is to be noted that, in accordance with a typical method adopted by the user to select and determine an application program from the menu, for example, the user operates the down or up key of the 4-direction keys 26 to change the selected item in the menu. The selected item in the menu is an item pointed to by a cursor. The menu is scrolled in the upward direction when the user presses the up key of the 4-direction keys 26 with the menu top item pointed by the cursor and scrolled in the downward direction when the user presses the down key of the 4-direction keys 26 with the menu bottom item pointed by the cursor. Then, after placing the cursor at a position to point to a desired item in the menu by operating the down or up key, the user presses the enter button 27 in order to confirm the selection of the desired menu item pointed to by the cursor as a selected application program. When the user confirms the selection of the desired menu item pointed to by the cursor as the selected application program by pressing the enter button 27, the program is activated. In accordance with another typical method adopted by the user to select an application program and confirm the selection of the application program from the menu, for example, with the third item in the menu assumed to be an always selected menu item, the user operates the down or up key of the 4-direction keys 26 in order to scroll the entire menu in the downward or upward direction respectively. In this way, different programs occupy the position of the third item serving as the always selected menu item. The user continues scrolling the menu till the desired application program occupies the position of the third item serving as the always selected menu item. As the desired application program occupies the position of the third item serving as the always selected menu item, the user presses the enter button 27 in order to confirm the selection of the third menu item as a selected application program. When the user confirms the selection of the third menu item as the selected application program by pressing the enter button 27, the program is activated.

First of all, by referring to FIGS. 14 to 18, the following description explains typical processing when the voice memo tool 467 is selected from the menu shown on the home screen 451 and the recording and reproduction tool (or the so-called voice memo) represented by the voice memo tool 467 is executed. As described above, the home screen 451 of FIG. 14 shows a menu as a list of application programs that can be executed in the information communication terminal 1 or, as an alternative, the displayed menu can also be a list of items each including a plurality of such application programs.

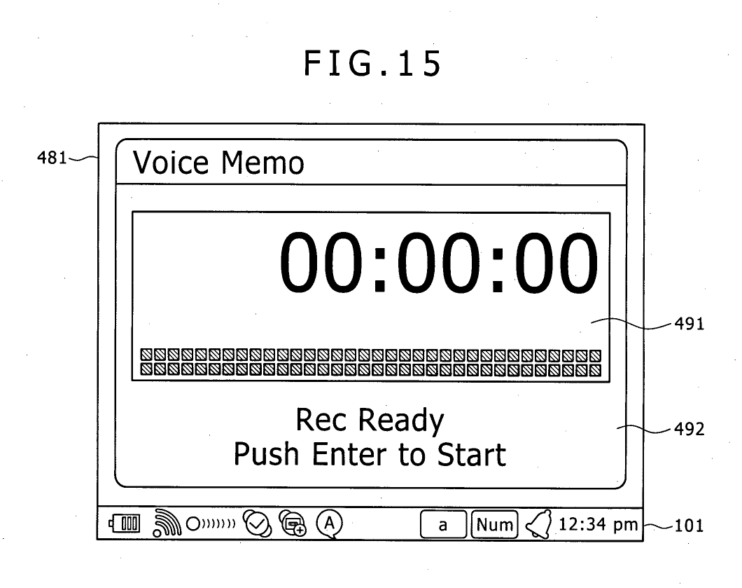

FIG. 15 is a diagram showing a typical display of a screen 481 appearing initially in a recording wait state when the recording and reproduction tool is activated.

The display screen 481 of the recording and reproduction tool includes a recording-duration display area 491 for showing a recording length and a message display area 492 for showing a message to the user. The recording-duration display area 491 not only shows a recording or a reproduction length but may also show other information such as the volume of recorded or reproduced audio data and the present reproduction position (or the reproduction-stop position) of recorded audio data in a reproduction process.

As shown in FIG. 15, in the recording wait state, the recording length shown in the recording-duration display area 491 is 0 and the message display area 492 shows a message saying: “Rec Ready. Push Enter to Start.”

When the user presses the enter button 27, that is, when a signal representing an operation input entered by the user is received from the input module 150, the application processor 131 drives the mike 29 or a mike connected to the connector jack 52 to input voices, receives audio data completing an A/D conversion process in the audio conversion module 145 and supplies the data to the audio processor 132. The audio processor 132 encodes the data and stores the encoded data in the large-capacity flash memory 154.

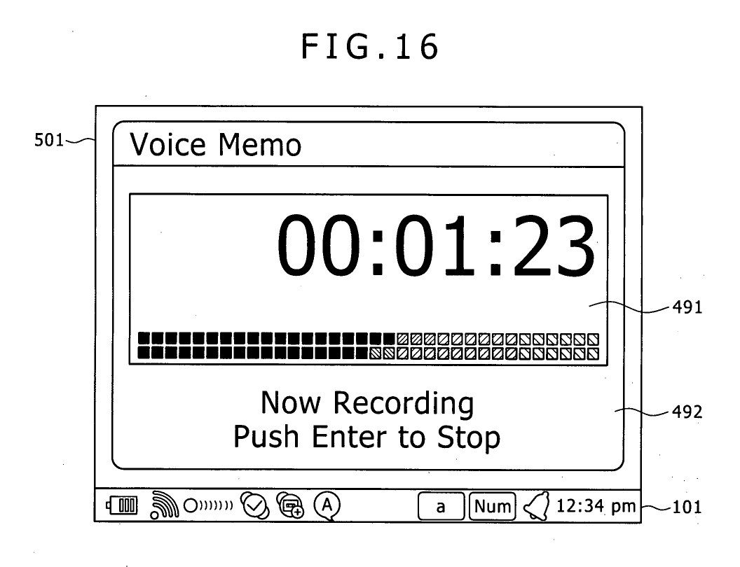

FIG. 16 is a diagram showing a typical display of a screen 501 in a recording state.

As shown in FIG. 16, in a recording state, the recording-duration display area 491 shows an increasing recording length whereas the message display area 492 shows a message saying: “Now Recording. Push Enter to Stop.”

When the user presses the enter button 27, that is, when a signal representing an operation input entered by the user is received from the input module 150, the application processor 131 stops the process to input voices by making use of the mike 29 or the mike connected to the connector jack 52.

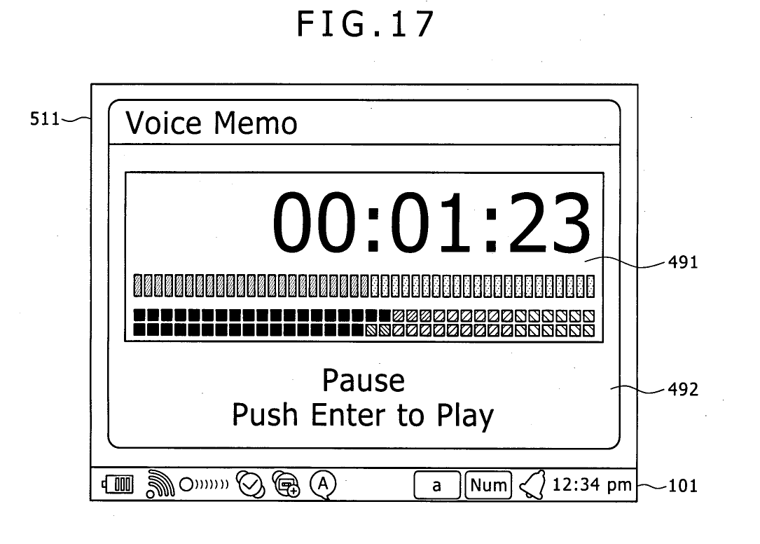

FIG. 17 is a diagram showing a typical display of a screen 511 in a stopped-recording state, that is, a state of waiting for reproduction of recorded audio data (or, a reproduction pause state).

As shown in FIG. 17, in a reproduction pause state, the recording-duration display area 491 shows a fixed recording length and information on the progress of reproduction of the recorded sound data whereas the message display area 492 shows a message saying: “Pause. Push Enter to Play.”

When the user presses the enter button 27, that is, when a signal representing an operation input entered by the user is received from the input module 150, the application processor 131 drives the audio processor 132 to read out recorded audio data from the large-capacity flash memory 154 and supply the data to the audio conversion module 145 after decoding the data. The audio conversion module 145 carries out a D/A conversion process on the audio data received from the audio processor 132 and outputs the data resulting from the D/A conversion process to the speaker 28 as reproduced data or outputs audio data obtained as a result of the D/A conversion process to typically a headphone connected to the connector jack 52 as a reproduced sound by way of the audio-signal processing module 152.

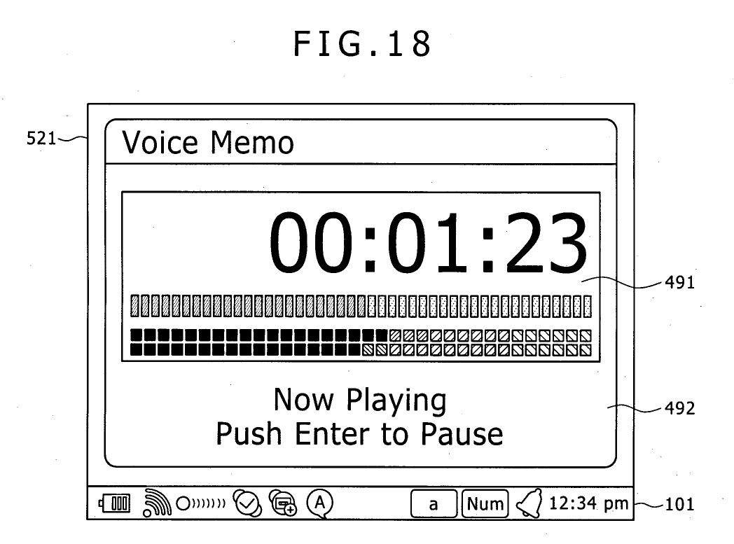

FIG. 18 is a diagram showing a typical display of a screen 521 in a state of reproducing recorded audio data.

As shown in FIG. 18, in a reproduction state, the recording-duration display area 491 shows a reproduction length and information on the progress of reproduction of the recorded sound data whereas the message display area 492 shows a message saying: “Now Playing. Push Enter to Pause,” meaning that the information communication terminal 1 is in a reproduction state, which can be stopped by pressing the enter button 27. When the user presses the enter button 27 in the state shown in FIG. 18, the reproduction process is temporarily stopped to enter the reproduction pause state explained earlier by referring to FIG. 17.

The following description explains typical processing carried out by execution of the photo viewer 465 selected by confirmation from items included in a menu displayed on the home screen 451 explained earlier by referring to FIG. 14. As described before, the displayed menu is a list of application programs that can be executed in the information communication terminal 1 or, as an alternative, the displayed menu can also be a list of items each including a plurality of such application programs.

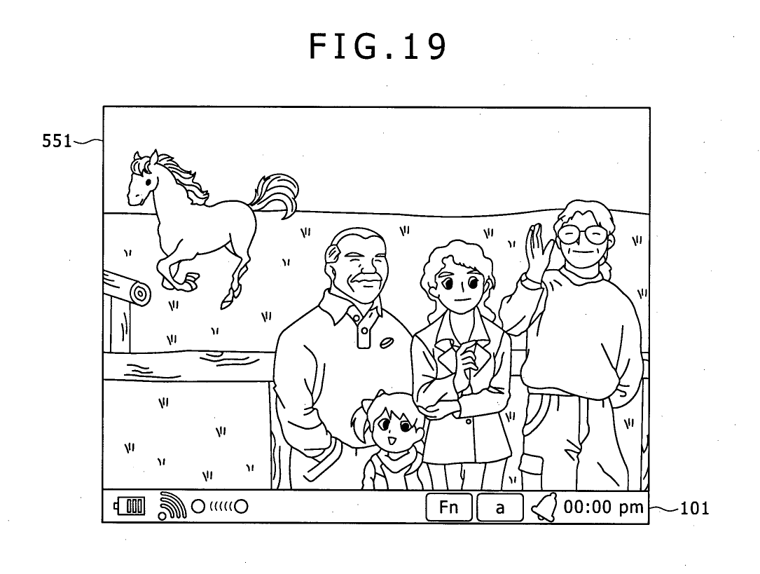

FIG. 19 is a diagram showing a typical display screen 551 in execution of the photo viewer 465. The photo viewer 465 is an application program for carrying out a process to read out the data of still pictures from the large-capacity flash memory 154 and display the data on the display unit 21 in accordance with an operation input entered by the user. Typically, the photo viewer 465 converts each of the still pictures into a thumbnail image and displays the data as a list of thumbnail images on the display unit 21. As an alternative, the photo viewer 465 displays the thumbnail images on the display unit 21 in units according to classification done by the user. As another alternative, the photo viewer 465 displays the thumbnail images on the display unit 21 in a slide-show format.

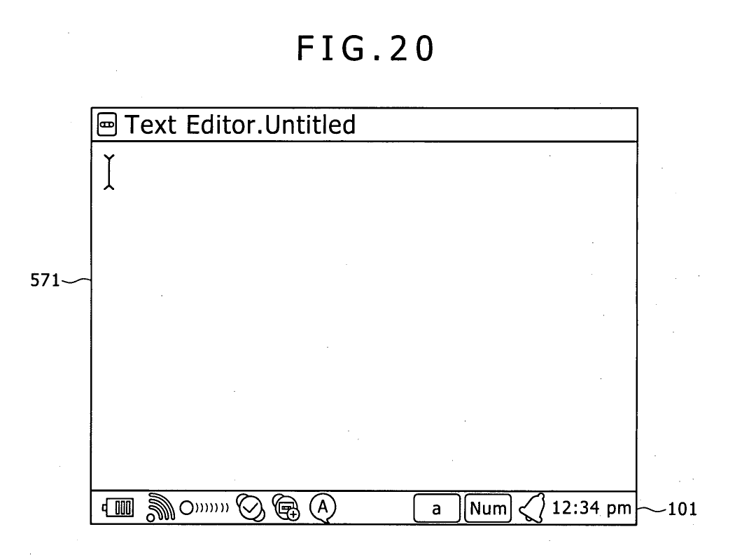

By referring to FIGS. 20 to 22, the following description explains typical processing carried out by execution of the text editor 466 selected by confirmation from items included in a menu displayed on the home screen 451 explained earlier by referring to FIG. 14. As described before, the displayed menu is a list of application programs that can be executed in the information communication terminal 1 or, as an alternative, the displayed menu can also be a list of items each including a plurality of such application programs.

FIG. 20 is a diagram showing a typical screen 571 for creation of a new text by making use of the text editor 466. On the top of the new-text creation screen 571, the name of a text file to be used for storing the new text is shown. If the user has not yet entered the name of a text file to be used for storing the new text, the name ‘untitled’ is used. In addition, the new-text creation screen 571 also shows a cursor pointing to the present edit position in a text input area.

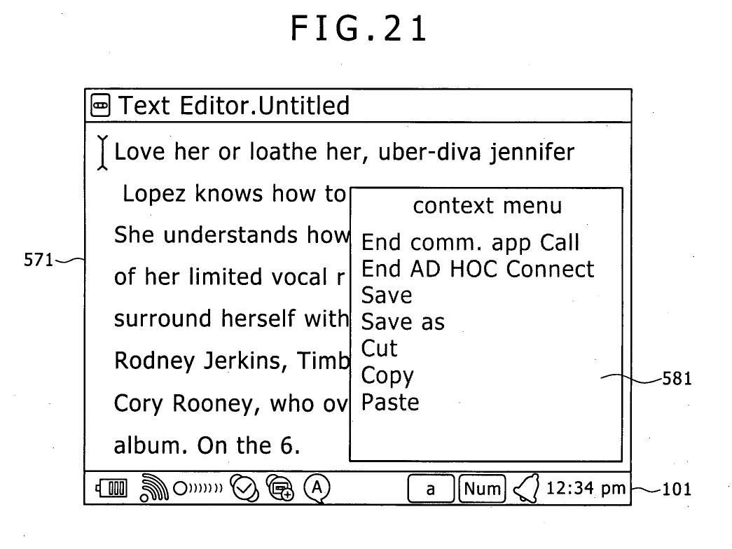

While a text is being entered, it is possible to display a context menu 581 like one shown in FIG. 21 in accordance with an operation input entered by the user. The context menu 581 typically shows commands including ‘End Comm. App. Call’, ‘End AD HOC Connect’, ‘Save’, ‘Save As’, ‘Cut’, ‘Copy’ and ‘Paste’. ‘End Comm. App. Call’ is the name of a command to terminate the text editor 466 and activate the communication application. ‘End AD HOC Connect’ is the name of a command to terminate the text editor 466 and start an ad-hoc connection mode. ‘Save’ is the name of a command to keep a created text. ‘Save As’ is the name of a command to keep a created text in a file by giving a name to the file. ‘Cut’ is the name of a command to cut out a portion of a text from the text. The portion to be cut out from the text is a character string in a specified range. ‘Copy’ is the name of a command to copy a portion of a text. The portion to be copied is a character string in a specified range. ‘Paste’ is the name of a command to paste a portion at a position in a text. The portion to be pasted to the text is a character string cut out from a text by making use of the ‘Cut’ command or a character string copied by making use of the ‘Copy’ command.

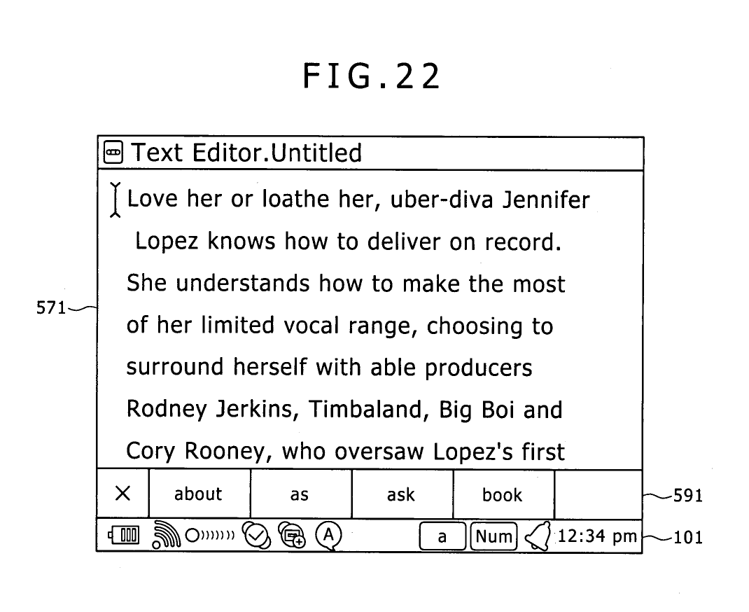

In addition, the text editor 466 also has a character predictive conversion function. The character predictive conversion function works as follows. When the user moves the cursor to a place at which a string of characters is to be entered and enters the first character of the string, the character predictive conversion function automatically displays a plurality of predicted candidates for the character string to be entered at the position of the entered first character as a string starting with the entered first character. The character predictive conversion function automatically displays the predicted candidates in a character-string predictive conversion bar 591 at the bottom of the new-text creation screen 571 as shown in FIG. 22.

If the predicted candidates shown in a character-string predictive conversion bar 591 include the character string to be entered by the user at the position of the entered first character, the user can carry out an operation to select the string of characters from the character-string predictive conversion bar 591 in order to enter the selected string of characters to the position. In this way, the user is capable of entering a desired string of characters to the position of the entered first character by carrying out only few text-character input operations. The user is capable of deleting the character-string predictive conversion bar 591 from the new-text creation screen 571 by carrying out an input operation of deciding to select an x box at the left end of the new-text creation screen 571.

The keyboard 71 shown in FIG. 8 as a keyboard employed in the information communication terminal 1 may have the so-called +character keys in addition to the 4-direction keys 26 provided on the cover 61. By providing the +character keys, the user may enjoy more convenience of selecting the +character keys or the 4-direction keys 26 as follows.

For example, the user may operate a key of the 4-direction keys 26 or a left-direction or right-direction key of the +character keys on the keyboard 71 in order to enter a command to move the cursor over the new-text creation screen 571 of the text editor 466 in a direction indicated by the operated key. On the other hand, the user may operate an upward-direction or downward-direction key of the +character keys on the keyboard 71 in order to enter a command to select a string of characters among a plurality of candidates shown in the character-string predictive conversion bar 591.

The software described above as the application programs implementing the photo viewer 465, the text editor 466 and the voice memo tool 467 is executed to carry out no processing of communication with an external apparatus. However, let us take functions each handling a musical content as an example. In this case, such a function may be executed to carry out processing of communication with an external apparatus or processing of no communication with an external apparatus. All the functions each handling a musical content are typically collected in a menu. This is because it is desirable to let the user utilize any of the functions each handling a musical content as an application program by selecting the program from the menu without the need to be aware of whether or not the selected program entails a communication with an external apparatus or without the need to distinguish the functions entailing a communication with an external apparatus and functions entailing no communication with an external apparatus from each other.

The method of communication with another apparatus can be implemented by wire connection making use of a USB cable or by radio connection making use of the WLAN. In the case of radio connection making use of the WLAN, the WLAN ad-hoc mode or the WLAN infrastructure mode can be adopted as described before.

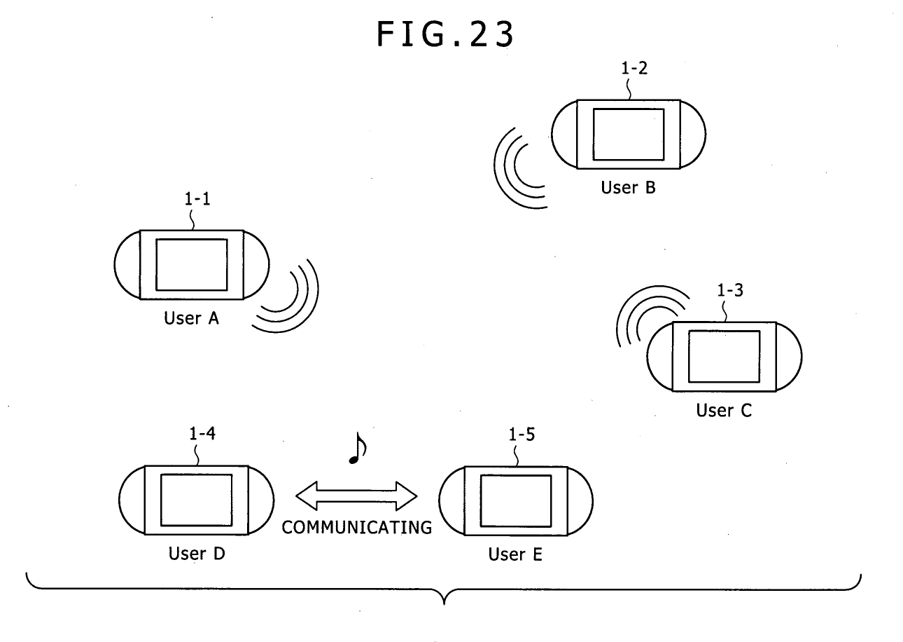

The WLAN communication adopting the WLAN ad-hoc mode is explained by referring to FIGS. 23 to 26 as follows.

Let us assume for example that information communication terminals 1-1 to 1-5 operated by users A to E respectively exist in a range of implementable communications as shown in FIG. 23. Also let us assume that the information communication terminal 1-4 operated by user D is communicating in the WLAN ad-hoc mode with the information communication terminal 1-5 operated by user E.

In this case, each of the information communication terminals existing in the range of implementable communications as a terminal for the WLAN ad-hoc mode is not set to allow the information communication terminals to freely transfer files among each other and freely reproduce a transferred musical content in a streaming reproduction process. Instead, each of the WLAN ad-hoc mode information communication terminals existing in the range of implementable communications is set to allow only mutually registered information communication terminals to freely transfer files among each other and freely reproduce a transferred musical content in a streaming reproduction process. Two information communication terminals serving as mutual communication partners are said to be mutually registered information communication terminals if any specific one of the terminals is a terminal registered in the other terminal and the other terminal is a terminal registered in the specific terminal.

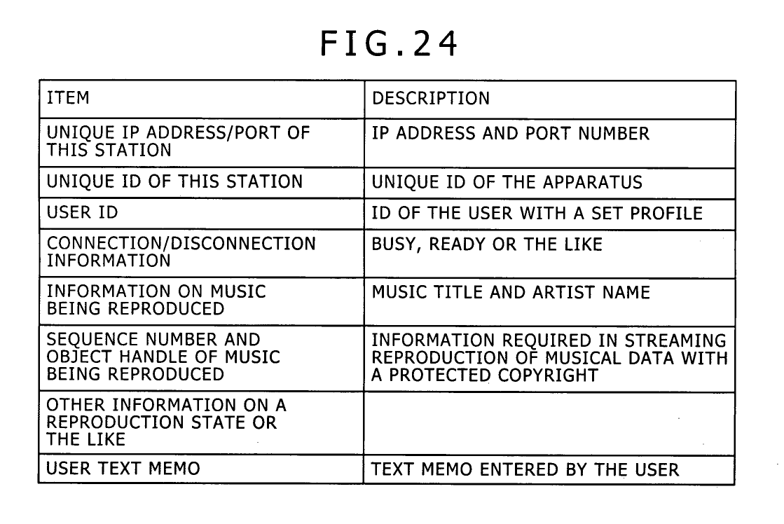

In the WLAN ad-hoc mode, each of the information communication terminals 1-1 to 1-5 operated by users A to E respectively as shown in FIG. 23 transmits its unique information and information on its present condition to all apparatus in the range of implementable communications by adoption of a broadcasting transmission technique, which does not specify any specific destination of the transmission. The unique information of a information communication terminal 1 is information that basically remains unchanged. On the other hand, the information on the present condition of a information communication terminal 1 is information that varies from time to time. FIG. 24 is a diagram explaining pieces of typical information transmitted by an information communication terminal 1 in an ad-hoc mode by adoption of the broadcasting transmission technique.

As shown in the figure, the typical information transmitted by an information communication terminal 1 in an ad-hoc mode by adoption of the broadcasting transmission technique includes a unique IP address and unique port number of this terminal, a unique apparatus ID of this terminal, a user ID with a set profile, connection/disconnection information typically indicating a busy or ready state or the like, information on music being reproduced (or now playing) including such as the music title and the artist name, information required in a streaming reproduction process for a musical content being reproduced as a content with a protected copyright, other information such as information on a reproduction state or the like and a text memo entered by the user. The sequence number and object handle of music being reproduced are typical information required in a streaming repro implementable duction process for a musical content being reproduced as a content with a protected copyright.

The unique IP address and unique port number of this terminal, the unique apparatus ID of this terminal and the user ID with a set profile, which are included in the information communication terminal 1 in an ad-hoc mode, are information that basically remains unchanged. On the other hand, the information on music being reproduced (or now playing), the information required in a streaming reproduction process for a musical content being reproduced as a content with a protected copyright and other information such as information on a reproduction state or the like are information varying from time to time. The text memo entered by the user is basically unchanged but the user may enter a text memo with contents varying from time to time.

In addition, each of the information communication terminals 1 setting the WLAN ad-hoc mode may transmit information other than that explained above by referring to FIG. 24 to all apparatus in the range of implementable communications by adoption of the broadcasting transmission technique as long as the other information is information that can be disclosed to any user not registered as a communication partner in the WLAN ad-hoc mode set typically for exchanging information. For example, each of the information communication terminals 1 setting the WLAN ad-hoc mode may transmit image data of an icon (or the thumbnail) of the sender itself along with the information explained above by referring to FIG. 24 to any other information communication terminal 1 setting the WLAN ad-hoc mode. The icon will be displayed on a standby screen of the other information communication terminal 1 operated by an ad-hoc communication partner, who is a user not mutually registered yet. The icon is an icon letting the user, who is not a mutually registered user, display a screen of the owner of the icon. The standby screen will be described later in detail.

On the other hand, each of the information communication terminals 1-1 to 1-5 operated by users A to E respectively as shown in FIG. 23 receives the information explained above by referring to FIG. 24 from each of the information communication terminals 1-1 to 1-5, and produces a result of determination as to whether the information communication terminals 1-1 to 1-5 each serving as a sender is owned by a user registered as an ad-hoc communication partner in order to recognize the states of communication with the information communication terminals 1-1 to 1-5 each owned by a user registered as an ad-hoc communication partner and recognize information on each user owning another information communication terminal 1 existing in the range of implementable communications as an unregistered information communication terminal 1.

Then, in the WLAN ad-hoc mode, the information communication terminal 1 displays an ad-hoc user list display screen on the display unit 21. The ad-hoc user list display screen is a screen showing a list of pieces of information on users each registered as an ad-hoc communication partner owning the information communication terminal 1 and users each owning another information communication terminal 1 existing in the range of implementable communications as an unregistered information communication terminal 1.

To put it concretely, the ad-hoc user list display screen shows the states of communication with the information communication terminals 1 each owned by a user registered as an ad-hoc communication partner and any other information communication terminal 1 existing in the range of implementable communications as an unregistered information communication terminal 1. The state of communication with another information communication terminal 1 owned by a user registered as an ad-hoc communication partner can be an online state, an offline state or a busy state. The online state of another information communication terminal 1 is a state in which a communication with the other information communication terminal 1 can be carried out. The offline state of another information communication terminal 1 is a state in which a communication with the other information communication terminal 1 cannot be carried out due to the fact that the other information communication terminal 1 does not exist in the range of implementable communications. The busy state of another information communication terminal 1 is a state in which a communication with the other information communication terminal 1 cannot be carried out due to the fact that the other information communication terminal 1 is communicating with another apparatus. As for the state of communication with any other information communication terminal 1 existing in the range of implementable communications as an unregistered information communication terminal 1, an unknown state is displayed.

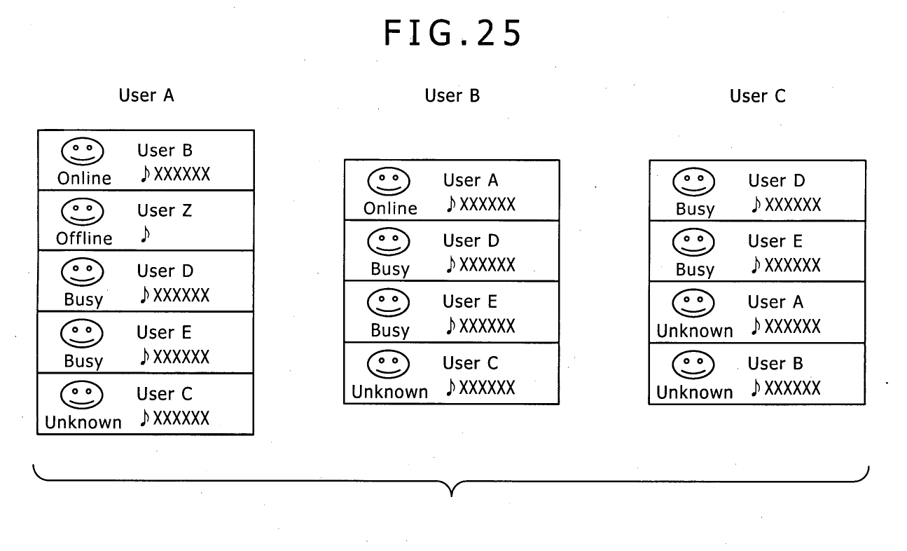

Let us assume for example that users B, Z, D and E are each a user registered in the information communication terminal 1 owned by user A as a communication partner of user A. In this case, the ad-hoc user list display screen of user A displays a list shown on the left side of FIG. 25 as a list of users. The list of users shows user B in an online state, user Z in an offline state, user D in a busy state, user E in a busy state and user C in an unknown state. That is to say, a communication with user B can be carried out, a communication with user Z cannot be carried out due to the fact that the information communication terminal 1 owned by user Z does not exist in the range of implementable communications, a communication with either of users D and E cannot be carried out due to the fact users D and E are each communicating with another apparatus whereas the information communication terminal 1 owned by user C exists in the range of implementable communications as an unregistered information communication terminal 1.

By the same token, let us assume for example that users A, D and E are each a user registered in the information communication terminal 1 owned by user B as a communication partner of user B. In this case, the ad-hoc user list display screen of user B displays a list shown in the middle of FIG. 25 as a list of users. The list of users shows user A in an online state, user D in a busy state, user E in a busy state and user C in an unknown state. That is to say, a communication with user A can be carried out, a communication with either of users D and E cannot be carried out due to the fact users D and E are each communicating with another apparatus whereas the information communication terminal 1 owned by user C exists in the range of implementable communications as an unregistered information communication terminal 1.

In the same way, let us assume for example that users D and E are each a user registered in the information communication terminal 1 owned by user C as a communication partner of user C. In this case, the ad-hoc user list display screen of user C displays a list shown on the right side of FIG. 25 as a list of users. The list of users shows user D in a busy state, user E in a busy state, user A in an unknown state and user C in an unknown state. That is to say, a communication with either of users D and E cannot be carried out due to the fact that users D and E are each communicating with another apparatus whereas the information communication terminals 1 owned by users A and C each exist in the range of implementable communications as an unregistered information communication terminal 1.

In addition, the ad-hoc user list display screen may also display the name of a user identifiable from at least a user ID included in various kinds of information broadcasted by another information communication terminal 1, the state of communication with the information communication terminal 1 owned by the user and, if necessary, other information. As described above, the state of communication with the information communication terminal 1 owned by the identified user can be an online, offline, busy or unknown state. In the examples shown in FIG. 25, the ad-hoc user list display screen displays the name of each user, the state of communication with the information communication terminal 1 owned by the user and information on a now playing musical content, that is, a musical content being reproduced. In addition, the ad-hoc user list display screen may also display information such as a text memo entered by the user if necessary.

Various kinds of information broadcasted by another information communication terminal 1 include information that cannot be displayed on the ad-hoc user list display screen. The information that cannot be displayed on the ad-hoc user list display screen may be recognized as a user information property.

In the examples shown in FIG. 25, let us assume that a decision is made by user A to confirm selection of the information communication terminal 1 owned by user C but not registered in the information communication terminal 1 owned by user A, a decision is made by user B to confirm selection of the information communication terminal 1 owned by user C but not registered in the information communication terminal 1 owned by user B or a decision is made by user C to confirm selection of the information communication terminal 1 owned by either of user A or B but not registered in the information communication terminal 1 owned by user C. In this case, a dialog box is displayed to show a message for verifying execution of a mutual registration process to register the selected user in the information communication terminal 1 owned by the selecting user and register the selecting user in the information communication terminal 1 owned by the selected user.

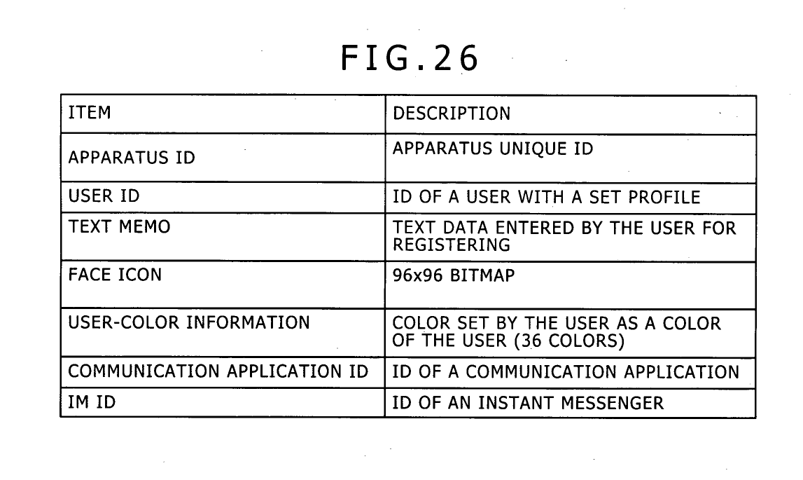

FIG. 26 is a diagram explaining typical user information exchanged between the information communication terminals 1 owned by the selecting and selected users serving as communication partners in the mutual registration process. As described above, the mutual registration process is carried out in order to register the selected user in the information communication terminal 1 owned by the selecting user and register the selecting user in the information communication terminal 1 owned by the selected user.

It is desirable to exchange information in the mutual registration process as information including an apparatus unique ID, a user ID with a set profile, a text, image data of a face icon, user color information, an ID used in a communication application and the ID of the instant messenger. Examples of the text entered by the user for the registration purpose are the URL of a home page of the user itself and sentences introducing the user itself. It is needless to say that the face icon to be displayed on a standby screen to be described later does not have to be a photo of the actual face of the user. The user color information set by the user is information on the display color of the background (or the so-called wallpaper) to be displayed during a process to communicate with the user as the background of the display unit 21. An example of the communication application cited above is a tool such as a chatting tool or an IP-telephone tool.

A message can be exchanged even between information communication terminals 1 owned by users not mutually registered in the information communication terminals 1 provided that the information communication terminals 1 exchanging the message exist in the range of implementable communications. For example, the radio communication module 148 employed in the information communication terminal 1 on the sender side transmits a message to a information communication terminal 1 on the recipient side as a message requesting the information communication terminal 1 serving as the message recipient to carry out a mutual registration process for registering the information communication terminals 1 in each other to in order to turn them into mutually registered terminals 1. After the information communication terminal 1 serving as the message recipient approves the request made by the information communication terminal 1 on the sender side, the information shown in FIG. 26 is exchanged between the terminals 1 and supplied to the application processors 131 employed in the terminals 1. The application processors 131 each supply the exchanged information to the flash memory 146 connected to the application processor 131 or either of the flash memory 156 and the large-capacity flash memory 154, which are connected to the audio processor 132. In this way, the exchanged information is stored in each specific one of the information communication terminals 1 as information on the other information communication terminal 1 owned by a user registered in the specific information communication terminal 1 as a communication partner capable of carrying out processing such as a process of exchanging files and a streaming reproduction process in an ad-hoc mode.

Between information communication terminals 1 mutually registering the other information communication terminal 1 as a communication partner capable of carrying out processing such as a process of exchanging files and a streaming reproduction process in an ad-hoc mode, a communication is always performed on a one-to-one basis in the same way as the communication between the information communication terminals 1-4 and 1-5 shown in FIG. 23 in order to implement the processing such as a process of exchanging files and processing to reproduce a musical content in a streaming reproduction process.

It is to be noted that, basically, all data files recorded internally in the information communication terminal 1 can be exchanged with the communication partner of the terminal 1 in the process of exchanging files. In the case of a data file exchanged in a file exchange process as a file having a protected copyright, however, the information communication terminal 1 serving as the communication partner receiving the data file in the file exchange process is not capable of opening (or reproducing) the file unless, for example, the information communication terminal 1 has a descramble key for decrypting the file.

In addition, in the case of a content to be reproduced in a streaming reproduction process as a content with a protected copyright in an ad-hoc mode by an information communication terminal 1 serving as a communication partner receiving the content in a file exchange process and having permission to reproduce the content, the information communication terminal 1 is not capable of opening (or reproducing) the data file containing the content unless, for example, the information communication terminal 1 has a descramble key for decrypting the streamed file.

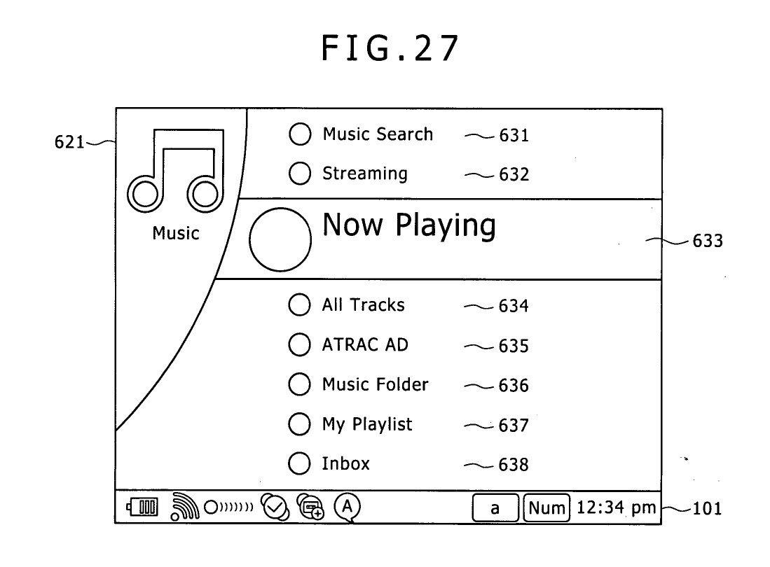

By referring to FIGS. 27 to 32, the following description explains typical processing carried out by execution of the music tool 463 selected by confirmation from items included in a menu displayed on the home screen 451 explained earlier by referring to FIG. 14. As described before, the displayed menu is a list of application programs that can be executed in the information communication terminal 1 or, as an alternative, the displayed menu can also be a list of items each including a plurality of such application programs. The processing carried out by execution of the music tool 463 is typically a process to handle audio data, which is mainly musical data.

FIG. 27 is an explanatory diagram showing a list menu screen 621 displayed on the display unit 21 as a list menu screen 621 of the music tool 463 selected by confirmation from items included in a menu displayed on the home screen 451 explained earlier by referring to FIG. 14. As shown in FIG. 27, the list menu screen 621 of the music tool 463 selected by confirmation from items included in a menu displayed on the home screen 451 shows a list of menu items such as Music Search 631, Streaming 632, Now Playing 633, All Tracks 634, ATRAC AD 635, Music Folder 636, My Playlist 637 and Inbox 638. The user is capable of selecting any desired one of the menu items by confirmation by operating the 4-direction keys 26 and the enter button 27.

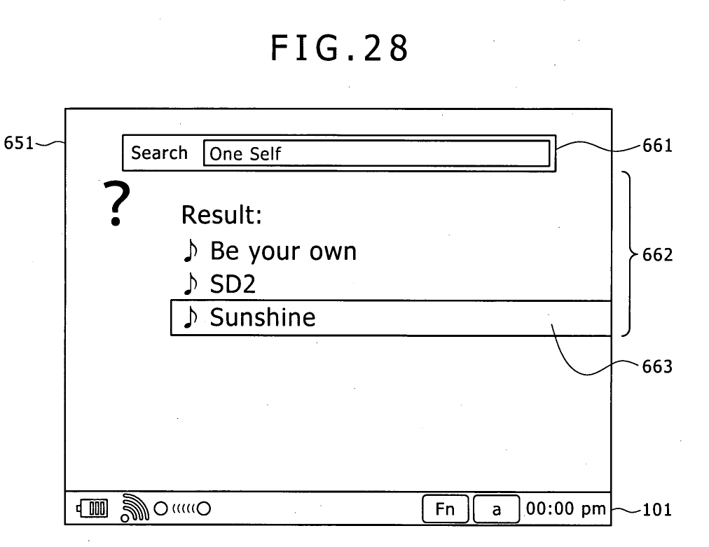

If the Music Search menu item 631 is selected by confirmation from the list menu screen 621, for example, the music search application of the application layer explained before by referring to FIG. 12 is activated. The activated music search application displays a search screen 651 like one shown in FIG. 28. Then, the user enters a desired search key to a text input area 661 in order to select a musical content as follows.

First of all, when the user enters the desired search key to the text input area 661 and presses the enter button 27, the music search application activated by the application processor 131 supplies the search key received from the keyboard module 149 to the audio processor 132.

By carrying out the music-DB function explained earlier by referring to FIG. 13, the audio processor 132 searches content titles, album titles and artist names for ones each including the search keyword received from the music search application and supplies the result of the search process to the music search application activated by the application processor 131. Let us assume for example that the result of the search process is content titles each including the search keyword.

The music search application activated by the application processor 131 displays the search result, which is a list of content titles, in a search-result display area 662 of the search screen 651 as shown in FIG. 28.

Then, the user operates the 4-direction keys 26 in order to move the cursor 663 to the position of a desired content title selected from the list displayed in the search-result display area 662 of the search screen 651, and presses the enter button 27 to confirm the selection of the desired content title pointed to by the cursor 663. In this case, the application processor 131 activates the audio player explained before by referring to FIG. 12 and, if necessary, controls the audio processor 132 to output the musical data of the content, the title of which has been selected by confirmation by the user, as reproduced data. That is to say, by carrying out the function of the audio player explained before by referring to FIG. 13, the audio processor 132 starts a process to reproduce the musical data of the content, the title of which has been selected by confirmation by the user.

To put it concretely, the audio processor 132 reads out the musical data managed by making use of the music DB from the large-capacity flash memory 154 as the musical data selected by confirmation by the user. If the musical data selected by confirmation by the user is data with a protected copyright, the audio processor 132 carries out a process to descramble the data by making use of a function and data, which are stored in the DRM library. The audio processor 132 then supplies data obtained as the result of the descrambling process to the audio-signal processing module 152 and uses an audio coding/decoding function to control the audio-signal processing module 152 to carry out a decoding process and a D/A conversion process on the data obtained as the result of the descrambling process and supply the result of the decoding process and the D/A conversion process to the ringer speaker 42 or a headphone connected to the connector jack 52 to be output as reproduced data.

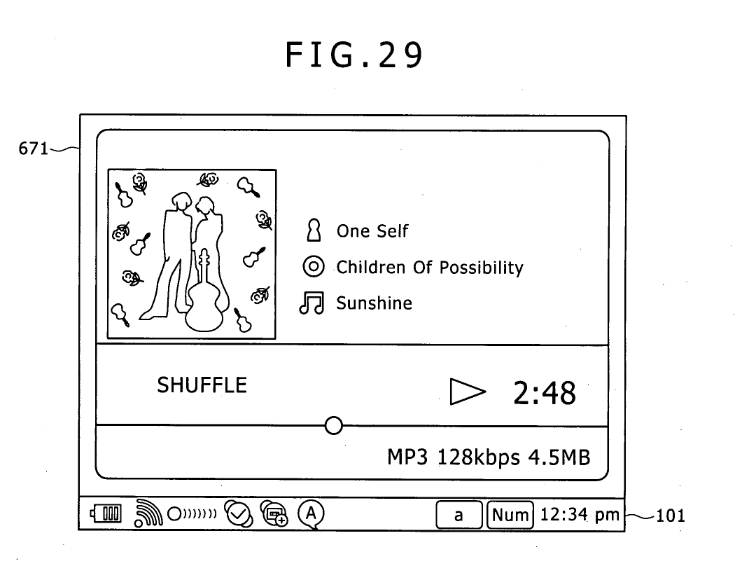

FIG. 29 is an explanatory diagram showing a musical-data reproduction display screen 671 appearing on the display unit 21 employed in the information communication terminal 1. The musical-data reproduction display screen 671 displays information on the musical content being reproduced. The information typically includes the title of the musical content, the name of an artist singing the content, the title of an album including the content and the thumbnail image of the jacket of the album.

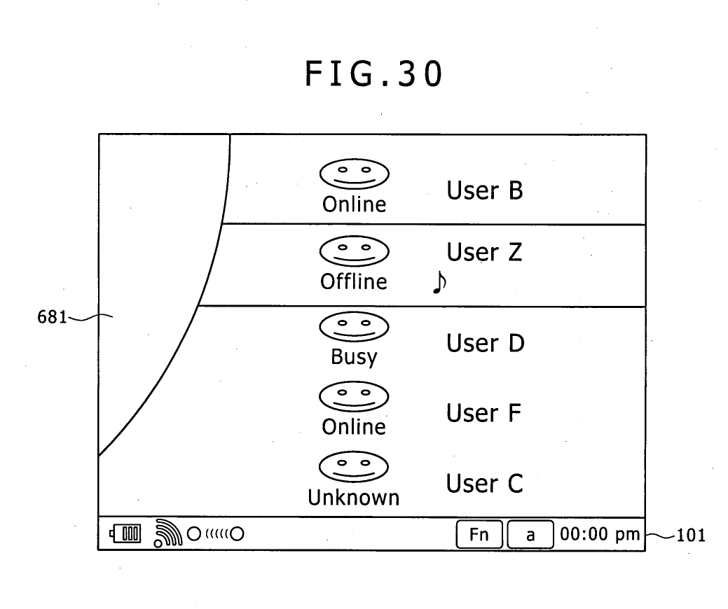

Let us now assume that the Streaming 632 is selected by confirmation from items of the menu screen 621 shown in FIG. 27 with the WLAN ad-hoc mode set. In this case, an ad-hoc user list screen 681 like one shown in FIG. 30 is displayed. If the Streaming 632 is selected by confirmation from items of the menu screen 621 shown in FIG. 27 without setting the WLAN ad-hoc mode, on the other hand, the information communication terminal 1 may display a dialog box including a message prompting the user to carry out an operation to set the WLAN ad-hoc mode. In this case, if the user carries out an operation to set the WLAN ad-hoc mode after selecting the Streaming 632 from the menu screen 621 shown in FIG. 27, an ad-hoc user list screen 681 like one shown in FIG. 30 is displayed.

As described before by referring to FIG. 25, the ad-hoc user list screen 681 basically shows a list of pieces of information on users each owning an information communication terminal 1 registered as an ad-hoc communication partner and users each owning an information communication terminal 1 located in a range of implementable communications but not registered as an ad-hoc communication partner.

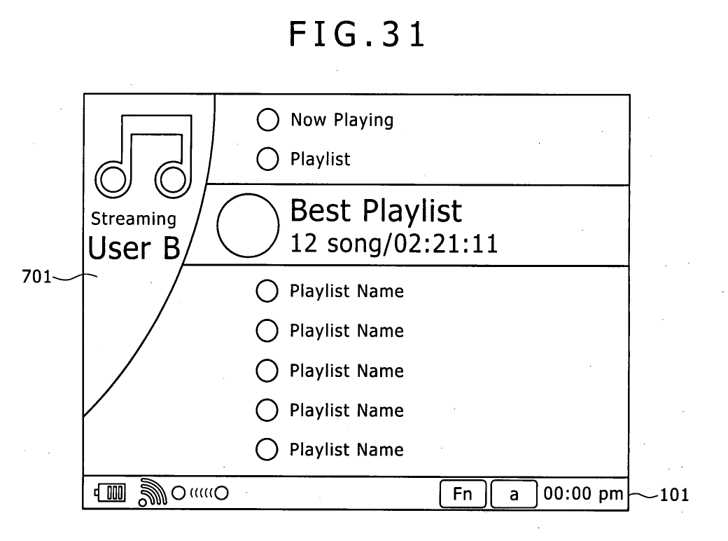

Let us assume for example that user B in an online state is selected by confirmation among users shown on the ad-hoc user list screen 681 of FIG. 30. In this case, the connection of the information communication terminal 1 to an information communication terminal 1 owned by user B in an online state is confirmed and disclosable playlists that can be disclosed to users by broadcasting are exchanged with user B. A playlist to be described later in detail is a list of some musical contents stored internally in the information communication terminal 1. Then, a disclosed-playlist list display screen 701 like one shown in FIG. 31 is displayed. As shown in the figure, the disclosed-playlist list display screen 701 is a list showing disclosed playlists received from the information communication terminal 1 owned by user B as disclosed playlists of user B and information selected from pieces of broadcasted information as information on a musical content being reproduced by (or now playing in) the information communication terminal 1 owned by user B. At that time, if the playlist including the musical content being reproduced by (or now playing in) the information communication terminal 1 owned by user B is a playlist disclosed to users, the disclosed-playlist list display screen 701 shows the playlist as a disclosed playlist in a selected state.

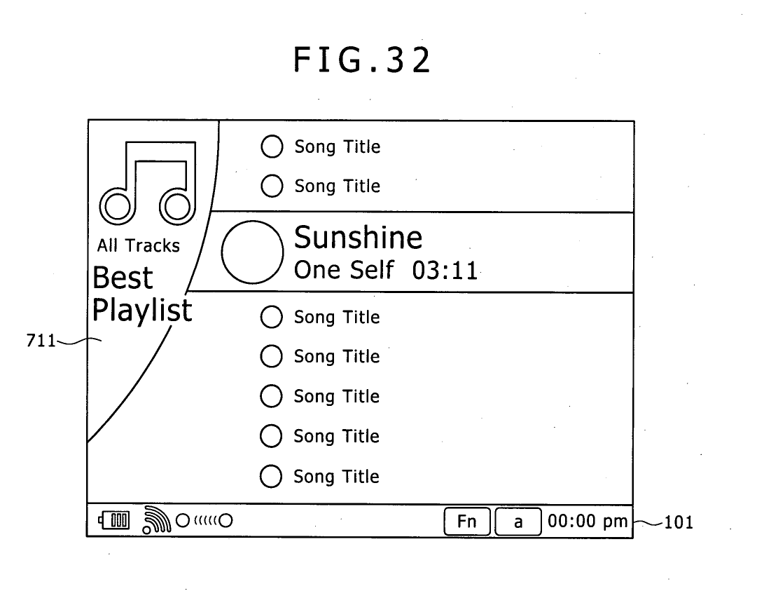

Let us assume that the user selects by confirmation a desired playlist among the disclosed playlists shown on the disclosed-playlist list display screen 701 of FIG. 31 as disclosed playlists of user B. In this case, a track-list display screen 711 like one shown in FIG. 32 is shown. As shown in the figure, the track-list display screen 711 is a list of tracks included in the desired playlist selected by confirmation among the disclosed playlists shown on the disclosed-playlist list display screen 701. In other words, the track-list display screen 711 is a list of musical contents included in the desired playlist. If the user selects a desired track by confirmation among the tracks shown on the track-list display screen 711, the information communication terminal 1 reproduces the desired track while receiving the track from the information communication terminal 1 owned by user B in a streaming reproduction process.

To put it concretely, the music streaming application executed by the application processor 131 employed in the information communication terminal 1-1 owned by user A receives a signal representing an input operation carried out by the user from the input module 150 and controls the radio communication module 148 to transmit information specifying the musical content selected by user A by confirmation from those included in the desired playlist also selected by user A by confirmation to the information communication terminal 1-2 owned by user B.

At that time, the display unit 21 employed in the information communication terminal 1-2 owned by user B may or may not display a request made by user A as a request for a permission of a connection with the information communication terminal 1-1 owned by user A.

The music streaming application executed by the application processor 131 employed in the information communication terminal 1-2 receives information from the information communication terminal 1-1 through the radio communication module 148 employed in the information communication terminal 1-2 and supplies the information to the audio processor 132. The information received from the information communication terminal 1-1 is the information specifying the musical content selected by user A by confirmation from those included on the desired playlist also selected by user A by confirmation. The audio processor 132 reads out the musical content managed by making use of the music DB from the large-capacity flash memory 154 and supplies the musical data, which is streamed data, to the application processor 131. The application processor 131 then controls the radio communication module 148 to transmit the streamed musical content to the information communication terminal 1-1.

The music streaming application executed by the application processor 131 employed in the information communication terminal 1-1 receives the streamed musical content from the information communication terminal 1-2 through the radio communication module 148 employed in the information communication terminal 1-1. If the musical content is a content with a protected copyright, the audio processor 132 carries out a process to descramble the musical content by making use of a function and data, which are stored in the DRM library. The audio processor 132 then supplies data obtained as the result of the descrambling process to the audio-signal processing module 152 and uses an audio coding/decoding function to control the audio-signal processing module 152 to carry out a decoding process and a D/A conversion process on the data obtained as the result of the descrambling process and supply the result of the decoding process and the D/A conversion process to the ringer speaker 42 or a headphone connected to the connector jack 52 to be output as reproduced data.

At that time, the musical-data reproduction display screen 671 explained earlier by referring to FIG. 29 is displayed on the display unit 21 employed in the information communication terminal 1-1, which is reproducing the musical content in a streaming reproduction process. As shown in the figure, the musical-data reproduction display screen 671 displays information on the musical content being reproduced. The information typically includes the title of the musical content, the name of an artist singing the content, the title of an album including the content and the thumbnail image of the jacket of the album. In addition, the musical-data reproduction display screen 671 may also display other information such as information on the supplier of the streamed musical content. In this case, the supplier of the streamed musical content is user B.

If the Now Playing 633 is selected by confirmation from items shown on the menu screen 621 explained earlier by referring to FIG. 27, the application processor 131 activates the audio player described before by referring to FIG. 12 and, if necessary, controls the audio processor 132 to output the musical content desired by the user as reproduced musical data. That is to say, the function of the audio player described before by referring to FIG. 13 is executed by the audio processor 132 to start a process to reproduce the musical content selected by the user by confirmation.

The audio processor 132 executes the function of the music DB explained earlier by referring to FIG. 13 to generate a list of musical contents recorded in the large-capacity flash memory 154 or information on a file structure, supplying the list or the information to the application processor 131. The file structure can be a real file structure or a virtual file structure. The application processor 131 displays the list of musical contents recorded in the large-capacity flash memory 154 or the information on the file structure on the display unit 21 by making use of the function of the graphic library. The user enters an operation input selecting a desired musical content by confirmation from those included in the data displayed on the display unit 21.

The audio processor 132 reads out the desired musical content selected by confirmation from those managed by making use of the music DB from the large-capacity flash memory 154. If the desired musical content is a content with a protected copyright, the audio processor 132 carries out a process to descramble the musical content by making use of a function and data, which are stored in the DRM library. The audio processor 132 then supplies data obtained as the result of the descrambling process to the audio-signal processing module 152 and uses an audio coding/decoding function to control the audio-signal processing module 152 to carry out a decoding process and a D/A conversion process on the data obtained as the result of the descrambling process and supply the result of the decoding process and the D/A conversion process to the ringer speaker 42 or a headphone connected to the connector jack 52 to be output as reproduced data.

At that time, the musical-data reproduction display screen 671 explained earlier by referring to FIG. 29 is displayed on the display unit 21.

If the All Tracks 634 is selected from items shown on the menu screen 621 explained earlier by referring to FIG. 27, a list of all tracks recorded in the large-capacity flash memory 154 is displayed on the display unit 21.

It is to be noted that the a content such as musical data recorded in the large-capacity flash memory 154 can be a content directly acquired from a service provider for distributing data of musical contents, acquired from a predetermined recording medium or acquired from another information communication terminal 1 or the personal computer 13. In other words, the content such as musical data recorded in the large-capacity flash memory 154 can be acquired by carrying out a radio communication in the WLAN infrastructure mode or the WLAN ad-hoc mode or by a wire communication through a USB connection according to the MSC or MTP method.

The information communication terminal 1 is capable of recording contents such as musical data in the large-capacity flash memory 154 by classifying the contents in accordance with the acquisition technique, the coding/decoding type and the copyright protection method. For example, the data of musical contents may be received from different service providers for distributing musical contents conforming to different coding/decoding techniques and/or different copyright protection methods. In this case, the contents such as musical data are classified on the basis of the service providers, which can each be an organization or an enterprise.

In the following description, in accordance with a typical classification method, contents such as musical data are categorized into at least 3 groups, i.e., ATRAC AD, Music Folder and Inbox. Thus, when the All Tracks item 634 is selected by confirmation from items shown on the menu screen 621 explained earlier by referring to FIG. 27, a list of all tracks recorded in each of three folders, namely, ATRAC AD, Music Folder and Inbox, are displayed on the display unit 21.

Musical contents stored in the folders named ATRAC AD and Music Folder are contents each acquired by carrying out a radio communication in either the WLAN infrastructure mode or the WLAN ad-hoc mode. To be more specific, musical contents stored in the folder named ATRAC AD are contents each having the ATRAC format. On the other hand, musical contents stored in the folder named Music Folder are contents each having a format other than the ATRAC format. Musical contents stored in the folder named Inbox are contents each acquired by carrying out a wire communication through a USB connection.

In the past, the copyright management method and the coding/decoding method, which were adopted for acquired (or, in most cases, downloaded) musical contents, varied in many cases in accordance with the service provider for distributing the musical contents. In addition, in many cases, the traditional information communication terminal was provided with an application program to be executed to acquire a musical content from a service provider for distributing the musical contents and reproduce the acquired musical content. In such cases, the communication method permitted as a method for exchanging musical data also varied. On the other hand, the information communication terminal 1 is adapted to the WLAN infrastructure radio communication mode and the WLAN ad-hoc radio communication mode as well as the MSC and MTP methods adopted for the USB connection. Thus, by installing an application program (or, software codec or DRM protocol) proper for the WLAN infrastructure radio communication mode and the WLAN ad-hoc radio communication mode and/or the MSC and MTP methods in the information communication terminal 1, the information communication terminal 1 can be made capable of acquiring data of musical contents from a number of service providers as well as storing and reproducing the data.

If the ATRAC AD 635 is selected from items shown on the menu screen 621 explained earlier by referring to FIG. 27, a list of all tracks recorded in the ATRAC AD folder stored in the large-capacity flash memory 154 is displayed on the display unit 21. By the same token, if the Music Folder item 636 is selected by confirmation from items shown on the menu screen 621 explained earlier by referring to FIG. 27, a list of all tracks recorded in the ‘Music Folder’ folder stored in the large-capacity flash memory 154 is displayed on the display unit 21. In the same way, if the Inbox item 638 is selected by confirmation from items shown on the menu screen 621 explained earlier by referring to FIG. 27, a list of all tracks received in a file transfer through the USB connection and recorded in the ‘Inbox’ folder stored in the large-capacity flash memory 154 is displayed on the display unit 21.

Musical contents recorded in the folder named Inbox are each a content acquired from the personal computer 13 connected to the information communication terminal 1 by a USB connection. To put it in detail, musical contents recorded in the folder named Inbox are each a content acquired from the personal computer 13 connected to the information communication terminal 1 by a wire communication through the USB connection according to the MSC or MTP method adopted as the USB connection method.

As described above, in the past, the copyright management method and the coding/decoding method, which were adopted for acquired (or, in most cases, downloaded) musical contents, varied in many cases in accordance with the service provider for distributing the musical contents. In addition, in many cases, the traditional information communication terminal was provided with an application program to be executed to acquire a musical content from a service provider for distributing the musical contents and reproduce the acquired musical content. That is to say, in many cases, since the personal computer 13 has installed application programs provided by a plurality of service providers, a content (such as musical data) stored in the personal computer 13 can be handled only by a predetermined application program provided by a service provider supplying the content. In other words, in many cases, an operation to copy a content from the personal computer 13 connected to the information communication terminal 1 by a USB connection to the information communication terminal 1 can be carried out only by a predetermined application program provided by a service provider distributing the content. Even in such a case, the information communication terminal 1 is capable of acquiring contents such as musical data from the personal computer 13, which has received the data from a variety of service providers, as well as storing and reproducing the data. This is because the information communication terminal 1 is adapted to both the MSC and MTP modes adopted as the USB connection mode for the USB connection.

An operation to switch the USB connection mode from MSC to MTP or vice versa can be started by selecting the Tools 468 from the items shown on the home screen 451 explained before by referring to FIG. 14. The setting tool described earlier by referring to FIG. 13 as a tool for the application processor 131 has a function to switch the USB connection mode from MSC to MTP or vice versa by controlling the audio processor 132 to select the MSC or MTP software owned by the audio processor 132 as described earlier by referring to FIG. 13. In this way, the function used by application programs such the file exchange application can be switched.

If the My Playlist 637 is selected from items shown on the menu screen 621 explained earlier by referring to FIG. 27, a list of contents such as musical data is displayed in accordance with an input operation carried out by the user. To put it concretely, My Playlist is a list of contents (such as musical data) managed as a virtual file generated as a file of a virtual-file system in a process to classify the contents in accordance with a method determined by the user. As described before, the contents such as musical data are categorized into at least three groups, i.e., ATRAC AD, Music Folder and Inbox and recorded in three folders, namely, the aforementioned ATRAC AD, Music Folder and Inbox folders respectively. For example, the playlist is a list of favorite contents such as songs. In order to manage a number of musical contents, playlists are typically classified by genre into, for example, a playlist of indoor music, a playlist of orchestral music, a playlist of instrumental music and a playlist of vocal music. At the same time, playlists may also be classified by artist and/or performer into, for example, a playlist of music performed by musician A, a playlist of music performed by musician B, a playlist of music performed by orchestra A, a playlist of music performed by orchestra B, a playlist of music performed by conductor A and a playlist of music performed by conductor B. In addition, playlists may also be classified by composer into a playlist of music written by composer A and a playlist of music written by composer B.

In addition, it is needless to say that playlists represented by the My Playlist menu can organized in a layer structure consisting of a plurality of layers. For example, the playlists are classified by composer into large groups such as a playlist of music written by composer A and a playlist of music written by composer B. Then, music pertaining to each of the large groups is further classified by genre into middle groups such as a playlist of indoor music, a playlist of orchestral music, a playlist of instrumental music and a playlist of vocal music. Furthermore, music pertaining to each of the middle groups is classified by music title into small groups, which including the same title of music performed by different artist and/or performer, or orchestra. By organizing musical contents in a layer structure consisting of a plurality of layers as described above, the user is capable of searching the structure for a musical content, which the user wants to listen to, with ease. For example, the user can easily find a musical content included on the orchestral-music playlist pertaining to the playlist of music written by composer A as a content performed by orchestra B named the Xth Symphony Orchestra.

In addition, it is possible to have a plurality of My Playlist musical groups. In this case, it is needless to say that the same musical content may pertain to more than one My Playlist musical group. Since each of the My Playlist musical groups is a virtual file of a virtual-file system, a musical content is actually stored as a real data file in the large-capacity flash memory 154 even if the same musical content pertains to more than one My Playlist musical group.

On top of that, each of the My Playlist musical groups may include a flag indicating whether or not the group can be disclosed at an ad-hoc broadcasting time. That is to say, it is possible to provide a configuration in which only some of the My Playlist musical groups are disclosed at an ad-hoc broadcasting time.

Moreover, My Playlist can be newly created, deleted or updated with a high degree of freedom in accordance with an operation input entered by the user. For example, it is desirable to provide a configuration in which, when the user presses downward the option button 25 with information on My Playlist displayed on the display unit 21, a dialog box appears on the screen of the display unit 21 as a box for letting the user select an operation to newly create, delete or update My Playlist.

The following description explains applications each executed in order to carry out processing involving a communication process performed in the WLAN infrastructure mode. The applications each executed in order to carry out processing involving a communication process performed in the WLAN infrastructure mode include the instant messenger, the web browser and the communication application including functions such as the IP-telephone function. In addition, application programs such as the email application may also be installed in the information communication terminal 1 as an application to be executed in order to carry out processing involving a communication process performed in the WLAN infrastructure mode.

The following description explains typical processing carried out by execution of the communication application (communication 462) selected by confirmation from application programs included in a menu displayed on the home screen 451 explained earlier by referring to FIG. 14. As described before, the displayed menu is a list of application programs that can be executed in the information communication terminal 1 or, as an alternative, the displayed menu can also be a list of items each including a plurality of such application programs.

Examples of the communication tool making use of a wide-area network such as the Internet are the IP-telephone function and the chatting function. Services making use of such communication tools are provided by a plurality of service enterprises each serving as a service provider. The information communication terminal 1 is configured to be capable of utilizing communication tools provided by a plurality of service enterprises each serving as a service provider.

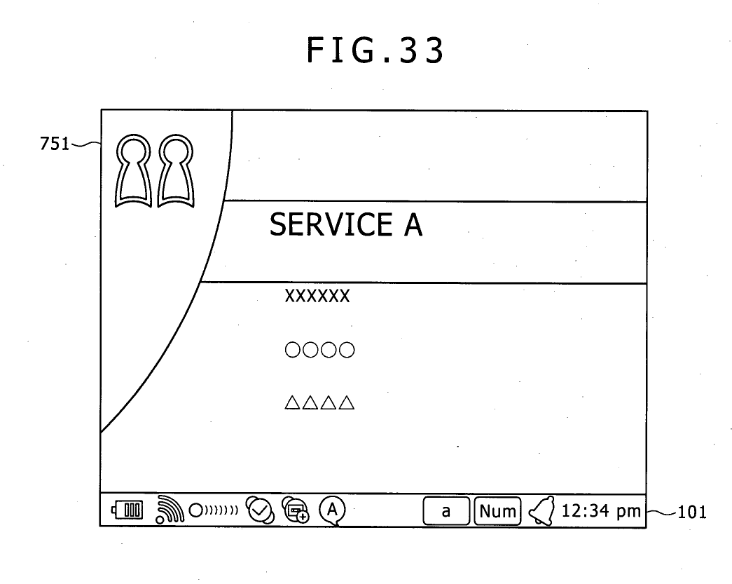

FIG. 33 is an explanatory diagram showing the top screen 751 of the communication application (Communication 462) selected by confirmation from application programs included in a menu displayed on the home screen 451 explained earlier by referring to FIG. 14. As shown in FIG. 33, the communication-application top screen 751 displays the names of communication tools provided by a plurality of service enterprises each serving as a service provider.

The user is allowed to set the so-called auto login function in an on or off state in advance for each of the communication tools to be used. The operation to set the auto login function in an on or off state is carried out by the setting tool started by selecting the Tools 468 among items shown in a menu displayed on the home screen 451 explained earlier by referring to FIG. 14. The setting tool has been explained earlier by referring to FIG. 12 as a tool of the application processor 131. The setting tool is provided with a function to switch the auto login function to an on or off state in accordance with an operation input entered by the user or provided with a function to switch the processing carried out by the communication application.

In addition, initial setting can be made in order to automatically activate a communication application with the WLAN put in an on state and the WLAN infrastructure mode set as the communication mode.

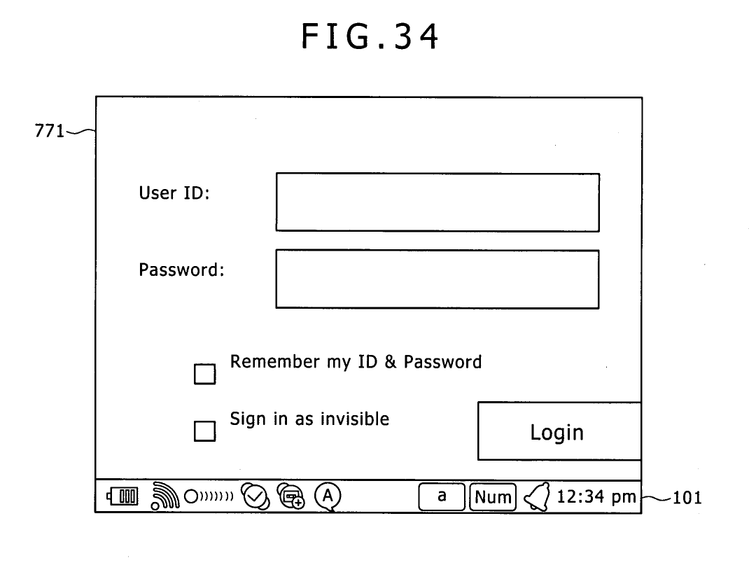

FIG. 34 is an explanatory diagram showing a login screen 771, which is displayed when the user selects by confirmation the name of a communication tool with the auto login function disabled in advance among menu items appearing on the communication-application top screen 751 shown in FIG. 33. As shown in FIG. 34, the login screen 771 includes areas to which information required in a login process is to be entered by the user. Information required in a login process includes a user ID and a password.

It is to be noted that, if the WLAN infrastructure mode is not set in this state, a message can be displayed in order to prompt the user to carry out an operation of putting the WLAN infrastructure mode in an on state before going on to a process carried out as described below after the WLAN infrastructure mode is set.

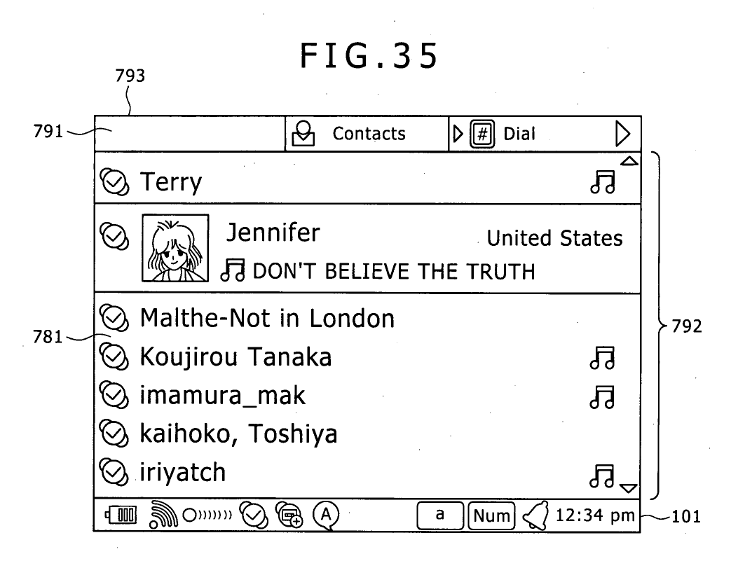

If the user selects by confirmation the name of a communication tool with the auto login function enabled in advance among menu items appearing on the communication-application top screen 751 shown in FIG. 33 or, if the login process is completed by the user by entering the information required in the login process to the login screen 771 shown in FIG. 34, a contact-list display screen 781 like one shown in FIG. 35 is displayed.

As shown in FIG. 35, the contact-list display screen 781 includes a content-tab display area 791 and a list display area 792 in addition to the continuous display panel 101.

The content-tab display area 791 includes a plurality of tabs each showing a command to carry out an operation. The list display area 792 is a list of contacts. The user operates the 4-direction keys 26 to select a tab shown in the content-tab display area 791 and select a contact on the list displayed in the list display area 792, pressing the enter button 27 to confirm the selection of the command and the selection of the contact in order to carry out the command displayed in the selected tab on the selected contact.

In this case, the tabs are laid out virtually to form an array. By operating the right-direction and left-direction keys of the 4-direction keys 26, the user is capable of shifting the whole array horizontally with a center display area 793 of the content-tab display area 791 always assumed to be an area showing the tab selected by the user. By operating the right-direction and left-direction keys of the 4-direction keys 26 to shift the whole array horizontally, the user is capable of shifting any tab on the left or right side of the selected-tab display area 793 to the area 793. It is to be noted that the virtual array can be designed as a circular array with the left-end tab followed by the right-end tab and vice versa or designed as a non-circular array. In the case of a non-circular virtual array, the user is capable of shifting the entire array horizontally to the right by making use of the right-direction key of the 4-direction keys 26 till the left-end tab is placed in the center display area 793 as a selected tab, or shifting the entire array horizontally to the left by making use of the left-direction key of the 4-direction keys 26 till the right-end tab is placed in the center display area 793 as a selected tab.

The content-tab display area 791 typically includes a contact-list tab, a dial tab, a call tab, a chat tab, a call-list tab, a setting tab and a start tab. The contact-list tab is a tab to be selected to display a list of registered users with which the user operating the information communication terminal 1 is capable of communicating. The dial tab is a tab to be selected to display a list of users with which the user operating the information communication terminal 1 is capable of communicating or a list of phone numbers, let the user enter an operation input to select one of the users by confirmation as a communication partner and carry out processing to make an IP call to the selected communication partner. The call tab is a tab to be selected to carry out a process of setting a screen during a call. The chat tab is a tab to be selected to display a text input area for inputting a chatting text and a text display area for displaying a text entered by the chatting partner. The call-list tab is a tab to be selected to display a history of outgoing and incoming calls. The setting tab is a tab to be selected to display a screen used to establish various kinds of setting. The start tab is a tab to be selected to display the status of the information communication terminal 1 owned by the user itself.

With the contact-list tab selected, for example, the list display area 792 shows a list of registered users with which the user operating the information communication terminal 1 is capable of communicating. In this case, the user can operate the 4-direction keys 26 to select a desired registered user among those shown on the list. The desired registered user selected among those shown on the list and information on the selected user may be deliberately displayed to occupy a largest area in the list display area 792 among the unselected users on the list. Then, the user typically operates the enter button 27 in order to confirm the selection of the desired user after examining the information on the selected user. In this case, it is desirable to display a list of usable communication tools, any one of which can be selected by the user. The usable communication tools typically include tools for carrying out the IP-phone, chatting and email functions.

The following description explains typical processing carried out by execution of the web browser 464 selected by confirmation from items included in a menu displayed on the home screen 451 explained earlier by referring to FIG. 14. As described before, the displayed menu is a list of application programs that can be executed in the information communication terminal 1 or, as an alternative, the displayed menu can also be a list of items each including a plurality of such application programs.

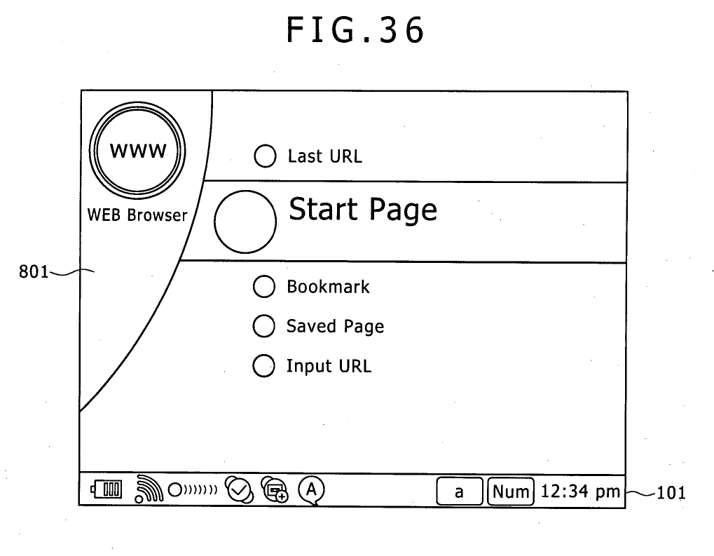

When the web browser 464 is selected by confirmation from items included in a menu displayed on the home screen 451 explained earlier by referring to FIG. 14, a web browser menu screen 801 like one shown in FIG. 36 is displayed. The web browser menu screen 801 displays a menu used for selecting a method to specify a web page to be displayed.

Typical methods each used to specify a web page to be displayed include a last-URL method, a start-page method, a bookmark method, a saved-page method and an input-URL method. The last-URL method is a method in accordance with which a web page accessed last is displayed. The start-page method is a method in accordance with which a page recorded in advance is displayed as a web page to be displayed initially. The bookmark method is a method in accordance with which a stored list of favorite web pages is displayed and the user selects a desired web page by confirmation among those on the list as a page to be displayed. The saved-page method is a method in accordance with which a page with the data thereof saved in advance is displayed. The input-URL method is a method in accordance with which the user enters the URL of a desired web page.

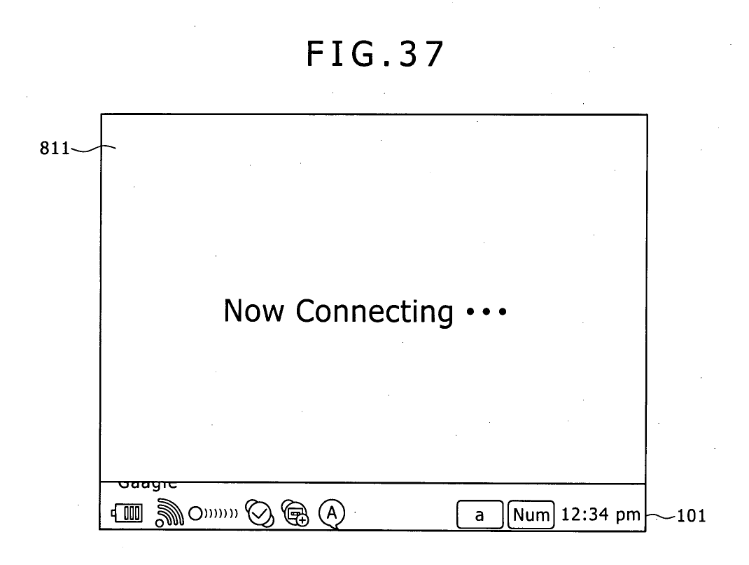

When the user selects a method to specify a web page to be displayed from those appearing on the web browser menu screen 801 and a web page to be accessed is confirmed, a connection to the page is established. In the mean time, a connection screen 811 like one shown in FIG. 37 is displayed. The connection to the web page is established by making an access to a server 12 disclosing the page in the network such as the Internet.

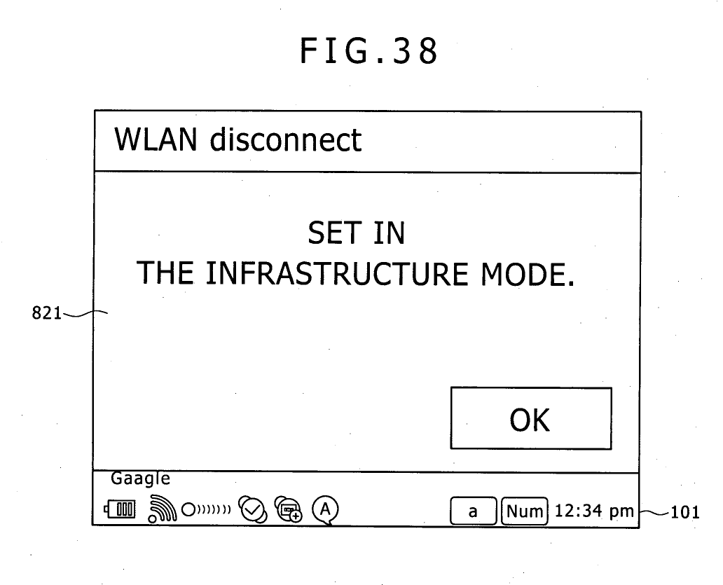

It is to be noted that, if the WLAN infrastructure mode has not been put in an on state in this case, the information communication terminal 1 typically displays a message display screen 821 including a message shown to the user as a message prompting the user to carry out an operation to set the WLAN infrastructure mode as shown in FIG. 38 before going on to a process carried out as described below after the WLAN infrastructure mode is set.

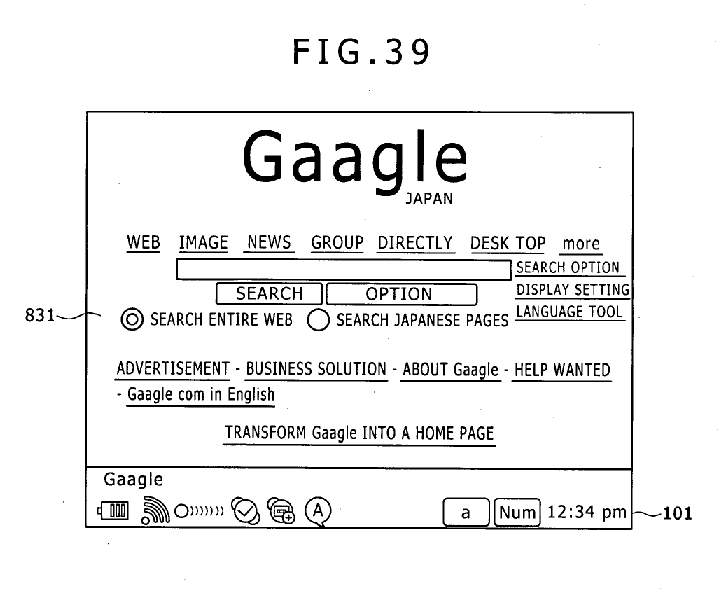

After the WLAN infrastructure mode is put in an on state and the connection to the web page at the specified URL is established, the web page is displayed as a web-page display screen 831 like one shown in FIG. 39.

In addition, the continuous display panel 101 of the connection screen 811 shown in FIG. 37, the continuous display panel 101 of the message display screen 821 shown in FIG. 38 and the continuous display panel 101 of the web-page display screen 831 shown in FIG. 39 may display information such as the URL or name of the web page to be connected or being connected.

The following description explains typical processing, which is carried out when the standby screen 461 is selected by confirmation from items included in a menu displayed on the home screen 451 explained earlier by referring to FIG. 14. As described before, the displayed menu is a list of application programs that can be executed in the information communication terminal 1 or, as an alternative, the displayed menu can also be a list of items each including a plurality of such application programs.

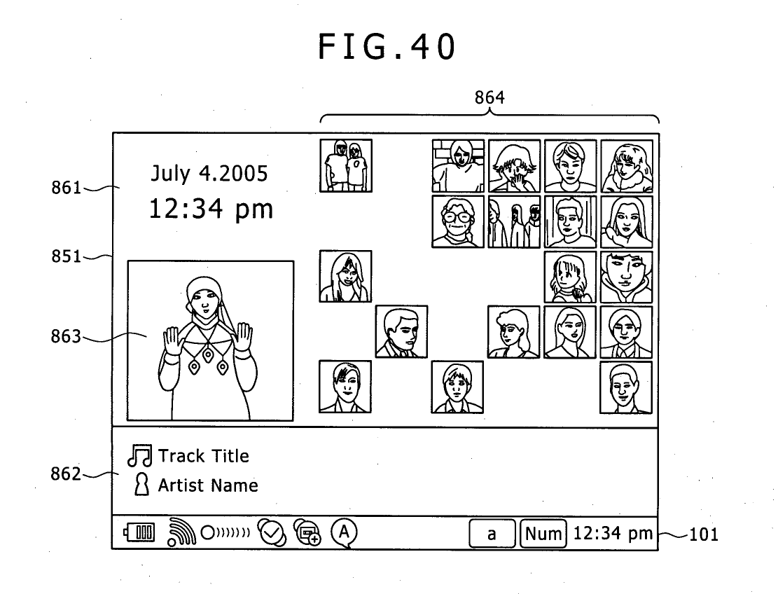

When the standby screen 461 is selected by confirmation from items included in a menu displayed on the home screen 451 explained earlier by referring to FIG. 14, a standby screen 851 like one shown in FIG. 40 is displayed.

As shown in the figure, the standby screen 851 includes a date/time display area 861, a reproduced music data information display area 862, an image display area 863 and a contact-icon display area 864.

The date/time display area 861 is an area for displaying the present date expressed in terms of a year, a month and a day, and displaying the present time.

The reproduced music data information display area 862 is an area for displaying information on a musical content if the musical content is presently being reproduced and output.

The image display area 863 is an area for displaying an image. For example, if an image set by the user exists or if a musical content is presently being reproduced and output, the image set by the user or an image stored by being associated with the musical content is displayed in the image display area 863. The image set by the user is typically the so-called wallpaper whereas the image stored by being associated with the musical content is typically the image of a jacket for an album including the musical content.

The contact-icon display area 864 is an area for displaying information on whether or not it is possible to communicate with a communication partner in the current communication mode. The information also includes information on whether the communication partner is a registered partner.

Thus, the standby screen 851 displays information on whether or not it is possible to communicate with a communication partner in each current communication mode. That is to say, the information communication terminal 1 is configured to be capable of communicating with another apparatus by adoption of the radio-communication method or the wire-communication method. When the information communication terminal 1 is configured to be capable of communicating with another apparatus by adoption of the radio-communication method, however, the information communication terminal 1 is capable of communicating with a plurality of information communication terminals 1. In this case, the standby screen 851 displays information on whether or not it is possible to communicate with a communication partner in the WLAN infrastructure mode or the WLAN ad-hoc mode with the WLAN communication enabled.

In the WLAN ad-hoc mode, the contact-icon display area 864 may typically display icons each representing an online user, which is defined as a registered user existing in the present range of implementable communications. In addition, in the WLAN ad-hoc mode, the contact-icon display area 864 may also display icons each representing an online user, which is defined as a registered user existing in the present range of implementable communications as described above, and icons each representing an unknown user, which is defined as an unregistered user existing in the range of implementable communications, by distinguishing the icons for online users from the icons for unknown users from each other. On top of that, in the WLAN ad-hoc mode, the contact-icon display area 864 may also display icons each representing an online user, icons each representing an offline user, which is defined as a registered user not existing in the present range of implementable communications, and icons each representing an unknown user by distinguishing the icons for online users, the icons for offline users and the icons for unknown users from each other in basically the same way as the displays explained before by referring to FIG. 25.

Furthermore, in the WLAN ad-hoc mode, the contact-icon display area 864 may typically display icons representing users with which the information communication terminal 1 is capable of communicating by executing a plurality of application programs each used for carrying out a communication process in the WLAN ad-hoc mode. To be more specific, the contact-icon display area 864 may display icons each representing a user with which the information communication terminal 1 is capable of communicating by execution of the instant messenger, icons each representing a user with which the information communication terminal 1 is capable of communicating by execution of the communication application, and icons each representing a user, the email address of which has been registered in the information communication terminal In such cases, if the communication mode is switched from the WLAN infrastructure mode to the WLAN ad-hoc mode or vice versa with the standby screen 851 displayed for example, icons appearing in the contact-icon display area 864 of the standby screen 851 are automatically changed in accordance with the switching of the communication mode.

To put it in detail, the application processor 131 generates data of images to be displayed in the contact-icon display area 864 of the standby screen 851 correlating to the communication mode, and controls the display module 142 to display the images on the display unit 21. The application processor 131 generates data on the basis of information stored in the flash memory 146 connected to the application processor 131 or either of the flash memory 156 and the large-capacity flash memory 154, which are connected to the audio processor 132. The information used as the basis for generating the data can be:

information on each other information communication terminal 1 owned by a user registered as a communication partner, in conjunction with which a file can be exchanged or a streaming reproduction process or other operations can be carried out in the WLAN ad-hoc mode;

information on each other information communication terminal 1 owned by a user registered as a communication partner for the instant messenger or the communication application in the WLAN infrastructure mode; or

the broadcasted information explained earlier by referring to FIG. 24 as information received by the radio communication module 148 employed in this information communication terminal 1 in the WLAN ad-hoc mode.

It is to be noted that each icon displayed in the contact-icon display area 864 as an icon representing a registered user is created on the basis of image data included in the information explained earlier by referring to FIG. 26 as user information, which is received if the user is a mutually registered user. On the other hand, each icon displayed in the contact-icon display area 864 as an icon representing an unknown user defined as an unregistered user existing in the range of implementable communications is created on the basis of image data received as image data for the icon along with the broadcasted information explained earlier by referring to FIG. 24 if such image data has been received for the icon. As an alternative, an icon displayed in the contact-icon display area 864 as an icon representing an unknown user can be an icon showing character information included in the broadcasted information explained earlier by referring to FIG. 24. For example, the icon displayed in the contact-icon display area 864 as an icon representing an unknown user is an icon showing the word ‘unknown’.

In addition, it is desirable to arrange icons each displayed in the contact-icon display area 864 as an icon representing a registered user in accordance with predetermined rules, which will be described later in detail.

By having the configuration described above, the user owning the information communication terminal 1 is capable of determining which other user is to be contacted by adoption of a more natural method in a process to contact the other user through a communication with the other user.

That is to say, in general, in a communication including a case not making use of a communication apparatus, an attempt is made to contact a person, who can be contacted with ease, in some cases. An example of such a person who can be contacted with ease is a nearby person. In other words, the standby screen displays partners (with each of whom the user is capable of communicating) by indicating that each of the partners is an online partner, an offline partner or an unknown partner defined as a partner with whom the user is capable of communicating but has not communicated before. In this way, the user owning the information communication terminal 1 is capable of determining which other user is to be contacted by adoption of a more natural method in a process to contact the other user through a communication with the other user.

In addition, it is possible to provide a configuration in which, if any of the icons appearing in the contact-icon display area 864 is selected in the WLAN ad-hoc mode, image data disclosed by a selected user is displayed in the image display area 863 whereas information on a musical content being reproduced by the selected user, a text memo broadcasted by the selected user and other information are displayed in the reproduced music data information display area 862 on the basis of the information explained earlier by referring to FIG. 24 as information broadcasted by another information communication terminal 1 existing in the range of implementable communications and on the basis of the user information explained earlier by referring to FIG. 26 as information exchanged with a communication partner in a process to mutually register the communication partner.

On top of that, the information communication terminal 1 is configured to be capable of producing a result of determination as to whether or not a musical content is being reproduced by another information communication terminal 1 on the basis of the Now Playing information included in information broadcasted by the other information communication terminal 1 in the WLAN ad-hoc mode. Thus, in the WLAN ad-hoc mode, it is possible to provide a configuration in which the application processor 131 employed in this information communication terminal 1 activates a portion of the music streaming function in advance as a background function with the standby screen 851 displayed, an icon representing another information communication terminal 1 owned by a registered user existing in a range of implementable communications is selected among icons appearing in the contact-icon display area 864 and, if the user represented by the selected icon is reproducing a musical content, the application processor 131 transmits a request to another information communication terminal 1 owned by the user represented by the selected icon in order to request the other information communication terminal 1 to serve as the sender of the musical content in a streaming reproduction process to be carried out by this information communication terminal 1 on the musical content being reproduced so that this information communication terminal 1 is capable of carrying out the streaming reproduction process to reproduce the musical content received from the other information communication terminal 1. It is to be noted that a displayed icon may be regarded as a selected icon only if the icon is being pointed to by a cursor used for selecting an icon for at least a predetermined period of typically three seconds in order to prevent any icon, which happens to be instantly pointed to by the cursor in a process to change the position of the cursor during an operation to select an icon, from being interpreted as a selected icon. In this way, the application processor 131 is capable of transmitting a request to another information communication terminal 1 owned by a user represented by the truly selected icon in order to request the other information communication terminal 1 to serve as the sender of the musical content in a streaming reproduction process to be carried out by this information communication terminal 1 on the musical content being reproduced by the other information communication terminal 1 instead of transmitting the request to another information communication terminal 1 owned by a user represented by an icon, which happens to be instantly pointed to by the cursor in a process to change the position of the cursor during an operation to select an icon.

On top of that, it is possible to provide a configuration in which, if any of the icons appearing in the contact-icon display area 864 is selected in the WLAN infrastructure mode, image data disclosed by a selected user is displayed in the image display area 863 whereas a text memo broadcasted by the selected user and other information are displayed in the reproduced music data information display area 862 on the basis of the user information explained earlier by referring to FIG. 26 as information exchanged with a communication partner in a process to mutually register the communication partner.

In addition, it is possible to provide a configuration in which, if any of the icons appearing in the contact-icon display area 864 is selected, without regard to whether the communication mode is the WLAN infrastructure mode or the WLAN ad-hoc mode, the selected icon is displayed in a shape enlarged to typically about 150% of the shapes of the other icons.

Furthermore, it is possible to provide a configuration in which, if any of the icons appearing in the contact-icon display area 864 is selected by confirmation, for example, user information can be displayed on the display unit 21 on the basis of the information explained earlier by referring to FIG. 24 as information broadcasted by another information communication terminal 1 existing in the range of implementable communications and on the basis of the user information explained earlier by referring to FIG. 26 as information exchanged with a communication partner in a process to mutually register the communication partner.

Moreover, it is possible to provide a configuration in which, if any of the icons appearing in the contact-icon display area 864 is selected by confirmation, a list of applications is displayed in order to show the applications each usable for exchanging information with another apparatus such as another information communication terminal 1 owned by a user represented by the icon selected by confirmation or the personal computer 13.

By providing configuration described above, the user owning the information communication terminal 1 is capable of determining which other user is to be contacted by adoption of a more natural method in a process to contact the other user through a communication with the other user.

That is to say, in a communication including a case of not making use of a communication apparatus in general, in order to contact a certain communication partner, it is necessary to think of a method for contacting the partner. That is to say, a list of applications is displayed as a list showing applications each usable in a process to exchange information with a communication partner selected by confirmation by making use of the standby screen in order to make the user owning the information communication terminal 1 capable of determining which other user is to be contacted by adoption of a more natural method in a process to contact the other user through a communication with the other user.

As described above, the information communication terminal 1 provided by the present invention is capable of exchanging information with other apparatus with ease by adoption of a variety of methods.

The following description explains a process to distribute a content such as mainly musical data to a large number of users and a process to promote sales of the content by virtue of the ability of the information communication terminal 1 to exchange information with other apparatus with ease.

FIG. 41 is an explanatory system configuration diagram referred to in description of a method to distribute a content in more detail in an information communication system including the information communication terminal 1 provided by the present invention as explained earlier by referring to FIG. 1.

That is to say, the severs 12 explained earlier by referring to FIG. 1 include a content introduction service server 12-1, a content sale server 12-2 and a content distribution server 12-3.

The information communication terminal 1 or the personal computer 13 generates information (or push data to be described later) including a portion of a content such as musical data and distributes the generated information to other apparatus (strictly speaking, transmits the generated information to an other predetermined apparatus). Thus, when the user owning the other apparatus receiving the distributed portion of the content purchases the content, the content introduction service server 12-1 gives points of content-introduction appreciation or other appreciations to the user distributing the portion of the content (that is, the user introducing the content), and/or acquires information on the accomplishments of the introduction and the purchasing of the content and stores the information on the accomplishments for future use. In this way, the content introduction service server 12-1 is capable of serving as a server for providing services to generate information for promoting distribution of a content and notify users of generated information.

The content sale server 12-2 is a server for providing services to sell a content such as musical data to a user owning the information communication terminal 1 or the personal computer 13 through the network 11.

The content distribution server 12-3 is a server for carrying out processing to generate a content to be distributed to users each owning an information communication terminal 1 or a personal computer 13. An example of the generated content is musical data. The content distribution server 12-3 is also a server commissioning sales of the content to the content sale server 12-2. The content distribution server 12-3 is also a server for rendering a service to sell a content such as musical data to users through the network 11.

Please keep in mind that it is needless to say that a plurality of content introduction service servers 12-1, a plurality of content sale servers 12-1 and/or a plurality of content distribution servers 12-3 may be provided. In addition, it is also possible to provide a single server for executing the functions of the content introduction service server 12-1, the content sale server 12-2 and the content distribution server 12-3. As an alternative, it is also possible to provide a server for carrying out a plurality of functions or for rendering a plurality of services. For example, it is possible to provide a content introduction service server 12-1 that also functions as a server for selling a content. Of course, it is also possible to provide a plurality of servers each used for carrying out the functions of the content introduction service server 12-1, the content sale server 12-2 and the content distribution server 12-3.

A typical content 881 generated by the content distribution server 12-3 is shown in FIG. 42.

The typical content 881 shown in FIG. 42 is provided (sold or distributed) musical data.

As shown in the figure, the content 881, which is a musical content, includes fringe data 891, which is information attached to the content 881 and musical data 892.

As shown in the figure, the fringe data 891 of a musical content includes the title of the musical content, the ID of the musical content, the name of an artist for the musical content, the sale date of the musical content, the name of the content sale server, the ID of the content sale server, copyright management information, information indicating whether or not push data for the musical content can be produced, the name of the distributor of the musical content, the ID of the distributor of the musical content, information on a server from which the musical content can be purchased, information on image data to be used for a display in a reproduction process, the name of the genre of the musical content, the ID of the genre of the musical content, information introducing the musical content, information on a musical-content cutout position, a period during which the push data can be held or a limit till which the push data can be held and other information.

When the user purchases a content 881 like the one shown in FIG. 42, the information communication terminal 1 owned by the user receives the content 881 and stores the content 881 in the large-size flash memory 154. Push data is data typically created by cutting out a portion of a content 881 stored in the large-size flash memory 154 and adding predetermined data to the portion, which is used for introducing the content 881 to other users. The push data is then distributed to the other users. Details of the push data will be described later.

The information indicating whether or not push data for the musical content 881 can be produced is information used by the information communication terminal 1 receiving the content 881 from the creator, seller or distributor of the content 881 to produce a result of determination as to whether or not the information communication terminal 1 is allowed to create the push data for the content 881. If the result of the determination indicates that the information communication terminal 1 is not allowed to create push data for the content 881, the push data cannot be created by typically cutting out a portion of a content 881 stored in the large-size flash memory 154 and adding predetermined data to the portion, which is used for introducing the content 881 to other users, for distribution to the other users.

Examples of the information on image data to be used for a display in a reproduction process are a photo of the jacket of an album including the content 881, a photo of the artist for the content 881 and a moving picture of a video being performed (or a musical clip). The information on image data to be used for a display in a reproduction process typically includes image data that can be reproduced and output to the image display area 863 shown in FIG. 40 in a process to reproduce the content 881 and information on the reproduced and output image data. The information of image data to be used for a display in a reproduction process typically also includes information indicating whether or not the image data to be used for a display in a reproduction process may be added to a portion cut out from a content 881 in a process to create push data for the content 881 and information indicating whether or not conversion of the image data is necessary if the image data may be added to the portion. The conversion of the image data to be used for a display in a reproduction process is a process to reduce the resolution of the image data and add the image data to the portion cut out from the content 881. In addition, the image data to be used for a display in a reproduction process may have plurality of data.

The information on a musical-content cutout position includes information indicating whether or not the user is allowed to arbitrarily set a position at which a portion is to be cut out from the musical content 881 in a process to generate push data for the content 881, information indicating a range in which the user can set the position at which a portion is to be cut out from the musical content 881 in a process to generate push data for the content 881 if the user is allowed to set such a position or information on a predetermined position at which a portion is to be cut out from the musical content 881 in a process to generate push data for the content 881.

The period during which the push data can be held or the limit till which the push data can be held is information showing a period during which the push data generated by the information communication terminal 1 for a content 881 can be held (or a limit till which the push data can be held) in another apparatus receiving the push data distributed by the information communication terminal 1 since the other apparatus stores the push data in a memory. If a period during which the push data can be held or a limit till which the push data can be held is set, the push data is deleted from the memory of the other apparatus serving as a recipient of the push data when the period or the limit expires.

The information on a server from which a musical content can be purchased is actually information indicating a plurality of such servers. The information on a plurality of servers from which a musical content can be purchased includes the name of each of the servers, the ID of each of the servers and the price of the musical content at each of the servers.

The information communication terminal 1 or the personal computer 13 can receive a content 881 explained earlier by referring to FIG. 42 as a content, which is transmitted by the content sale server 12-2 or the content distribution server 12-3 through the network 11, basically as a pay content. In other words, the user owning the information communication terminal 1 or the personal computer 13 can purchase a content 881 explained earlier by referring to FIG. 42 from the content sale server 12-2 or the content distribution server 12-3. It is to be noted that the information communication terminal 1 is capable of acquiring a content 881 stored in the personal computer 13 in a file transfer process making use of the USB connection described above provided that the management of copyrights allows such a file transfer.

As described above, the information communication terminal 1 stores a received content 881 in the large-size flash memory 154 and, on the basis of an operation input entered by the user, the information communication terminal 1 is capable of reproducing and outputting the content 881, generating an aforementioned playlist including the content 881 or constructing a database including the content 881.

Then, the information communication terminal 1 is capable of generating push data including a portion of the received content 881 as data for introducing the content 881 and transmitting the push data to an apparatus owned by another user.

The component for executing control of processes to generate push data and transmit the push data from the information communication terminal 1 to another apparatus is the application processor 131. The application layer shown in FIG. 12 is a layer of application programs each installed as a program for controlling execution of processing corresponding to the program.

FIG. 43 is a functional block diagram showing functions, which are executed by the application processor 131 when an application program for controlling a process to generate push data and transmit the generated push data is activated. It is to be noted that the application processor 131 also has functions not shown in FIG. 43. That is to say, the application processor 131 makes use of the functions not shown in FIG. 43 in order to control other processing corresponding to the functions. The functions not shown in FIG. 43 and the processing corresponding to the functions are not described.

In order to control a process to generate push data and transmit the generated push data to another apparatus, as shown in the figure, the application processor 131 is provided with functions including an operation-input acquisition unit 901, an introduced-musical-data search unit 902, a registered-user acquisition unit 903, a broadcasted-information acquisition unit 904, a GUI generation/display control unit 905, a musical-data search unit 906, a content introduction data generation unit 907 and a content introduction data transmission control unit 908.

The operation-input acquisition unit 901 is a section for receiving a signal output by the input module 150 through the OS and a device driver as a signal representing an operation input entered by the user.

The introduced-musical-data search unit 902 is a section for searching the large-size flash memory 154 for a musical content to be introduced to another user by making use of generated push data. The introduced-musical-data search unit 902 searches the large-size flash memory 154 for a musical content in accordance with typically a search condition based on an operation input entered by the user or based on information received by the registered-user acquisition unit 903 or the broadcasted-information acquisition unit 904. The introduced-musical-data search unit 902 then provides the musical-data search unit 906 with the musical content found in the search process as a musical content to be introduced to the other user. In addition, if necessary, the introduced-musical-data search unit 902 also provides the GUI generation/display control unit 905 with information required for displaying a screen showing a message to the user to prompt the user to enter an operation input required in the process to search the large-size flash memory 154 for a musical content to be introduced to another user.

The registered-user acquisition unit 903 is a section for controlling a process to acquire information on a registered user. To be more specific, the registered-user acquisition unit 903 controls a control device through the OS in order to acquire information on a registered user from the large-size flash memory 154 by way of the audio processor 132. In this case, the registered user can be a registered user capable of carrying out a music streaming operation and a file transfer operation in typically the ad-hoc mode or a registered mode capable of carrying out communications in a infrastructure mode by execution of a plurality of application programs, which are used for carrying a communication process making use of the infrastructure mode.

It is desirable to include information on content-related favorites in information acquired by the registered-user acquisition unit 903 as information on a registered user.

Let us assume for example that information is exchanged between an information communication terminal 1 owned by a specific unregistered user and another information communication terminal 1 owned by another unregistered user in order to register the other user in the information communication terminal 1 owned by the specific user and register the specific user in the information communication terminal 1 owned by the other user. In this case, the user owning the other information communication terminal 1 serves as a communication partner of the specific user, whereas the exchanged information includes the information explained earlier by referring to FIG. 26 and the favorite information included in the information shown in FIG. 44. The favorite information is information on content-related favorites or, to be more specific, information including a genre liked by the user, a genre of interest to the user and artists liked by the user as shown in FIG. 44.

In addition, it is also desirable to include information on users registered for application programs such as the instant messenger and the communication application in the information on content-related favorites.

The broadcasted-information acquisition unit 904 is a section for controlling a device driver through the OS to control the radio communication module 148 to carry out a process of acquiring for example the information broadcasted in the ad-hoc mode as explained earlier by referring to FIG. 24.

It is also desirable to include information to be received by the broadcasted-information acquisition unit 904 as information on such registered users in the information on content-related favorites.

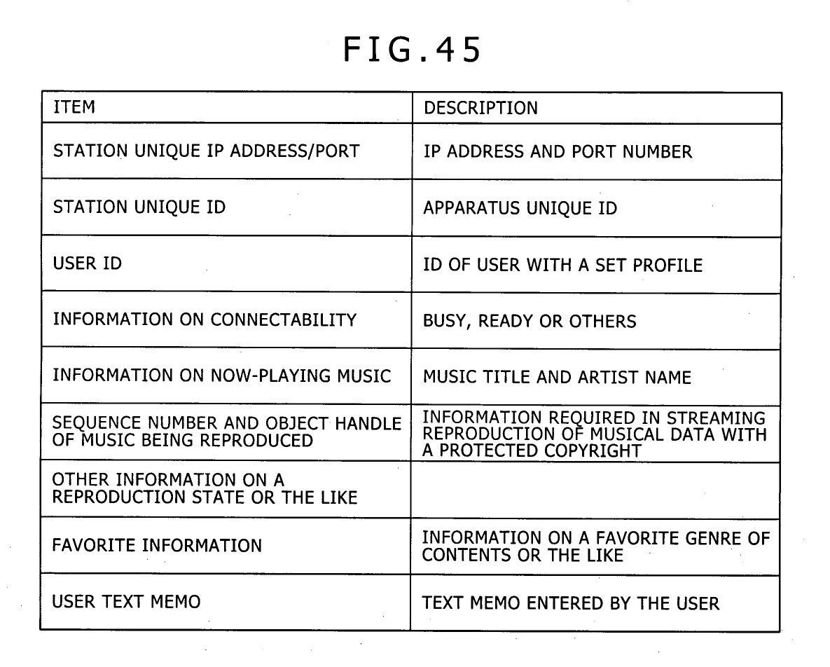

To be more specific, it is desirable to include, for example, not only the information as explained earlier by referring to FIG. 24, but also the content-related favorite information shown in FIG. 45 as information including a genre liked by the user, a genre of interest to the user and artists liked by the user in the information broadcasted in the ad-hoc mode.

The GUI generation/display control unit 905 is a section for receiving information required for displaying a display screen from the introduced-musical-data search unit 902, generating the data of an image to be displayed and controlling the display module 142 to display the image on the display unit 21. The information received from the introduced-musical-data search unit 902 is information required for displaying a display screen used for prompting the user to enter an operation input necessary for determining a musical content to be introduced to another user. The GUI generation/display control unit 905 generates the data of an image to be displayed on the basis of information required for generating the data of an image to be displayed and, if necessary, by making use of the graphics library. The GUI generation/display control unit 905 controls the display module 142 by controlling a device driver through the OS.

The musical-data search unit 906 is a section for controlling a device driver through the OS to control a process to read out a musical content from the large-size flash memory 154 on the basis of a detection result produced by the introduced-musical-data search unit 902 or on the basis of a signal representing an operation input entered by the user and supplying the musical content to the content introduction data generation unit 907.

The content introduction data generation unit 907 is configured to include functions such as a musical data cutout processing unit 911, a fringe data extraction unit 912, an introducer-related data generation unit 913, a metadata generation unit 914, a data conversion unit 915 and a push-data generation unit 916.

The musical data cutout processing unit 911 is a section for cutting out a portion of the musical data 892 included in a content 881 explained before by referring to FIG. 42 on the basis of a music cutout position information included in the fringe data 891 or on the basis of a signal representing an operation input entered by the user.

The fringe data extraction unit 912 is a section for extracting a portion of the fringe data 891 included in a content 881 explained before by referring to FIG. 42 as information to be added to push data. The information added to push data is metadata to be described later.

The introducer-related data generation unit 913 is a section for extracting information on a user and information on an apparatus information from the flash memory 146, the large-size flash memory 154 or the flash memory 156 as information to be added to push data. The information on an apparatus is information on an information communication terminal 1 generating push data and the information on a user is information on a user owning the information communication terminal 1 generating push data. As explained above, the information added to push data is metadata to be described later.

The metadata generation unit 914 is a section for generating the aforementioned metadata to be added to push data on the basis of data extracted by the fringe data extraction unit 912 and data extracted by the introducer-related data generation unit 913. In some cases, the format of a portion of the metadata is converted into another format in a process carried out by the data conversion unit 915.

The data conversion unit 915 is a section for converting the format of partial information of the metadata extracted from fringe data into a predetermined data format by adoption of a data conversion method. The partial information of the metadata is typically a text introducing an image to be displayed during a reproduction process or introducing a musical content. The partial information of the metadata can also be a text representing the lyrics of the musical content.

The push-data generation unit 916 is a section for generating push data of a musical data 892 on the basis of a portion extracted by the musical data cutout processing unit 911 as a potion of the musical data 892 included in a content 881 and on the basis of metadata generated by the metadata generation unit 914 as data to be added to the push data, and supplying the generated push data to the content introduction data transmission control unit 908.

The content introduction data transmission control unit 908 is a section for controlling a process to transmit push data generated by the push-data generation unit 916 to other apparatus.

FIG. 46 is an explanatory diagram showing the structure of push data generated by the push-data generation unit 916 and transmitted to another apparatus in accordance with control executed by the content introduction data transmission control unit 908.

As shown in the figure, the push data 921 includes fringe extraction data 931, introducer-related data 932 and cut-out musical data 933. The fringe extraction data 931 and the introducer-related data 932 are the so-called metadata.

The fringe extraction data 931 is data extracted by the fringe data extraction unit 912 from the fringe data 891 included in a content 881 explained earlier by referring to FIG. 42. Typically, the fringe extraction data 931 of a musical content includes information on the content 881 or information on the purchasing of the content 881, information on content-related favorites and information on holding of the push data 921. The information on the content 881 or the information on the purchasing of the content 881 includes the title of the musical content 881, the ID of the musical content 881, the name of an artist for the musical content 881, the sale date of the musical content 881, the name of the content sale server, the ID of the content sale server, the name of the distributor of the musical content, the ID of the distributor of the musical content, the name of content salable server #1, the ID of content salable server #1, the content price at content salable server #1, the name of content salable server #2, the ID of content salable server #2 and the content price at content salable server #2. On the other hand, the information on content-related favorites and the information on holding of the push data 921 include the name of the genre of the musical content 881, the ID of the genre of the musical content 881 and, a period during which the push data 921 can be held or a limit till which the push data 921 can be held and other information.

The introducer-related data 932 of a musical content is data structured on the basis of data extracted by the introducer-related data generation unit 913 and on the basis of data obtained as a result of a conversion process carried out by the data conversion unit 915. For example, the introducer-related data 932 includes the ID of a user introducing the musical content 881, the ID of an apparatus serving as the distributor of the musical content 881, a plurality of pieces of processed image data, music introduction information (or an abstract), information specifying the content sale server, a date on which the push data 921 was supplied and a message to be sent to a user, to which the content user introduced the musical content 881. The pieces of processed image data include processed image data #1, processed image data #2, processed image data #3 and so on.

Receiving push data 921, the information communication terminal 1 or the personal computer 13 is capable of storing the push data 921 in an internal memory such as the large-size flash memory 154. When the user owning the information communication terminal 1 or the personal computer 13 wants to purchase a musical content introduced in the push data 921 by entering an operation input specifying the musical content, the information communication terminal 1 or the personal computer 13 is capable of reproducing and outputting the sound of the cut-out musical data 933 of the received push data 921 in accordance with the operation input. In addition, the information communication terminal 1 or the personal computer 13 is also capable of displaying metadata and the aforementioned message sent to the user, to which the content user introduced the musical content, that is, the user owning the information communication terminal 1 or the personal computer 13. Structured to compose of the fringe extraction data 931 and the introducer-related data 932, the metadata includes the title of the musical content 881, the name of an artist for the musical content 881, the name of a content salable server, the content price at the content salable server and a period during which the push data 921 can be held or a limit till which the push data 921 can be held.

Then, the application processor 131 employed in the information communication terminal 1 or the personal computer 13 typically displays a content purchasing button on the display unit 21 as a button to be pressed by a user owning the information communication terminal 1 or the personal computer 13, for example, when the user makes a request to purchase a musical content including the cut-out musical data 933 being reproduced and output by the information communication terminal 1 or the personal computer 13. As the user presses the content purchasing button in order to make a request to purchase the musical content including the cut-out musical data 933 reproduced and output by the information communication terminal 1, the information communication terminal 1 or the personal computer 13 makes an access to the content introduction service server 12-1, the content sale server 12-2 or the content distribution server 12-3 in a process of transmitting the ID of the musical content to be purchased and information on the content introducer to the server 12 by way of the network 11. The information on the content introducer can be typically the ID of the information communication terminal 1 or the personal computer 13, or the ID of the user owning the information communication terminal 1 or the personal computer 13.

Receiving the request to purchase a musical content from the user, the content introduction service server 12-1, the content sale server 12-2 or the content distribution server 12-3 exchanges information required in a process to purchase the musical content with the information communication terminal 1 or the personal computer 13 through the network 11 in order to carry out the process to purchase the musical content. In addition, if the server 12 exchanging the information required in the process to purchase the musical content is the content sale server 12-2 or the content distribution server 12-3, the server 12 supplies information indicating the purchasing of the musical content and information on the content introducer to the content introduction service server 12-1. As described earlier, the information on the content introducer can be typically the ID of the information communication terminal 1 or the personal computer 13, or the ID of the user owning the information communication terminal 1 or the personal computer 13.

On the basis of the supplied information indicating the purchasing of the musical content and the information on the content introducer, the content introduction service server 12-1 gives points of content-introduction appreciation to the content introducer, newly generates information for further promoting the sales of another musical content and supplies the promotional information to the user.

It is possible to provide a configuration in which the information communication terminal 1 or personal computer 13 receiving push data 921 normally sets in advance the upper limit of a push-data count, which is the number of pieces of push data 921, or the upper limit of the storage capacity of an internal memory used for storing the pieces of push data 921. A typical internal memory used for storing the pieces of push data 921 is the large-size flash memory 154. If many pieces of push data 921 have been stored in the internal memory so that the upper limit of the push-data count or the upper limit of the storage capacity has been reached, the information communication terminal 1 or the personal computer 13 typically deletes the least recent push data 921 from the internal memory or turns down the reception of the new push data 921. By having such a configuration, it is possible to prevent the information communication terminal 1 or the personal computer 13 from receiving pieces of push data 921, storing the push data 921 in the internal memory without a limit and from wastefully exhausting the internal memory, which has a limited storage capacity. As described above, a typical internal memory used for storing the pieces of push data 921 is the large-size flash memory 154.

In addition, it is also possible to provide a configuration in which the information communication terminal 1 or the personal computer 13 normally sets in advance the upper limit of the push-data count or the upper limit of the storage capacity of an internal memory used for storing pieces of push data 921 typically for every category of content or every sender of push data 921. By having such a configuration, it is possible not only to prevent the information communication terminal 1 or the personal computer 13 from receiving pieces of push data 921, storing the push data 921 in the internal memory without a limit and wastefully exhausting the internal memory, which has a limited storage capacity, but also to store push data 921 in the internal memory on a priority basis. For example, the user can set a large upper limit for a content category of interest to the user or for the number of pieces of content introduction push data received from another user having similar favorite contents.

In addition, the information communication terminal 1 or the personal computer 13 is capable of ignoring a sender of push data 921 that is not to be recorded in an internal memory by putting such a sender on a list. For example, a specific user does not record push data 921 received from an apparatus owned by another user but, instead, deletes the push data 921 because the push data 921 introduces a content, which is not a favorite with the specific user. By not recording certain push data 921 in this way, the user owning the information communication terminal 1 or the personal computer 13 can be prevented from wastefully exhausting the internal memory, which has a limited storage capacity. As described above, a typical internal memory used for storing the pieces of push data 921 is the large-size flash memory 154.

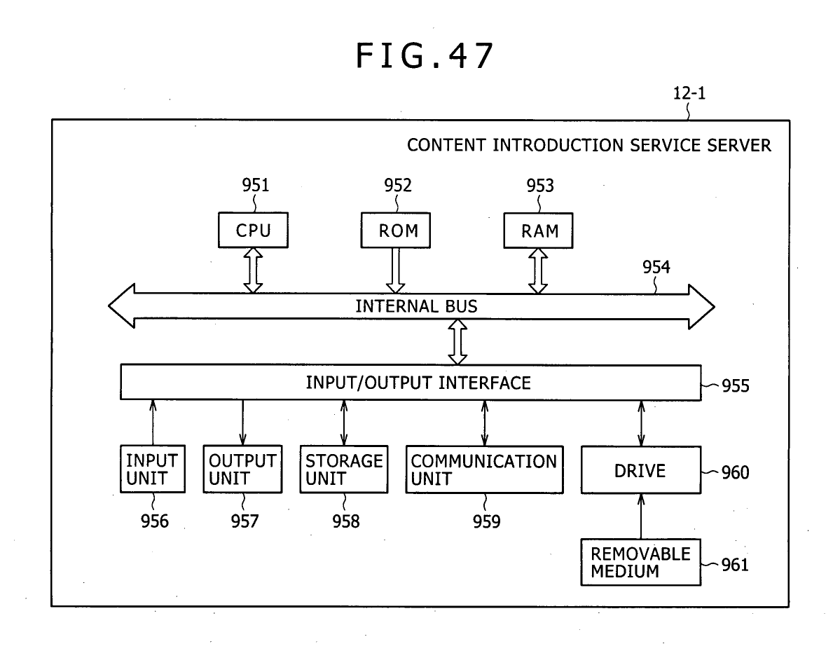

FIG. 47 is a block diagram showing the configuration of the content introduction service server 12-1.

A CPU (Central Processing Unit) 951 employed in the content introduction service server 12-1 as shown in the figure is a component for carrying out various kinds of processing by execution of programs stored in a ROM (Read Only Memory) 952 and/or programs loaded from a storage unit 958 into a RAM (Random Access Memory) 953. The RAM 953 also serves as a memory used for properly storing data required by the CPU 951 in the execution of the processing.

The CPU 951, the ROM 952 and the RAM 953 are connected to each other by making use of an internal bus 954. The internal bus 954 is also connected to an input/output interface 955.

The input/output interface 955 is connected to an input unit 956, an output unit 957, the aforementioned storage unit 958 and a communication unit 959. The input unit 956 includes a keyboard and a mouse whereas the output unit 957 includes a display unit and a speaker. The storage unit 958 is typically a hard disk whereas the communication unit 959 includes a modem and a terminal adaptor. The communication unit 959 is a component for carrying out communications with other apparatus through the network 11 such as the Internet.

If necessary, the input/output interface 955 is also connected to a drive 960, on which a removable recording medium 961 is mounted so that data can be exchanged between the removable recording medium 961 and the content introduction service server 12-1 by way of the drive 960. Examples of the removable recording medium 961 are a magnetic disk, an optical disk, a magneto-optical disk and a semiconductor memory.

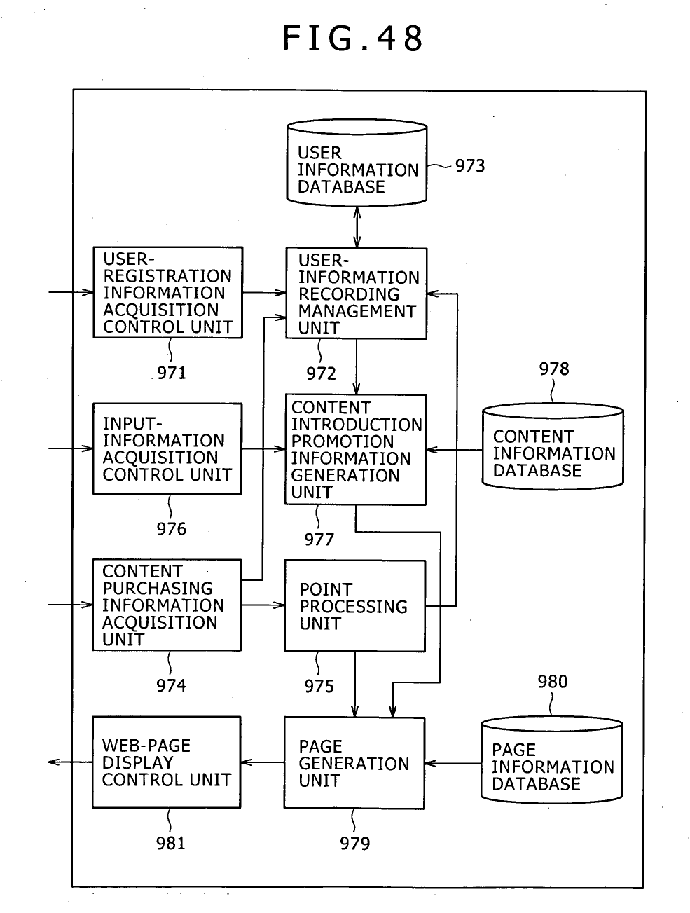

FIG. 48 is an explanatory functional block diagram showing processing carried out by the CPU 951 employed in the content introduction service server 12-1 shown in FIG. 47.

As shown in FIG. 48, the content introduction service server 12-1 includes a user-registration information acquisition control unit 971, a user-information recording management unit 972, a user-information database 973, a content-purchasing information acquisition unit 974, a point processing unit 975, an input-information acquisition control unit 976, a content-introduction promotion information generation unit 977, a content-introduction database 978, a page generation unit 979, a page-information database 980 and a web-page display control unit 981. The user-registration information acquisition control unit 971 is an element for receiving user registration information from an information communication terminal 1 or a personal computer 13 through the network 11 and supplies the information to the user-information recording management unit 972.

The user registration information is various kinds of information including a user ID, an apparatus ID, a user name, information on content-related favorites and information on a member belonging to a content introduction group to be described later.

The user-information recording management unit 972 is a functional element for managing the user registration information received by the user-registration information acquisition control unit 971. The user-information recording management unit 972 also records the user registration information received by the user-registration information acquisition control unit 971, content purchasing information acquired by the content-purchasing information acquisition unit 974 and content introduction point information processed by the point processing unit 975 in the user-information database 973 by adding them to already recorded user information. The content introduction point information to be described later is information on points of content-introduction appreciation. The user-information recording management unit 972 also reads out information from the user-information database 973 and supplies the information to the content-introduction promotion information generation unit 977.

The user-information database 973 is a functional element used for storing user registration information, which is acquired by the user-registration information acquisition control unit 971, under control executed by the user-information recording management unit 972. In addition, the user-information database 973 is also used for storing content-purchasing information acquired by the content-purchasing information acquisition unit 954 and content introduction point information processed by the point processing unit 975 for each registered user as will be described later.

Content-related favorite information is information on favorites related to contents. The content-related favorite information for each registered user may be disclosed to all registered users or disclosed only to predetermined registered users, who are permitted to see the content-related favorite information disclosed by the registered user associated with the disclosed information. In addition, a plurality of registered users set to disclose their content-related favorite information to each other can each be included in a content introduction group as a member belonging to the group.

That is to say, the user-information database 973 can also be used for storing information on disclosure of content-related favorite information of each registered user and information on the content introduction group.

The content-purchasing information acquisition unit 954 acquires information from the content introduction service server 12-1, the content sale server 12-2 or the content distribution server 12-3, supplying the acquired information to the user-information recording management unit 972 and the point processing unit 975 when a registered user purchases a content 881 explained earlier by referring to FIG. 42. The acquired information includes information on the purchased content 881 and information on a user introducing the content 881. The information on the purchased content 881 includes the ID and category of the content 881 whereas the information on the user introducing the content 881 includes the user ID of the content introducer and the apparatus ID of the apparatus owned by the introducer.

The point processing unit 975 is a functional element for computing the number of content-introduction appreciation points on the basis of information acquired by the content-purchasing information acquisition unit 974 as information on a content 881 purchased by one of registered users and information on a user introducing the content 881. As described above, the information on the purchased content 881 includes the ID and category of the content 881 whereas the information on the user introducing the content 881 includes the user ID of the content introducer and the apparatus ID of the apparatus owned by the introducer.

The content-introduction appreciation points are points to be given to a user introducing a content in order to appreciate efforts made by the content introducer to create push data of the content and transmit the push data to another user as data used for introducing the content to the other user, who then purchases the content as a result of the content introduction. The user introducing a content thus also serves as a sender sending the push data created for the content to the other user. It is desirable to provide a configuration in which the user introducing a content to another user can accumulate content-introduction appreciation points to be exchanged with a predetermined service such as a service of offering a discounted price of a content purchased next time.

With a mechanism for giving content-introduction appreciation points to a user introducing a content, in an effort to introduce a purchased content to a number of other users, a user purchasing the content will aggressively send push data created for the content to friends or the like in order to get content-introduction appreciation points. The effort made by the user purchasing the content to send push data created for the content to friends or the like is an effort to promote sales of the content.

The input-information acquisition control unit 976 is a functional element for receiving a request for information for promoting introduction of a content from the information communication terminal 1 or personal computer 13 owned by a registered user by way of the network 11 and supplying the request to the content-introduction promotion information generation unit 977.

The content-introduction promotion information generation unit 977 is a functional element for generating information for promoting introduction of a content for a user purchasing the content or a user making a request for the information for promoting introduction of the content and supplying the generated information to the page generation unit 979. The content-introduction promotion information generation unit 977 generates information for promoting introduction of a content on the basis of user information stored in the user-information database 973 and supplied to the content-introduction promotion information generation unit 977 by way of the user-information recording management unit 972 and content information stored in the content-introduction database 978.

The information for promoting introduction of a content is information generated on the basis of predetermined particular registered users, favorite contents of the predetermined particular registered users or other predetermined specific registered users. The predetermined particular registered users are each a user who has purchased a number of contents each introduced by a user introducing the content. The predetermined particular registered users are each typically a member pertaining to a content introduction group to be described later. The other predetermined specific registered users are each a user holding a number of points appreciating introduction of contents pertaining to categories including many contents purchased by the specific users. The predetermined specific registered users are also each typically a member pertaining to the content introduction group mentioned above. A user seeing the information for promoting introduction of a content is capable of generating push data matching information on a favorite content at a high priority level and transmitting the push data to registered users purchasing a number of contents introduced by the user seeing the content introduction promotion information and users each expected to have a similar favorite content. The users each expected to have a similar favorite content are each a registered user holding a number of points appreciating introduction of contents pertaining to categories including many contents purchased by the user seeing the content introduction promotion information.

By providing a mechanism for generating information for promoting introduction of a content and transmitting the information to every user in this way, a content can be introduced more effectively so that sales of the content can be further promoted.

The content-introduction database 978 is a database used for storing information on content-related favorites of registered users. The information on content-related favorites is based on information on contents purchased from the content introduction service server 12-1 itself, the content sale server 12-2 and the content distribution server 12-3 and information on users purchasing the contents. The information on purchased contents is typically information on categories and favorites.

The page generation unit 979 is a functional element for generating a web page, which has a variety of templates and shows various kinds of image data, and supplying the web page to the web-page display control unit 981. As will be described below, the templates and the image data of a variety of kinds are information stored in the page-information database 980. The generated web page is typically a screen to be displayed for notifying the user of various kinds of information used for promoting introduction of a content. Such a web page is generated on the basis of information received from the content-introduction promotion information generation unit 977. The generated web page can also be a screen for notifying the user of the number of content-introduction appreciation points given to the user. Such a web page is generated on the basis of information received from the point processing unit 975.

The page-information database 980 is a database used for storing templates of the web page and various kinds of image data used for creating a web page.

The web-page display control unit 981 is a functional element for providing a web page generated by the page generation unit 979 to users by way of the network 11.

As described above, the content introduction service server 12-1 has functions to acquire information on purchasing of a content and information on a user introducing the content and store these pieces of information in a memory. In addition, the content introduction service server 12-1 also has functions to give points of content-introduction appreciation to a user introducing a content, generate information for promoting introduction of a new content and provide the generated information to users.

By referring to a flowchart shown in FIG. 49, the following description explains processing to exchange contents in the content providing system.

As shown in the figure, the flowchart begins with a step S1 at which the content distribution server 12-3 carries out a process to generate a content to be distributed. The generated content to be distributed is the content 881 explained before by referring to FIG. 42. The content 881 is sold to users owning an information communication terminal 1 or a personal computer 13 by the content distribution server 12-3 or the content sale server 12-2 by exchanging predetermined information between the content distribution server 12-3 or the content sale server 12-2 and the information communication terminal 1 or the personal computer 13 respectively through the network 11.

Then, at the next step S2, an apparatus owned by a first user makes an access to the content distribution server 12-3 or the content sale server 12-2 to carry out a process to purchase the content 881 explained before by referring to FIG. 42. The apparatus owned by the first user is the information communication terminal 1 or the personal computer 13.

To put it concretely, the information communication terminal 1 or the personal computer 13 transmits information on a content 881 to be purchased to the content sale server 12-2 or the content distribution server 12-3. If the content 881 to be purchased is a content introduced by a user introducing the content through push data 921 provided by the introducer of the content 881, the information communication terminal 1 or the personal computer 13 also transmits information on the introducer of the content 881 to the content sale server 12-2 or the content distribution server 12-3. Then, after information on charging of the price of the content to be purchased to the user owning the information communication terminal 1 or the personal computer 13 and information on payment of the price are exchanged between the information communication terminal 1 or the personal computer 13 and the content sale server 12-2 or the content distribution server 12-3, the content sale server 12-2 or the content distribution server 12-3 transmits the purchased content 881 to the information communication terminal 1 or the personal computer 13 by way of the network 11.

Subsequently, at the next step S3, the content introduction service server 13-1 carries out a process to record a history of content purchasing. To put it concretely, the content introduction service server 13-1 acquires information on the purchased content 881 and information on the user purchasing the content 881 from the content distribution server 12-3 or the content sale server 12-2 by way of the network 11. In addition, the content introduction service server 13-1 also acquires information on a user introducing the content 881 from the content distribution server 12-3 or the content sale server 12-2 by way of the network 11 if the purchased content 881 is a content introduced by the content introducer through push 921 data provided by the introducer.

Then, at the next step S4, the apparatus, that is, the information communication terminal 1 or the personal computer 13, owned by the first user generates push data 921 explained earlier by referring to FIG. 46 as data used for introducing the purchased content 881 to other users and transmits the push data 921 to an apparatus owned by a second user. The apparatus owned by the second user is also an information communication terminal 1 or a personal computer 13.

Subsequently, at the next step S5, the apparatus owned by the second user as an apparatus receiving the push data 921 carries out a process to store the push data 921 in an internal memory of its own if necessary.

Then, at the next step S6, the apparatus owned by second user makes an access to the content distribution server 12-2 or the content sale server 12-3 to carry out processes to purchase the introduced content 881 and transmit information on the introducer of the content 881 to the content distribution server 12-2 or the content sale server 12-3. In addition, the content selling server carries out a process to transmit information on the purchased content, information on a user purchasing the content and information on a user content introducing the content 881 to the content introduction service server 12-1. In this case, the content selling server is the content distribution server 12-2 or the content sale server 12-3, the user purchasing the content 881 is the second user and the user content introducing the content 881 is the first user.

Subsequently, at the next step S7, the content introduction service server 12-1 carries out a process to compute content-introduction appreciation points to be given to the introducer of the content 881.

Then, at the next step S8, the content introduction service server 12-1 carries out a process to record a history of content introduction and content purchasing for the content 881.

Subsequently, at the next step S9, the content introduction service server 12-1 carries out processes to generate information for promoting content distribution and disclose the information to users if necessary.

By carrying out the processing described above, each content can be introduced to a number of users and, hence, sales of the content can be promoted.

In the processing explained above by referring to the flowchart shown in FIG. 49, the content distribution server 12-2 or the content sale server 12-3 serves as the content selling server. It is needless to say that the content introduction service server 12-1 is also capable of carrying out the process to sell a content to a user.

By referring to a flowchart shown in FIG. 50, the following description explains the processing to generate and transmit content introduction data corresponding to the step S4 of the flowchart shown in FIG. 49. As described above, the processing of the step S4 is processing carried out by an information communication terminal 1 or personal computer 13 owned by the first user purchasing a content 881.

In the following description, it is assumed that the processing is carried out by an information communication terminal 1, which has the functions explained before by referring to FIG. 43.

The flowchart shown in FIG. 50 begins with a step S21 at which the operation-input acquisition unit 901 produces a result of determination as to whether or not an operation input specifying the destination of transmission of push data 921 for introducing a content 881 has been received from the user on the basis of a signal received from the input module 150 as a signal representing the operation input entered by the user. If the result of the determination indicates that an operation input specifying the destination of transmission of push data 921 for introducing a content 881 has not been received from the user, the flow of the processing goes back to the step S21 at which the process of determination is repeated. As a matter of fact, the process of determination of the step is carried out repeatedly till the result of the determination indicates that an operation input specifying the destination of transmission of push data 921 for introducing a content 881 has been received from the user.

As the determination result produced at the step S21 indicates that an operation input specifying the destination of transmission of push data 921 for introducing a content 881 has been received from the user, the flow of the processing goes on to a step S22 at which the operation-input acquisition unit 901 supplies information on the destination of transmission of push data 921 to the introduced-musical-data search unit 902. Then, the introduced-musical-data search unit 902 produces a result of determination as to whether or not a content 881 to be introduced by making use of the push data 921 to be transmitted to a user specified in the operation input as the destination of transmission of the push data 921 is to be selected automatically.

Even if a content 881 to be introduced by making use of the push data 921 to be transmitted to another user specified in the operation input as the destination of transmission of the push data 921 is to be selected by the user, the content 881 to be introduced by making use of the push data 921 can be selected automatically on the basis of favorite information included in broadcasted information or information on registered users.

If the determination result produced at the step S22 indicates that a content 881 to be introduced by making use of the push data 921 to be transmitted to a user specified in the operation input as the destination of transmission of the push data 921 is to be selected automatically, the flow of the processing goes on to a step S26.

If the determination result produced at the step S22 indicates that a content 881 to be introduced by making use of the push data 921 is not to be selected automatically, that is, if the determination result produced at the step S22 indicates that a content to be introduced by making use of the push data 921 is to be specified by the user, on the other hand, the flow of the processing goes on to a step S23 at which the operation-input acquisition unit 901 produces a result of determination as to whether or not the user has entered an operation input specifying a content 881 to be introduced. If the determination result produced at the step S23 indicates that the user has not entered an operation input specifying a content 881 to be introduced, the flow of the processing goes back to the step S23 at which the process of determination is repeated. As a matter of fact, the process of determination of the step S23 is carried out repeatedly till the result of the determination indicates that the user has entered an operation input specifying a content 881 to be introduced.

As the determination result produced at the step S23 indicates that the user has entered an operation input specifying a content 881 to be introduced, the flow of the processing goes on to a step S24 at which the operation-input acquisition unit 901 supplies information specifying the content 881 to the introduced-musical-data search unit 902. The introduced-musical-data search unit 902 notifies the musical-data search unit 906 of information on the specified content 881. The musical-data search unit 906 then reads out the specified content 881 from the large-size flash memory 154 through the audio processor 132 and refers to information indicating whether or not the specified content 881 allows push data 921 included in the fringe data 891 of the content 881 to be created for the content 881 in order to produce a result of determination as to whether or not the specified content 881 allows creation of the push data 921.

If the determination result produced at the step S24 indicates that the specified content 881 allows creation of the push data 921, the flow of the processing goes on to a step S34 to be described later. If the determination result produced at the step S24 indicates that the specified content 881 does not allow creation of the push data 921, on the other hand, the flow of the processing goes on to a step S25 at which the GUI generation/display control unit 905 generates data of a display screen showing a message or data of a dialog box showing the message and controls a process to display the screen or the dialog box on the display unit 21. The message notifies the user that the specified content 881 prohibits creation of push data 921. Finally, the processing is ended.

As described above, if the determination result produced at the step S22 indicates that a content 881 to be introduced by making use of the push data 921 to be transmitted to a user specified in the operation input as the destination of transmission of the push data 921 is to be selected automatically, the flow of the processing goes on to the aforementioned step S26 at which the introduced-musical-data search unit 902 produces a result of determination as to whether or not the present communication mode is the ad-hoc mode and whether or not the specified recipient of the push data 921 is a registered user capable of communication in the ad-hoc mode.

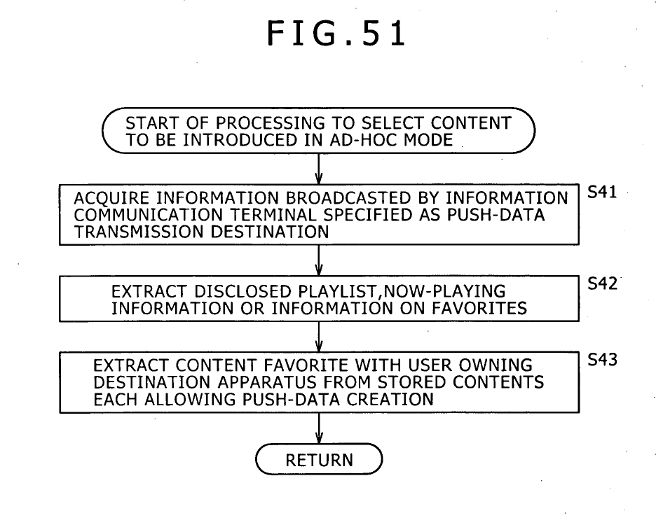

If the determination result produced at the step S26 indicates that the present communication mode is the ad-hoc mode and the specified recipient of the push data 921 is a registered user capable of communication in the ad-hoc mode, the flow of the processing goes on to a step S27 to carry out processing to select a content 881 to be introduced in the ad-hoc mode as will be described later by referring to a flowchart shown in FIG. 51. Then, the flow of the processing goes on to a step S31 to be described later.

If the determination result produced at the step S26 indicates that the present communication mode is not the ad-hoc mode or the present communication mode is the ad-hoc mode but the specified recipient of the push data 921 is not a registered user capable of communication in the ad-hoc mode, on the other hand, the flow of the processing goes on to a step S28 at which the introduced-musical-data search unit 902 produces a result of determination as to whether or not the specified recipient of the push data 921 is a user registered for an application to be executed in the infrastructure mode.

If the determination result produced at the step S28 indicates that the specified recipient of the push data 921 is not a user registered for an application to be executed in the infrastructure mode either, the flow of the processing goes on to a step S29 at which the GUI generation/display control unit 905 generates data of a display screen showing a message or data of a dialog box showing the message and controls a process to display the screen or the dialog box on the display unit 21. The message notifies the user that the specified push-data recipient is an unregistered user or the push data cannot be transmitted to the recipient. Finally, the processing is ended.

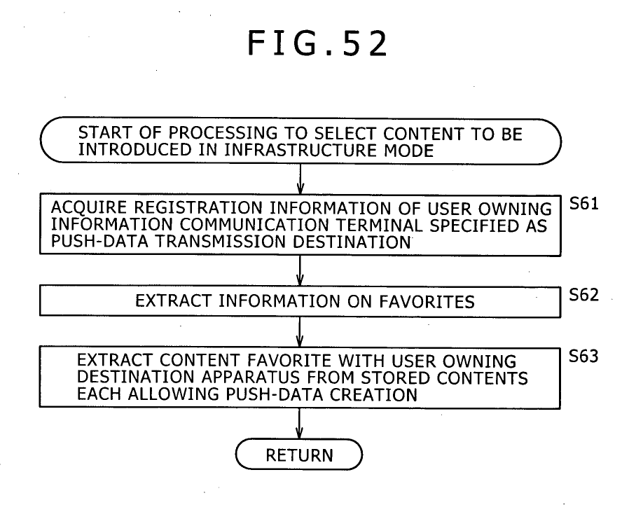

If the determination result produced at the step S28 indicates that the specified recipient of the push data 921 is a user registered for an application to be executed in the infrastructure mode, on the other hand, the flow of the processing goes on to a step S30 to carry out processing to select a content 881 to be introduced in the infrastructure mode as will be described later by referring to a flowchart shown in FIG. 52.

After the process carried out at the step S27 or S30 is completed, the flow of the processing goes on to the aforementioned step S31 at which the GUI generation/display control unit 905 produces a result of determination as to whether or not a list of contents automatically selected in a process carried out at the step S27 or S30 is to be displayed. If the determination result produced at the step S31 indicates that a list of automatically selected contents is not to be displayed, that is, if a plurality of contents have been selected, the flow of the processing goes on to a step S34 to be described later. This is because it is assumed that a content 881 to be introduced by push data is determined to be a content to be selected at random or on the basis of a predetermined selection criterion and the selection of the content 881 is to be confirmed.

If the determination result produced at the step S31 indicates that a list of automatically selected contents is to be displayed, on the other hand, the flow of the processing goes on to a step S32 at which the GUI generation/display control unit 905 generates data of a display screen showing the list of contents automatically selected in a process carried out at the step S27 or S30 or data of a dialog box showing the list and controls a process to display the screen or the dialog box on the display unit 21.

Then, at the next step S33, the operation-input acquisition unit 901 produces a result of determination as to whether or not an operation input specifying a content 881 to be introduced by making use of the push data 921 from the list of automatically selected contents has been received from the user on the basis of a signal received from the input module 150 as a signal representing the operation input entered by the user. If the determination result produced at the step S33 indicates that an operation input specifying a content 881 to be introduced by making use of the push data 921 from the list of automatically selected contents has not been received from the user, the flow of the processing goes back to the step S32 to repeat the processes of the steps S32 and S33.

If the determination result produced at the step S33 indicates that an operation input specifying a content 881 to be introduced by making use of the push data 921 from the list of automatically selected contents has been received from the user, on the other hand, the flow of the processing goes on to the aforementioned step S34 to carry out content introduction data generation processing to be described later by referring to a flowchart shown in FIG. 53.

Then, at the next step S35, the content introduction data transmission control unit 908 controls the radio communication module 148 to transmit the generated content introduction data to the specified recipient. The generated content introduction data is the push data 921 explained earlier by referring to FIG. 46.

Subsequently, at the next step S36, the content introduction data transmission control unit 908 produces a result of determination as to whether or not an apparatus serving as the specified recipient has rejected the generated content introduction data transmitted to the recipient at the step S35. As described above, the generated content introduction data is the push data 921 explained earlier by referring to FIG. 46. If the determination result produced at the step S36 indicates that the apparatus serving as the specified recipient did not reject the generated content introduction data, the processing is ended.

If the determination result produced at the step S36 indicates that the apparatus serving as the specified recipient has rejected the generated content introduction data, on the other hand, the flow of the processing goes on to a step S37 at which the GUI generation/display control unit 905 generates data of a screen or data of a dialog box and controls a process to display the screen or the dialog box on the display unit 21 in order to show a message notifying the user that the apparatus serving as the specified recipient has rejected the generated content introduction data. Finally, the processing is ended.

By carrying out the processing described above, push data 921 explained earlier by referring to FIG. 46 is generated as data for introducing a content 881 and transmitted to an apparatus owned by a specified recipient of the push data 921.

By referring to a flowchart shown in FIG. 51, the following description explains processing carried out at the step S27 of the flowchart shown in FIG. 50 to select a content 881 to be introduced in the ad-hoc mode.

The flowchart shown in FIG. 51 begins with a step S41 at which the broadcasted-information acquisition unit 904 acquires information broadcasted by an information communication terminal 1 specified as the destination of transmission of push data 921 and supplies the information to the introduced-musical-data search unit 902.

Then, at the next step S42, the introduced-musical-data search unit 902 extracts information usable for determination of a content 881 to be introduced to a user owning the information communication terminal 1 specified as the destination of transmission of the push data 921 from the broadcasted information received from the broadcasted-information acquisition unit 904. The extracted information is typically a disclosed playlist of the user owning the information communication terminal 1 specified as the destination of transmission of the push data 921, now-playing information indicating a content being reproduced in the information communication terminal 1 or information on favorites with the user.

Subsequently, at the next step S43, the introduced-musical-data search unit 902 detects information required for specifying a content 881 regarded as a content 881 serving as a favorite with the user owning the information communication terminal 1 specified as the destination of transmission of the push data 921 from the information extracted at the step S42 and supplies the detected information to the musical-data search unit 906. Then, the musical-data search unit 906 extracts the content 881 serving as a favorite with the user owning the information communication terminal 1 specified as the destination of transmission of the push data 921 through the audio processor 132 from contents 881 each stored in the large-size flash memory 154 as a content 881 allowing its push data 921 to be created. As described above, the information extracted at the step S42 is typically a disclosed playlist of the user owning the information communication terminal 1 specified as the destination of transmission of the push data 921, now-playing information indicating a content being reproduced in the information communication terminal 1 or information on favorites with the user. The flow of the processing then goes back to the step S31 of the flowchart shown in FIG. 50 through the step S27 of the same flowchart.

By carrying out the processing described above, it is possible to extract a content 881 regarded as a content 881 serving as a favorite with the user owning the information communication terminal 1 specified as the destination of transmission of the push data 921 on the basis of information broadcasted in the ad-hoc mode from contents 881 each stored in the large-size flash memory 154 as a content 881 allowing its push data 921 to be created.

By referring to a flowchart shown in FIG. 52, the following description explains processing carried out at the step S30 of the flowchart shown in FIG. 50 to select a content to be introduced in the infrastructure mode.

The flowchart shown in FIG. 52 begins with a step S61 at which the registered-user acquisition unit 903 acquires registration information of a user owning an information communication terminal 1 specified as the destination of transmission of push data 921 and supplies the information to the introduced-musical-data search unit 902.

Then, at the next step S62, the introduced-musical-data search unit 902 extracts information on favorites with the user owning the information communication terminal 1 specified as the destination of transmission of the push data 921 from the user registration information received from the registered-user acquisition unit 903 at the step S61.

Subsequently, at the next step S63, the introduced-musical-data search unit 902 detects information required for specifying a content 881 regarded as a content 881 serving as a favorite with the user owning the information communication terminal 1 specified as the destination of transmission of the push data 921 from the information extracted at the step S62 and supplies the detected information to the musical-data search unit 906. Then, the musical-data search unit 906 extracts the content 881 serving as a favorite with the user owning the information communication terminal 1 specified as the destination of transmission of the push data 921 from contents 881 each stored in the large-size flash memory 154 as a content 881 allowing its push data 921 to be created. The flow of the processing then goes back to the step S31 of the flowchart shown in FIG. 50 through the step S30 of the same flowchart.

By carrying out the processing described above, it is possible to extract a content 881 regarded as a content 881 serving as a favorite with the user owning the information communication terminal 1 specified as the destination of transmission of the push data 921 on the basis of user registration information from contents 881 each stored in the large-size flash memory 154 as a content 881 allowing its push data 921 to be created.

By referring to a flowchart shown in FIG. 53, the following description explains processing carried out at the step S34 of the flowchart shown in FIG. 50 to generate data for introducing a content 881.

The flowchart shown in FIG. 53 begins with a step S81 at which the musical-data search unit 906 searches contents 881 stored in the large-size flash memory 154 through the audio processor 132 for a specific one to be introduced to another user owning the information communication terminal 1 specified as the destination of transmission of the push data 921 of the specific content 881, and supplies the specific content 881 found in the search process to the content introduction data generation unit 907. The specific content 881 is a content 881 regarded as a content 881 serving as a favorite with the other user owning the information communication terminal 1 specified as the destination of transmission of the push data 921 generated on the basis of the specific content 1. The specific content 1 matches the content 881 selected in the processing represented by the flowchart shown in FIG. 51 as a content 881 to be introduced in the ad-hoc mode or the content 881 selected in the processing represented by the flowchart shown in FIG. 52 as a content 881 to be introduced in the infrastructure mode, or matches a content 881 specified by the user owning this information communication terminal 1 at the process carried out at the step S33 of the flowchart shown in FIG. 50.

Then, at the next step S82, on the basis of information included in the fringe data 891 of the content 881 found in the search process carried out at the step S81, the musical data cutout processing unit 911 produces a result of determination as to whether or not the cutout position of the musical data 892 of the content 881 is to be set by the user. The cutout position of the musical data 892 is used for generating cut-out musical data 933 to be included in the push data 921.

If the determination result produced at the step S82 indicates that the cutout position of the musical data 892 of the content 881 is to be set by the user, the flow of the processing goes on to a step S83 at which the operation-input acquisition unit 901 receives a signal from the input module 150 as a signal representing an operation input entered by the user to specify the cutout position and supplies the cutout position to the musical data cutout processing unit 911.

If the determination result produced at the step S82 indicates that the cutout position of the musical data 892 of the content 881 is not to be set by the user, on the other hand, the flow of the processing goes on to a step S84 at which the musical data cutout processing unit 911 extracts information specifying a cutout position from the fringe data 891 of the content 881.

After the process carried out at the step S83 or S84 is completed, the flow of the processing goes on to a step S85 at which the musical data cutout processing unit 911 cuts out a predetermined segment from the musical data 892 of the content 881 to generate cut-out musical data 933 to be included in the push data 921.

Then, at the next step S86, the fringe data extraction unit 912 extracts information to be used as a portion of metadata of the push data 921 from the fringe data 891 of the content 881. An example of the portion of metadata is the fringe extraction data 931 explained before by referring to FIG. 46.

Subsequently, at the next step S87, the data conversion unit 915 converts a part included in the information to be used as the metadata as a part requiring conversion. The part requiring conversion is a part included in the fringe extraction data 931 as information set to require data conversion in a process to attach the part to the metadata. An example of the part requiring conversion is image information or a text expressing the lyrics of a musical content.

Then, at the next step S88, the introducer-related data generation unit 913 extracts information on the information communication terminal 1 generating the push data 921 and information on a user owning the information communication terminal 1 from information stored in the flash memory 146, the large-size flash memory 154 or the flash memory 156 as information on users and information on apparatus, and generates typically the data 932 explained earlier by referring to FIG. 46 as data related to the introducer of the content 881 on the basis of the extracted information.

Subsequently, at the next step S89, on the basis of the data extracted by the fringe data extraction unit 912, the data extracted by the introducer-related data generation unit 913 and the data obtained as a result of the conversion process carried out by the data conversion unit 915, the metadata generation unit 914 generates metadata to be included in the push data 921 to be created at the following step.

Finally, at the last step S90, the push-data generation unit 916 generates the push data 921 explained earlier by referring to FIG. 46 on the basis of the cut-out musical data 933 and the metadata generated by the metadata generation unit 914 as metadata to be included in the push data 921. The cut-out musical data 933 is a portion cut out by the musical data cutout processing unit 911 as a portion of the musical data 892 of the content 881. Then, the flow of the processing goes back to the step S35 of the flowchart shown in FIG. 50 through the step S34 of the same flowchart.

By carrying out the processing described above, the push data 921 explained earlier by referring to FIG. 46 can be generated.

By referring to flowcharts shown in FIGS. 54 and 55, the following description explains processing carried out by an apparatus receiving data introducing a content 881. In the following description, it is assumed that data introducing a content 881 is received by information communication terminal 1 other than an information communication terminal 1 generating and transmitting the data introducing a content 881 as explained earlier by referring to the flowchart shown in FIG. 50.

The flowchart shown in FIG. 54 begins with a step S111 at which the application processor 131 produces a result of determination as to whether or not the radio communication module 148 has received push data 921 explained earlier by referring to FIG. 46 from another apparatus. If the determination result produced at the step S111 indicates that the radio communication module 148 has not received push data 921 from another apparatus, the flow of the processing goes back to the step S111 at which the process of determination is repeated. As a matter of fact, the process of determination of the step is carried out repeatedly till the result of the determination indicates that the radio communication module 148 has received push data 921 from another apparatus.

As the determination result produced at the step S111 indicates that the radio communication module 148 has received push data 921 from another apparatus, the flow of the processing goes on to a step S112 at which the application processor 131 produces a result of determination as to whether or not an upper limit of push-data holding has been set. It is to be noted that the upper limit of the push-data holding can be the upper limit of a push-data count or the upper limit of the size of a memory used for storing pieces of push data. The push-data count is the number of pieces of push data. In addition, the upper limit of the push-data count or the upper limit of the size of a memory used for storing pieces of push data can be set for every content category or every sender of push data.

If the determination result produced at the step S112 indicates that an upper limit of push-data holding has been set, the flow of the processing goes on to a step S113 at which the application processor 131 produces a result of determination as to whether or not the push-data count or the size of a memory used for storing pieces of push data has reached the upper limit.

If the determination result produced at the step S113 indicates that the push-data count or the size of a memory used for storing pieces of push data has reached the upper limit, the flow of the processing goes on to a step S114 at which the application processor 131 generates information for notifying the sender of the push data 921 that reception of the push data 921 has been denied and transmits the information to the sender of the push data 921 by way of the radio communication module 148. Then, the flow of the processing goes on to a step S121 of the flowchart shown in FIG. 55.

If the determination result produced at the step S112 indicates that no upper limit of push-data holding has been set or if the determination result produced at the step S113 indicates that the push-data count or the size of a memory used for storing pieces of push data has not reached the upper limit, on the other hand, the flow of the processing goes on to a step S115 at which the application processor 131 gets the push data 921 received at the step S111.

Then, at the next step S116, the application processor 131 refers to the introducer-related data 932 of the metadata included in the push data 921 in order to produce a result of determination as to whether or not the push data 921 has been received from a sender registered as an apparatus, recording of push data generated by which is prohibited.

If the determination result produced at the step. S116 indicates that the push data 921 has been received from a sender registered as an apparatus, recording of push data generated by which is prohibited, the flow of the processing goes on to a step S117 at which the application processor 131 discards the received the push data 921. Then, the flow of the processing goes on to the aforementioned step S121.

If the determination result produced at the step S116 indicates that the push data 921 has been received from a sender registered as an apparatus, recording of push data generated by which is not prohibited, on the other hand, the flow of the processing goes on to a step S118 at which the application processor 131 gives the push data 921 a file name indicating the title of a content introduced by the push data 921 and a user serving as the sender of the push data 921 on the basis of the metadata included in the push data 921. Then, the application processor 131 supplies the push data 921 to the audio processor 132. The (file system of the) audio processor 132 passes on the push data 921 with a file name indicating the title of a content introduced by the push data 921 and a user serving as the sender of the push data 921 to the large-size flash memory 154 used for storing the push data 921 in a predetermined folder.

In this way, the push data 921 can be stored in a folder dedicated for push data in a process carried out by (the file system of) the audio processor 132. It is also desirable to provide a configuration in which the push data 921 is stored in a plurality of folders typically dedicated for content categories and push-data senders.

Then, at the next step S119, the application processor 131 produces a result of determination as to whether or not a command to reproduce the cut-out musical data 933 of any push data 921 stored in the large-size flash memory 154 has been received on the basis of a signal received from the input module 150 as a signal representing an operation input entered by the user.

If the determination result produced at the step S119 indicates that a command to reproduce the cut-out musical data 933 of any push data 921 stored in the large-size flash memory 154 has been received, the flow of the processing goes on to a step S120 at which the application processor 131 supplies a control signal to the audio processor 132 as a signal for reproducing the cut-out musical data 933 of the push data 921 whose reproduction has been requested. In accordance with the control signal, the audio processor 132 carries out a file-system process to read out the cut-out musical data 933 of the push data 921, the reproduction of which has been requested, from the large-size flash memory 154. Then, the audio processor 132 carries out processing such as an audio-decoding process and an audio-player process on the cut-out musical data 933 of the push data 921, the reproduction of which has been requested, in order to reproduce the cut-out musical data 933. Subsequently, the audio processor 132 controls the audio-signal processing module 152 to carry out a D/A conversion process on an audio signal completing the processing such as an audio-decoding process and an audio-player process, and output an analog signal obtained as a result of the D/A conversion process to the ringer speaker 42 or the connector jack 52 as a reproduced signal.

If the determination result produced at the step S119 indicates that no command to reproduce the cut-out musical data 933 of any push data 921 stored in the large-size flash memory 154 has been received, on the other hand, the flow of the processing goes on to the aforementioned step S121. The flow of the processing also goes on to the aforementioned step S121 after the process carried out at the step S114, S117 or S120 is completed. At the step S121, the application processor 131 produces a result of determination as to whether or not a command to delete any push data 921 stored in the large-size flash memory 154 has been received on the basis of a signal received from the input module 150 as a signal representing an operation input entered by the user.

If the determination result produced at the step S121 indicates that a command to delete any push data 921 stored in the large-size flash memory 154 has been received, the flow of the processing goes on to a step S122 at which the application processor 131 supplies a control signal to the audio processor 132 as a signal for deleting the push data 921 whose deletion has been requested, from the large-size flash memory 154. Then, the audio processor 132 deletes the push data 921, the deletion of which has been requested, from the large-size flash memory 154.

If the determination result produced at the step S121 indicates that no command to delete any push data 921 stored in the large-size flash memory 154 has been received, on the other hand, the flow of the processing goes on to a step S123. The flow of the processing also goes on to the step S123 after the process carried out at the step S122 is completed. At the step S123, the application processor 131 generates a control signal and supplies the control signal to the audio processor 132 to request the audio processor 132 to refer to the metadata included in every push data 921 stored in the large-size flash memory 154 in order to produce a result of determination as to whether or not there is push data 921 whose deletion is required due to expiration of a period during which the push data 921 can be held or a limit till which the push data 921 can be held. In accordance with the control signal, the audio processor 132 refers to the metadata included in every push data 921 stored in the large-size flash memory 154 in order to produce a result of determination as to whether or not there is push data 921 whose deletion is required due to expiration of a period during which the push data 921 can be held or a limit till which the push data 921 can be held.

If the determination result produced at the step S123 indicates that there is push data 921 whose deletion is required due to expiration of a period during which the push data 921 can be held or a limit till which the push data 921 can be held, the flow of the processing goes on to a step S124. At the step S124, the audio processor 132 deletes the push data 921, deletion of which is required, from the large-size flash memory 154.

If the determination result produced at the step S123 indicates that there is no push data 921 whose deletion is required due to expiration of a period during which the push data 921 can be held or a limit till which the push data 921 can be held, on the other hand, the flow of the processing goes on to a step S125. The flow of the processing also goes on to the step S125 after the process carried out at the step S124 is completed. At the step S125, the application processor 131 produces a result of determination as to whether or not purchasing of a content 881 introduced by predetermined push data 921 has been requested on the basis of a signal received from the input module 150 as a signal representing an operation input entered by the user.

If the determination result produced at the step S125 indicates that no purchasing of a content 881 introduced by predetermined push data 921 has been requested, the processing is ended.

If the determination result produced at the step S125 indicates that purchasing of a content 881 introduced by predetermined push data 921 has been requested, on the other hand, the flow of the processing goes on to a step S126 at which the application processor 131 controls the radio communication module 148 to make an access to a content selling server 12 in order to transmit information required in the purchasing of the content 881 and information on a user introducing the content 881 on the basis of the metadata included in the push data 921. The content selling server 12 can be the content introduction service server 12-1, the content sale server 12-2 or the content distribution server 12-3. The information required in the purchasing of the content 881 is the ID of the content 881 to be purchased whereas the information on a user introducing the content 881 is the ID of an apparatus serving as the sender of the push data 921 and/or the ID of a user owning the apparatus.

Then, at the next step S127, the application processor 131 controls the radio communication module 148 to exchange the information required in the purchasing of the content 881 with the content introduction service server 12-1, the content sale server 12-2 or the content distribution server 12-3 through the network 11, carry out a process to purchase the content 881 from the content introduction service server 12-1, the content sale server 12-2 or the content distribution server 12-3, receive the content 881 such as the one explained earlier by referring to FIG. 42 and store the content 881 in the large-size flash memory 154 through the audio processor 132. Finally, the processing is ended.

By carrying out the processing described above, it is possible to acquire and store push data 921, reproduce the cut-out musical data 933 included in the stored push data 921, allow the user listening to the reproduced cut-out musical data 933 to purchase a content 881 introduced by the push data 921 on the basis of the metadata included in the push data 921 and transmit information on a user introducing the content 881 to the server 12 selling the content 881. The user introducing the content 881 is a user owning an apparatus serving as the sender of the push data 921.

If the server 12 carrying out the process to sell the content 881 is the content sale server 12-2 or the content distribution server 12-3, the server 12 supplies information indicating the purchasing of the musical content 881 and information on a user introducing the content 881 to the content introduction service server 12-1. The information indicating the purchasing of the content 881 is typically the ID of the purchased content 881 and the ID of the apparatus owned by the user or the ID of the user, whereas the information on the introducer of the content 881 is typically the ID of the information communication terminal 1 or personal computer 13 owned by the introducer or the ID of the introducer itself.

On the basis of the information indicating the purchasing of the musical content 881 and the information on the user introducing the content 881, the content introduction service server 12-1 gives points of content-introduction appreciation to the introducer and generates information for promoting introduction of another content 881, supplying the information to the introducer.

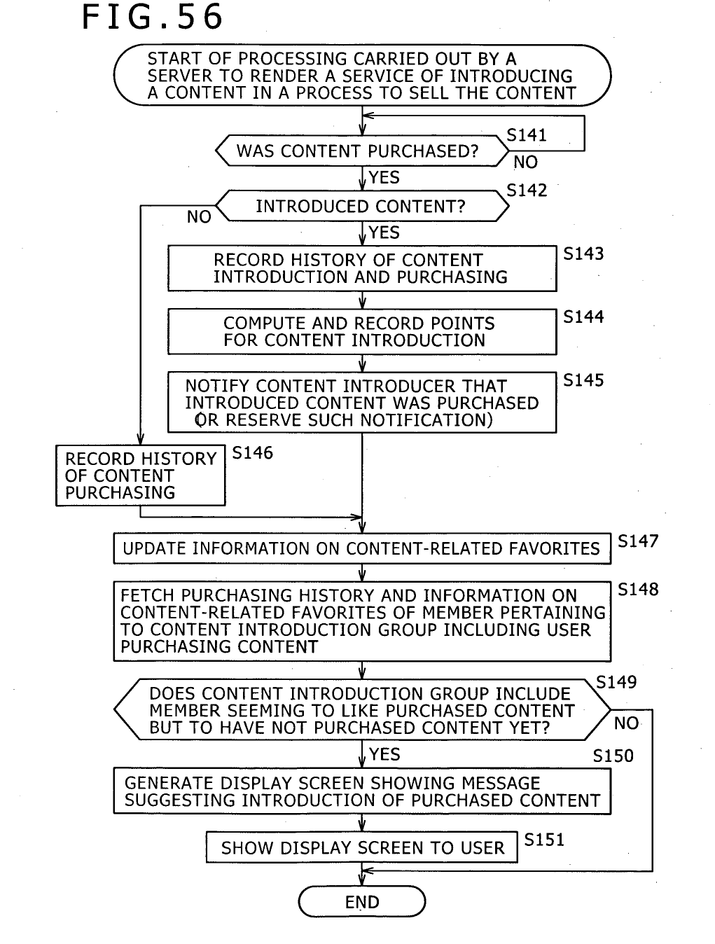

By referring to a flowchart shown in FIG. 56, the following description explains processing carried out by the content introduction service server 12-1 to sell a content 881.

The flowchart shown in FIG. 56 begins with a step S141 at which, on the basis of a signal received from the communication unit 959, the content-purchasing information acquisition unit 954 produces a result of determination as to whether or not a content 881 has been purchased. If the determination result produced at the step S141 indicates that a content 881 has not been purchased, the flow of the processing goes back to the step S141 at which the process of determination is repeated. As a matter of fact, the process of determination of the step is carried out repeatedly till the result of the determination indicates that a content 881 has been purchased.

As the determination result produced at the step S141 indicates that a content 881 has been purchased, the flow of the processing goes on to a step S142 at which, on the basis of information indicating the purchasing of the musical content 881 and information on the user introducing the content 881, the content-purchasing information acquisition unit 974 produces a result of determination as to whether or not the purchased content 881 is a content 881 introduced by an introducer. As described above, the information indicating the purchasing of the content 881 is typically the ID of the purchased content 881 and the ID of the apparatus owned by the user purchasing the content 881 or the ID of the user itself, whereas the information on the introducer of the content 881 is typically the ID of the information communication terminal 1 or personal computer 13 owned by the introducer or the ID of the content introducer itself.

If the determination result produced at the step S142 indicates that the purchased content 881 is a content 881 introduced by an introducer, the flow of the processing goes on to a step S143 at which the content-purchasing information acquisition unit 974 supplies the information indicating the purchasing of the musical content 881 and the information on the user introducing the content 881 to the user-information recording management unit 972. The user-information recording management unit 972 then records a history of content introduction and purchasing for the content 881 in the user-information database 973.

Then, at the next step S144, the content-purchasing information acquisition unit 974 supplies the information indicating the purchasing of the musical content 881 and the information on the user introducing the content 881 to the point processing unit 975. The point processing unit 975 then computes points of content-introduction appreciation for the introduction of the content 881 on the basis of the information indicating the purchasing of the musical content 881 and the information on the user introducing the content 881, which have been received from the content-purchasing information acquisition unit 974, and supplies the points to the user-information recording management unit 972. The information on the introducer of the content 881 is typically the ID of the information communication terminal 1 or personal computer 13 owned by the content introducer or the ID of the introducer itself. The user-information recording management unit 972 then adds the computed points of content-introduction appreciation to the content-introduction appreciation points accumulated for the introducer of the content 881 so far and records the resulting sum in the user-information database 973 as updated content-introduction appreciation points for the content introducer.

Subsequently, at the next step S145, the point processing unit 975 supplies information on the introducer of the purchased content 881 and the computed points of content-introduction appreciation to the page generation unit 979. Then, by making use of various kinds of image data and a web-page template, which have been stored in the page-information database 980, the page generation unit 979 generates a web page for notifying the introducer of the purchased content 881 that the content 881 introduced by the introducer has been purchased (or for reserving such a notification) and supplying the web page to the web-page display control unit 981. The web-page display control unit 981 then discloses the web page generated by the page generation unit 979 to the network 11 or transmits the web page to the introducer of the purchased content 881. As an alternative, the web-page display control unit 981 saves the web page, allowing pieces of information in the web page to be transmitted later to a user when an apparatus owned by the user makes an access to the content introduction service server 12-1.

If the determination result produced at the step S142 indicates that the purchased content 881 is not a content 881 introduced by an introducer, on the other hand, the flow of the processing goes on to a step S146 at which the content-purchasing information acquisition unit 974 supplies the information indicating the purchasing of the content 881 to the user-information recording management unit 972. The user-information recording management unit 972 then records a history of content purchasing in the user-information database 973 for the content 881.

After the process carried out at the step S145 or S146 is completed, the flow of the processing goes on to a step S147 at which the user-information recording management unit 972 supplies the history of content purchasing for the content 881 to the content-introduction promotion information generation unit 977. The content-introduction promotion information generation unit 977 then requests the user-information recording management unit 972 to update information stored in the user-information database 973 as information on content-related favorites.

Then, at the next step S148, the content-introduction promotion information generation unit 977 retrieves the purchasing history of the content 881 and information on content-related favorites for members each pertaining to a content introduction group including user A purchasing content 881 from the user-information database 973 through the user-information recording management unit 972.

Subsequently, at the next step S149, the content-introduction promotion information generation unit 977 produces a result of determination as to whether or not the content introduction group includes a member who apparently likes the content 881 purchased by user A but has not purchased the content 881 yet. If the determination result produced at the step S149 indicates that the content introduction group does not include a member who apparently likes the content 881 purchased by user A but has not purchased the content 881 yet, the processing is ended.

If the determination result produced at the step S149 indicates that the content introduction group includes a member who apparently likes the content 881 purchased by user A but has not purchased the content 881 yet, on the other hand, the flow of the processing goes on to a step S150 at which the content-introduction promotion information generation unit 977 provides the page generation unit 979 with information on the member who apparently likes the content 881 purchased by user A but has not purchased the content 881 yet. Then, by making use of various kinds of image data and a web-page template, which have been stored in the page-information database 980, the page generation unit 979 generates a display screen showing a message suggesting introduction of the content 881 purchased by user A and supplies the display screen to the web-page display control unit 981.

Then, at the next step S151, the web-page display control unit 981 discloses the display screen generated by the page generation unit 979 to users through the network 11. Finally, the processing is ended.

In the processing described above, a purchasing history of the content 881 and information on content-related favorites for users are recorded in the content introduction service server 12-1 along with recorded information on users and, on the basis of these pieces of information, information for promoting introduction of a content 881 is generated and provided to users in order to promote sales of the content 881.

In addition, when a registered user purchases a content 881, the registered user purchasing the content 881 is immediately informed of other users to whom the purchased content 881 should be introduced. Thus, a newly distributed content 881 can be circulated to a large number of users quickly. In addition, by providing each registered user with enjoyment to earn content-introduction appreciation points accruing from introduction of contents 881, sales of the contents 881 can be further promoted.

On top of that, when a registered user purchases a content 881, in addition to the process to immediately notify the registered user purchasing the content 881 of other users to whom the purchased content 881 should be introduced, if desired by the registered user, the content-introduction promotion information generation unit 977 is capable of generating information for promoting distribution of the content 881 on the basis of information stored in the content-introduction database 978 and providing the generated information to the registered u66ser.

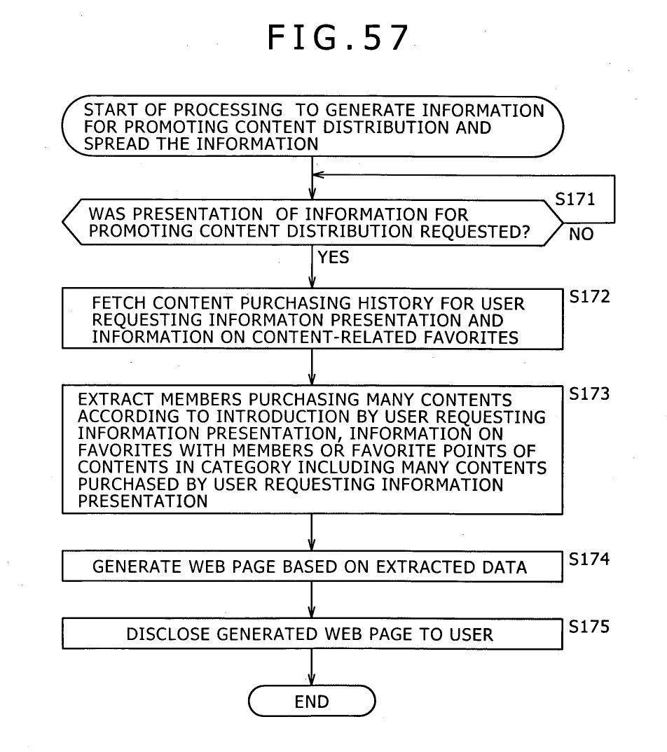

By referring to a flowchart shown in FIG. 57, the following description explains processing to generate information for promoting distribution of a content 881 and disseminate the information.

The flowchart shown in FIG. 57 begins with a step S171 at which the input-information acquisition control unit 976 produces a result of determination as to whether or not a request for presentation of information for promoting distribution of a content 881 has been received from an information communication terminal 1 or personal computer 13 owned by a user purchasing the content 881 through the network 11. If the determination result produced at the step S171 indicates that a request for presentation of information for promoting distribution of a content 881 has not been received from an information communication terminal 1 or a personal computer 13, the flow of the processing goes back to the step S171 at which the process of determination is repeated. As a matter of fact, the process of determination is carried out repeatedly till the result of the determination indicates that a request for presentation of information for promoting distribution of a content 881 has been received from an information communication terminal 1 or personal computer 13.

As the determination result produced at the step S171 indicates that a request for presentation of information for promoting distribution of a content 881 has been received from an information communication terminal 1 or a personal computer 13, the flow of the processing goes on to a step S172 at which the input-information acquisition control unit 976 supplies information on an apparatus owned by a user making the request for presentation of information for promoting distribution of a content 881 to the content-introduction promotion information generation unit 977. The information on an apparatus owned by a user making the request is typically the ID of a user owning the apparatus or the ID of the apparatus. The content-introduction promotion information generation unit 977 then retrieves various kinds of information from the user-information database 973 through the user-information recording management unit 972. The information retrieved from the user-information database 973 includes a history of content purchasing for the user making the request for the presentation of information and information on content-related favorites, a history of content purchasing for every member belonging to a content introduction group including the user making the request for the presentation of information and information on content-related favorites of every member belonging to the content introduction group.

Then, at the next step S173, the content-introduction promotion information generation unit 977 extracts various kinds of information used for creation of information for promoting distribution of the content 881 from the information on content-related favorites. The information for promoting distribution of the content 881 includes information on particular members each pertaining to the content introduction group as a member purchasing a number of contents each introduced by the user making the request for presentation of information, information on content-related favorites of the particular members or information on members each liking contents with high favorite points in a category including many contents purchased by the user making the request for the presentation of information.

Subsequently, at the next step S174, by making use of various kinds of image data and a web-page template, which have been stored in the page-information database 980, the page generation unit 979 generates a web page based on the extracted information. The web page is a page showing users information for promoting distribution of a content 881.

Then, at the next step S175 the web-page display control unit 981 discloses the web page generated by the page generation unit 979 to users through the network 11. Finally, the processing is ended.

By carrying out the processing described above, information for promoting distribution of a content 881 can be generated on the basis of a purchasing history of the content 881 and information on content-related favorites of users and presented to the users. Thus, sales of the content 881 can be promoted.

The series of processes described previously can be carried out by hardware and/or execution of software. If the series of processes described above is carried out by execution of software, programs composing the software can be installed into a computer embedded in dedicated hardware, a general-purpose personal computer or the like from typically a recording medium. In this case, the computer or the personal computer serves as the information communication terminal 1 described above. A general-purpose personal computer is defined as a personal computer, which can be made capable of carrying out a variety of functions by installing a variety of programs into the personal computer.

The aforementioned recording medium for recording programs to be installed into a computer or a general-purpose personal computer as programs to be executed by the computer or the general-purpose personal computer respectively is typically a removable recording medium 172 provided to the user separately from the main unit of the computer as shown in FIG. 11. Examples of the removable recording medium 172 include a magnetic disk such as a flexible disk, an optical disk such as a CD-ROM (Compact Disk—Read Only Memory) or a DVD (Digital Versatile Disk), a magneto-optical disk such as an MD (Mini Disk™) as well as a semiconductor memory.

In this specification, steps of each program recorded on the recording medium can be carried out not only in a pre-prescribed order along the time axis, but also concurrently or individually.

It is worth noting that the technical term ‘system’ used in this specification implies the configuration of a confluence including a plurality of apparatus.

It is to be noted that embodiments of the present invention are not limited to the embodiments described above. In addition, it is possible to make a variety of changes in a range not deviating from essentials of the present invention.

What is claimed is:

1. An information processing system comprising an information processing apparatus and another information processing apparatus different from said information processing apparatus wherein:
said information processing apparatus includes
a first communication unit configured to exchange information,
a first storage unit configured to store a content,
a data generation unit configured to cut out a portion of said content stored in said first storage unit and generate content introduction data based on said portion, and
a transmission control unit configured to control transmission of said content introduction data to another apparatus by making use of said first communication unit; and
said other information processing apparatus includes
a second communication unit configured to exchange information,
a second storage unit configured to store a content,
a content reproduction unit configured to reproduce said content, and
a control unit configured to store said content introduction data received by said second communication unit from said information processing apparatus as a portion cut out from said content in said information processing apparatus in said second storage unit and control said content reproduction unit to reproduce said content introduction data stored in said second storage unit.

2. The information processing system according claim 1 wherein:
said data generation unit employed in said information processing apparatus generates purchasing information to purchase said content and includes said purchasing information and said cut-out portion of said content in said content introduction data; and
said control unit employed in said other information processing apparatus controls said second communication unit to receive said content introduction data and transmit a signal making a request for purchasing of said content in accordance with said purchasing information.

3. The information processing system according claim 2 wherein:
said data generation unit employed in said information processing apparatus generates apparatus information of said information processing apparatus and includes said apparatus information and said cut-out portion of said content in said content introduction data; and
said control unit employed in said other information processing apparatus controls said second communication unit to receive said content introduction data and transmit a signal making a request for purchasing of said content along with said apparatus information.

4. An information processing method comprising the steps of:
cutting out a portion of a content stored in a first storage unit and generating content introduction data based on said portion;
controlling transmission of said content introduction data to another apparatus by making use of a first communication unit;
letting a second communication unit receive said content introduction data and store said content introduction data in a second storage unit; and
controlling a content reproduction unit to reproduce said content introduction data stored in said second storage unit as a portion cut out from said content.

5. An information processing apparatus comprising:
a communication unit configured to exchange information with another apparatus;
a storage unit configured to store a content;
a data generation unit configured to cut out a portion of said content stored in said storage unit and generate content introduction data based on said portion; and
a transmission control unit configured to control transmission of said content introduction data to said other apparatus by making use of said communication unit.

6. The information processing apparatus according claim 5 wherein said data generation unit generates apparatus information of said information processing apparatus and includes said apparatus information and said cut-out portion of said content in said content introduction data.

7. The information processing apparatus according claim 5 wherein said data generation unit generates purchasing information to purchase said content including said cut-out portion and includes said purchasing information and said cut-out portion of said content in said content introduction data.

8. The information processing apparatus according claim 5, further comprising:
a user-information acquisition unit configured to acquire user information on a user owning said other apparatus in a predetermined communication mode and information on a favorite with said user, which is included in said user information; and
a content search unit configured to search said storage unit for a content serving as a favorite with said user on the basis of information, which is included in said user information acquired by said user-information acquisition unit, as information on content-related favorites of said user,
wherein said data generation unit generates said content introduction data based on said content found by said content search unit.

9. The information processing apparatus according claim 8 wherein said predetermined communication mode is a communication mode for carrying out direct radio communications between apparatus as communications passing through no access point.

10. The information processing apparatus according claim 5 wherein said data generation unit cuts out a predetermined portion of said content on the basis of information included in said content or on the basis of an operation input entered by a user owning said information processing apparatus to an operation input unit employed in said information processing apparatus.

11. The information processing apparatus according claim 9 wherein said data generation unit includes a data conversion unit configured to convert at least a portion of said content.

12. An information processing method comprising the steps of:
cutting out a portion of a content stored in a storage unit and generating content introduction data based on said portion; and
controlling transmission of said content introduction data generated at said cutting out/generating step to another apparatus by making use of a communication unit.

13. A recording medium for storing a computer-readable program to be executed by a computer to carry out processing comprising the steps of:
cutting out a portion of a content stored in a storage unit and generating content introduction data based on said portion; and
controlling transmission of said content introduction data generated at said cutting out/generating step to another apparatus by making use of a communication unit.

14. An information processing apparatus comprising:
a communication unit configured to exchange information with another apparatus;
a storage unit configured to store content data;
a content reproduction unit configured to reproduce said content data; and
a control unit configured to control
said communication unit to receive content introduction data, which includes at least a portion cut out by said other apparatus from a content, information on said other apparatus and information on a method to purchase said content, from said other apparatus,
said content reproduction unit to reproduce said cut-out portion included in said content introduction data, and
said communication unit to transmit said information on said other apparatus and a signal making a request for purchasing of said content in accordance with said information on said other apparatus and said information on a method to purchase said content.

15. An information processing method comprising the steps of controlling:
a communication unit to receive content introduction data, which includes at least a portion cut out by another apparatus from a content, information on said other apparatus and information on a method to purchase said content, from said other apparatus;
a content reproduction unit to reproduce said cut-out portion included in said content introduction data; and
said communication unit to transmit said information on said other apparatus and a signal making a request for purchasing of said content in accordance with said information on said other apparatus and said information on a method to purchase said content.

16. A recording medium for storing a computer-readable program to be executed by a computer to carry out processing comprising the steps of controlling:
a communication unit to receive content introduction data, which includes at least a portion cut out by another apparatus from a content, information on said other apparatus and information on a method to purchase said content, from said other apparatus;
a content reproduction unit to reproduce said cut-out portion included in said content introduction data; and
said communication unit to transmit said information on said other apparatus and a signal making a request for purchasing of said content in accordance with said information on said other apparatus and said information on a method to purchase said content.

17. An information processing apparatus comprising:
communication means configured to exchange information with another apparatus;
storage means configured to store a content;
data generation means configured to cut out a portion of said content stored in said storage means and generate content introduction data based on said portion; and
transmission control means configured to control transmission of said content introduction data to said other apparatus by making use of said communication means.

18. An information processing apparatus comprising:
communication means configured to exchange information with another apparatus;
storage means configured to store content data;
content reproduction means configured to reproduce said content data; and
control means configured to control
said communication means to receive content introduction data, which includes at least a portion cut out by said other apparatus from a content, information on said other apparatus and information on a method to purchase said content, from said other apparatus,
said content reproduction means to reproduce said cut-out portion included in said content introduction data, and
said communication means to transmit said information on said other apparatus and a signal making a request for purchasing of said content in accordance with said information on said other apparatus and said information on a method to purchase said content.
